(19) United States
(12) Patent Application Publication
(10) Pub. No.: US 2026/0300446 A1
(43) Pub. Date: Oct. 1, 2026

(54) METHOD AND SYSTEM FOR A PROVIDING A REAL-TIME MULTI-LAYER COPYRIGHT VERIFICATION AND COLLABORATION PLATFORM

(71) Applicant: Regina DeBellis, Long Beach, NY (US)

(72) Inventor: Regina DeBellis, Long Beach, NY (US)

(21) Appl. No.: 19/704,086

(22) Filed: Jun. 10, 2026

Related U.S. Application Data
(63) Continuation-in-part of application No. 19/013,389, filed on Jan. 8, 2025.
(60) Provisional application No. 63/619,941, filed on Jan. 11, 2024.
(60) Provisional application No. 63/822,331, filed on Jun. 12, 2025.

(51) Int. Cl. G06F 21/10; G06F 21/32

(52) U.S. Cl. CPC G06F 21/106; G06F 21/32

(57) ABSTRACT

A multi-layer modular digital content platform that integrates copyrighted content upload, identity verification, content documentation, and behavioral analytics into a unified architecture. The platform enables users to upload and document original copyrighted content, record and retrieve authorship records on a blockchain, monitor in real-time content use, reuse, creation of derivative works and enforce real-time identity verification of authors and users of the original copyrighted content using biometric inputs.

### CROSS REFERENCES TO RELATED APPICATIONS

This U.S. utility patent application is a Continuation-In-Part (CIP) of U.S. patent application Ser. No. 19/013,389, filed Jan. 8, 2025, that claims priority to U.S. Provisional patent applications No. 63/619,941, filed on Jan. 11, 2024, and also claims priority to U.S. Provisional patent application 63/822,331, filed on Jun. 12, 2025, the content of all of which are incorporated by reference.

### FIELD OF INVENTION

This invention relates to verifying and collaborating copyright materials. More specifically, it relates to a method and system for providing a multi-layer copyright verification and collaboration platform.

### BACKGROUND OF THE INVENTION

The Constitution of the United States of America includes in Article I, Section 8, Clause 8, a clause authoring empowers Congress to “promote the Progress of Science and useful Arts” by securing exclusive rights for authors and inventors to their respective writings and discoveries for limited times. This clause established the constitutional foundation for U.S. copyright and patent law, in part shaping the creative and technological development of the United States.

Copyright laws in the United States are covered under Title 17 of the United States Code (17 U.S.C.). This title contains the Copyright Act of 1976 and all subsequent amendments, which form the basis of federal copyright law.

Copyright regulations in the United States are primarily covered in Title 37 of the Code of Federal Regulations (C.F.R.), Chapter II. These regulations are managed by the U.S. Copyright Office, which is part of the Library of Congress and cover procedures regarding registration, recordation, and general policies.

The “basic copyrights” generally refer to the exclusive rights granted to a copyright owner under the Copyright Act of 1976, specifically 17 U.S.C. § 106.

Under U.S. copyright law, an “author” is a person that creates an original work (e.g., a painting, a drawing, movie, a computer program, etc.) fixed in a tangible medium of expression (e.g., writing it down, filming it, saving it to a computer file, etc.) An author is a human creator of original expression, a person who translates an idea into a fixed creative expressive form.

Two or more people may be “joint authors” if they merge their own individual contributions into a single work, and author contributes individual copyrightable expressions.

The “basic copyrights” generally refer to six exclusive rights granted to a copyright owner under the Copyright Act of 1976, specifically 17 U.S.C. § 106. These six exclusive rights give the copyright owner legal control over how a copyrighted work is used. These six exclusive rights include: (1) Reproduction Rights, the right to copy or reproduce the work; (2) Distribution Right, the right to distribute copies of the work to the public; (3) Right to Create Derivative Works, the right to change and prepare modified or adapted versions of the original work; (4) Public Performance Right, he right to publicly perform the work; (5) Public Display Right, the right to publicly display the work; and (6) Digital Audio Transmission Right, a specialized right for sound recordings (e.g., Internet radio streaming, digital music services, etc.).

Under U.S. copyright law, a copyright exists automatically once: an original work is created, and the work is fixed in a tangible medium. No registration is necessary to create copyright.

However, in the United States federal copyright registration is a formal registration of a copyrighted work with the United States Copyright Office under U.S. copyright law.

U.S. copyright registration creates an official public record of the copyright claim and provides important legal and procedural benefits beyond the automatic copyright protection that already exists when a work is created.

U.S. copyright registration is generally not required to protect a copyrighted work. However, a U.S. copyright registration provides powerful enforcement and evidentiary mechanism.

A U.S. federal copyright registration: (1) Records a copyright claim with the U.S. government; identifies an author and claimant; (2) identifies a copyrighted work; (3) establishes an official copyright registration date; and places a copyright claim into U.S. government public record.

Even when U.S. copyright registrations are obtained, proliferation of digital content across the Internet and social media platforms (e.g., INSTAGRAM, FACEBOOK, LINKEDIN, TICTOK, X-TWITTER, etc.) has made it increasingly difficult for authors to establish and protect ownership over their original works. Copyrighted content is frequently reposted, altered, and/or reused without attribution, and current Internet and social media platform systems provide little support for documenting authorship, determining identities of user who misuse copyrighted content, determining and recording collaboration.

As a result, authors face challenges in proving original ownership and/or asserting ownership of copyrighted materials and/or determining and recording collaboration on copyrighted content in an event of a copyright dispute.

There are many problems associated with protecting copyrighted materials in a digital format on the Internet and/or social media platforms.

One problem is that existing solutions attempt to provide timestamp-based records of content submission but often lack integration with blockchain systems, biometric verification tools, and/or real-time content reuse detection.

Another problem is that traditional copyright registration systems are not well integrated into the workflow of Internet, social media and/or content-sharing platforms. Such systems leave gaps and leave copyright creators vulnerable and make it difficult to verify a provenance of copyrighted content in dynamic digital environments.

Another problem there is little support for enforcing user identity integrity across user accounts in social platforms, leading to impersonation, misuse of copyrighted content, and manipulation of engagement metrics.

Another problem is that most systems do not link platform actions to a verified identity or provide configurable privacy modes that allow users to control how and when interactions are recorded. These limitations restrict accountability and reduce user trust across digital platforms for copyrighted materials.

There have been some attempts to solve some of the problems associated with handling copyrighted materials.

For example, U.S. Pat. No. 11,922,730, that issued to Levin, et al. teaches “The present disclosure provides for methods for signature and identity verification and authentication. The system may comprise a plurality of visual capture devices, virtual data, and a plurality of virtual databases. The plurality of visual capture devices may capture a photo or video of the signee, the signature, a witness, or a combination thereof. The system may comprise a plurality of auxiliary authentication components for recording data such as the date, time, and location of the signature verification, as non-limiting examples. The virtual data may comprise visual data and other metadata. The method may comprise uploading the virtual data collected during the signature verification to a blockchain, where a signature authentication may occur or be recorded. Auxiliary authentication devices may include a plurality of audio capture devices, a plurality of geospatial capture devices, such as accelerometers or GPS, a plurality of pressure sensors, or any combination thereof, as non-limiting examples.”

U.S. Pat. No. 10,666,423, that issued to Benini, teaches “A blockchain database employs cryptography and other methods to implement and protect a distributed, publicly-amendable ledger. Transactions in a blockchain ledger are intentionally anonymous; however, there are cases where it would be useful to be able to verify or disprove a claim of identity of a contributor of a blockchain transaction. Biometrics can be used to link a human being to digital information using their unique physical traits in a way that is analogous to a handwritten or digital signature. An exemplary embodiment disclosed herein describes methods to create and store data in a blockchain transaction such that it can be used in the future to biometrically verify the identity of the contributor of the transaction, and use encoded biometric data to determine whether the blockchain transaction was created or not created by a particular individual.”

U.S. Pat. No. 10,541,818, that issued to Butler, et al. teaches “A method and system for decentralized biometric signing of a digital contract. A digital identity including a private key is created. The private key was encrypted on a mobile device via use of captured biometric data. A digital hash of the digital contract is generated. A user using biometric data is authenticated. Usage of the biometric data is authorized. Responsive to the usage of the biometric data being authorized, the encrypted private key is decrypted. The digital hash is signed with the decrypted private key. The signed digital hash is stored in a blockchain.”

U.S. Pat. No. 10,516,538, that issued to Fielding, et al. teaches “a system and method executed in one or more servers that interface with a Database Management System (DBMS) for signing and exchanging documents electronically with or without a PIV. If a PIV card is used, a card reader reads embedded private biometric key stored on the card and sends the private key to a node that has the corresponding public key on the X.509 certificate. The public key is derived from the private biometric key embedded in the PIV card as described above. Information contained in X.509 certificate is used to authenticate a user for example using the SSH protocol. If a PIV card is not used, the biometric data represents captured biometric data blocks, which are used to generate a biometric hash at a subscriber node. The subscriber node sends the biometric hash to a plurality of observer nodes that validate the hash by sending validation responses based on hash ledgers states at each observer node. If most of the observer nodes validate the biometric hash, the subscriber is authenticated for signing documents under any role a subscriber may have in an organization.”

U.S. Published Patent Application Number US2023/0134651A1, published by Agbamu teaches “A password-less computer system for automated identity, document, and transaction management, enabling onboarding, compliance workflow, and client lifecycle management includes a biometrics system of supervised and/or unsupervised intelligence. The system may support various biometrics types, preferably utilizing facial biometrics comparison for compliance onboarding. Images compared may be an image/recording of an identification card, credentials being physical and/or digital; gender, age, ethnicity, anti-spoofing, liveness component being present. An authentication system utilizing authentication server(s) that may upon request send a nonce to another system, devices, applications, etc. Utilizing biometrics for validating and unlocking private keys to sign a nonce, and communicating with the authentication server(s) for private and public key validation, and an access token(s).”

U.S. Published Patent Application No. US2020/0042688A1, published by Schwartz teaches “At least one contemporaneous signature image is captured while a user generates an electronic signature for a document. When one or more contemporaneous signature images maps to a verification image, signature data representative of an electronic signature is associated with the document.”

U.S. Published Patent Application No. US2019/0213311A1, published by Tussi, teaches “Systems and methods for authenticating a user in an authentication system using a computing device configured to capture authentication biometric identity information. The authentication biometric identify information captured during an authentication session. The authentication biometric identify information may comprise or be derived from one or more images of the user being authenticated. The authentication biometric identify information is compared to root identify biometric information. The root identify biometric information is captured from a trusted source, such as trusted devices located at trusted locations, such as a government entity, financial institution, or business. Identity verification may occur by comparing the trusted root identify biometric information to the biometric identify information captured during an authentication session. Liveness determination may also occur to verify the user is a live person. Liveness determination may include comparing two images of the user such that the two images are captured at different distances from the user.”

U.S. Published Patent Application No. US2016/0283920A1, published by Fischer, et al., teaches “Systems and methods for authenticating a user in an authentication system using a method for authenticating a chain of custody utilizing blockchain technology, whereby digital evidence or other digital content is acquired and then hashed to produce a hash fingerprint/signature and then immediately or instantly submitting said hash fingerprint/signature to the blockchain using the blockchain network protocol, forming an immediate verifiable chain of custody without human interaction or requiring a trusted third party.”

However, none of these solutions solve all of the problems associated with using and protecting copyrighted materials on the Internet and/or social media platforms.

Thus, it is desirable to solve some of the problems associated with protecting copyright materials on and across the Internet and/or social media platforms.

### SUMMARY OF THE INVENTION

In accordance with preferred embodiments of the present invention, some of the problems associated with using and protecting copyrighted materials on the Internet and/or social media platforms are overcome. A multi-layer copyright verification and collaboration platform is presented.

The multi-layer modular digital content platform integrates copyrighted content upload, identity verification, content documentation, and behavioral analytics into a unified architecture. The platform enables users to upload and document original copyrighted content, record and retrieve authorship records on a blockchain, monitor in real-time content use, reuse, creation of derivative works and enforce real-time identity verification of authors and users of the original copyrighted content using biometric inputs.

The foregoing and other features and advantages of preferred embodiments of the present invention will be more readily apparent from the following detailed description. The detailed description proceeds with references to the accompanying drawings.

### BRIEF DESCRIPTION OF THE DRAWINGS

Preferred embodiments of the present invention are described with reference to the following drawings, wherein:

FIG. 1 is a block diagram illustrating an exemplary identification verification and location processing and display system;

FIG. 2 is a block diagram illustrating an exemplary identification verification and location information display system;

FIG. 3 is a block diagram illustrating an exemplary networking protocol stack;

FIG. 4 is a block diagram illustrating an exemplary cloud communications network;

FIG. 5 is a block diagram illustrating an exemplary cloud storage object;

FIG. 6 is a block diagram illustrating wearable network devices;

FIGS. 7A, 7B and 7C are a flow diagram illustrating a method for providing identification verification and location services for a desired person;

FIG. 8 is a block diagram illustrating a plural different security layers available on the server identification verification and location application on the server network device;

FIGS. 9A and 9B are a flow diagram illustrating a method for providing identification verification and location services;

FIG. 10 is a flow diagram illustrating a method for providing identification verification and location services;

FIG. 11 is a flow diagram illustrating a method for providing identification verification and location services for a desired person;

FIG. 12 is a block diagram illustrating a data flow for providing identification verification and location services;

FIG. 13 is a block diagram illustrating an exemplary block chain;

FIG. 14 is a block diagram illustrating plural different services available on the server identification verification and location application on the server network device;

FIG. 15 is a block diagram illustrating a copyright verification and collaboration platform;

FIGS. 16A, 16B, 16C, 16D, 16E, 16F, 16G and 16H are a flow diagram including method for providing a copyright verification and collaboration platform; and

FIG. 17 is a flow diagram including a method for providing copyright verification and collaboration.

### DETAILED DESCRIPTION OF THE INVENTION

### Exemplary Multi-Layer Copyright Verification and Collaboration Processing and Display System

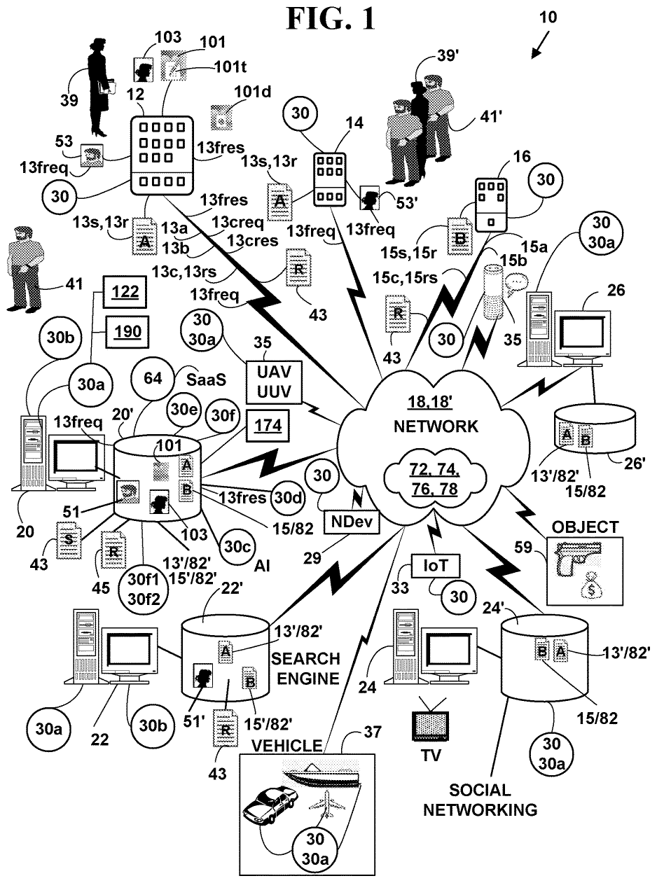

FIG. 1 is a block diagram illustrating an exemplary copyright verification and collaboration processing and display system 10 for sending and receiving electronic messages. The exemplary system 10 includes, but is not limited to, one or more target network devices 12, 14, 16, etc. each with one or more processors and each with a non-transitory computer readable medium, connected to a communications network 18, 18′. A network device is any device that can be connected to the communications network 18, 18′ with a wireless and/or wired connection.

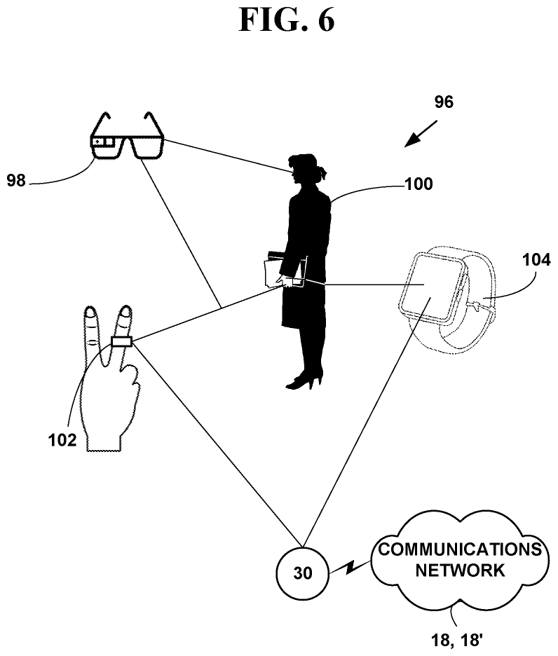

The one or more target network devices 12, 14, 16 (illustrated in FIG. 1 only as a tablet and two smart phones for simplicity) include, but are not limited to, (desktop and laptop computers, tablet computers, mobile phones, non-mobile phones with displays, smart phones, Internet phones, Internet appliances, personal digital/data assistants (PDA), portable, handheld and desktop video game devices, cable television (CATV), satellite television (SATV) and Internet television set-top boxes, digital televisions including high definition television (HDTV), three-dimensional (3DTV) televisions, collectively, network devices (NDev) 29, smart speakers 31, Internet of Things (IoT) devices 33, Unmanned Ariel Vehicles (UAVs) 35, vehicles 37, wearable network devices 106-112 (FIG. 6), Point of Sale (POS) network devices 225 and/or other types of network devices.

A “smart phone” is a mobile phone 14 that offers more advanced computing ability and connectivity than a contemporary basic feature phone. Smart phones and feature phones may be thought of as handheld computers integrated with a mobile telephone, but while most feature phones are able to run applications based on platforms such as JAVA ME, a smart phone usually allows the user to install and run more advanced applications. Smart phones and/or tablet computers run complete operating system software providing a platform for application developers.

The tablet computers 12 include, but are not limited to, tablet computers such as the IPAD, by APPLE, Inc., the HP Tablet, by HEWLETT PACKARD, Inc., the PLAYBOOK, by RIM, Inc., the TABLET, by SONY, Inc., etc.

A “smart speaker” 31 includes but is not limited to, a type of wireless speaker and voice command device with an integrated virtual assistant that offers interactive actions and hands-free activation with the help of one “hot word” (or several “hot words”). Some smart speakers can also act as a smart device that utilizes Wi-Fi, BLUETOOTH and other wireless protocol standards to extend usage beyond audio playback, such as to control home automation devices. This can include, but is not be limited to, features such as compatibility across a number of services and platforms, peer-to-peer connection through mesh networking, virtual assistants, and others. Each can have its own designated interface and features in-house, usually launched or controlled via application or home automation software. Some smart speakers also include a screen to show the user a visual response.

The IoT network devices 33, include but are not limited to, cameras, security cameras, doorbells with real-time video cameras, baby monitors, televisions, set-top boxes, lighting, heating (e.g., smart thermostats, etc.), ventilation, air conditioning (HVAC) systems, and appliances such as washers, dryers, robotic vacuums, air purifiers, ovens, refrigerators, freezers, toys, game platform controllers, game platform attachments (e.g., guns, googles, sports equipment, etc.), gun-shot detection monitors and/or other types of IoT network devices.

Unmanned aerial vehicles (UAV) 35, commonly known as “drones” and also referred to as Remotely Piloted Aircraft (RPA), included but are not limited to, are aircraft and watercraft guided autonomously, by remote control, or both and that carry sensors and cameras to collect information and display the collected information to an operator.

Unmanned underwater vehicles 35 (UUV), also known as uncrewed underwater vehicles and underwater drones, are submersible vehicles that can operate underwater without a human occupant. These vehicles may be divided into two categories: remotely operated underwater vehicles (ROUVs) and autonomous underwater vehicles (AUVs).

Vehicles 37, include, but are not limited to, vehicles with and/or without a driver including, land vehicles (e.g., automobiles, trucks, buses, motorcycles, locomotives, snow machines, etc.), air vehicles (e.g., drones, UAVs, airplanes, helicopter, hot air balloon, blimp, etc.), water vehicles, (e.g., UUVs, ROUVs AUVs, ships, boats, barges, rafts, canoes, kayaks, personal water craft (PWC), etc.) and/or other types of vehicles with a wired and/or wireless network interface for connecting with the communications network 18, 18′.

Point of Sale (POS) network devices 225, include, but are not limited to, a network device used by businesses to process customer transactions, track inventory, and manage sales data. The PoS 225 network devices include hardware and software 30 combination used at the place where a customer makes a purchase, whether in-store or online. The POS network devices 225 include, but are not limited to, cash registers, credit and debit card readers, barcode scanners, easy pay readers (e.g., NFC, M2M, etc.), mobile payment readers (e.g. APPLE PAY, GOOGLE PAY, etc.), receipt printers, touchscreen displays and/or other types of POS 225 network devices 225.

The target network devices 12, 14, 16, 31, 33, 35, 37, 106-112 are in communications with a cloud communications network 18 or a non-cloud computing network 18′ via one or more wired and/or wireless communications interfaces. The cloud communications network 18, is also called a “cloud computing network” herein and the terms may be used interchangeably.

The plural target network devices 12, 14, 16, 31, 33, 35, 37, 106-112 send and receive requests for electronic information 13, 15 including but not limited to, identification verification and/or location information for a desired person 41 (e.g., criminal, terrorist, solider, missing person, professional (e.g., doctor, lawyer, nurse, etc.), student, ride share driver, etc.) via the cloud communications network 18 or non-cloud communications network 18′.

The cloud communications network 18 and non-cloud communications network 18′ includes, but is not limited to, communications over a wire connected to the target network devices, wireless communications, and other types of communications using one or more communications and/or networking protocols.

Plural server network devices 20, 22, 24, 26 (only four of which are illustrated) each with one or more processors and a non-transitory computer readable medium include one or more associated databases 20′, 22′, 24′, 26′. The plural network devices 20, 22, 24, 26 are in communications with the one or more target devices 12, 14, 16, 31, 33, 35, 37, 106-112 via the cloud communications network 18 and/or the non-cloud communications network 18′.

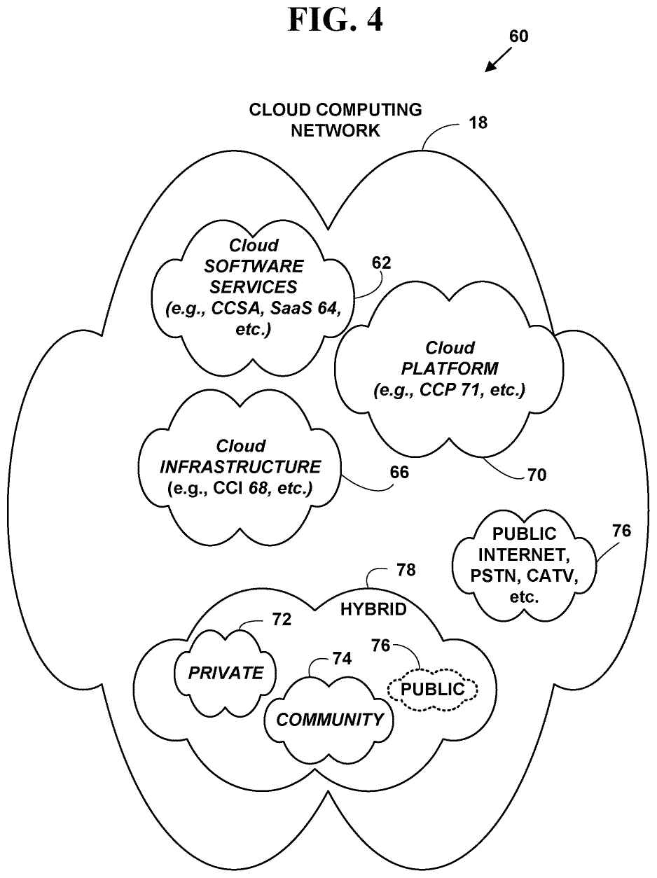

Plural server network devices 20, 22, 24, 26 (only four of which are illustrated) are physically located on one more public networks 76 (See FIG. 4), private networks 72, community networks 74 and/or hybrid networks 78 comprising the cloud network 18.

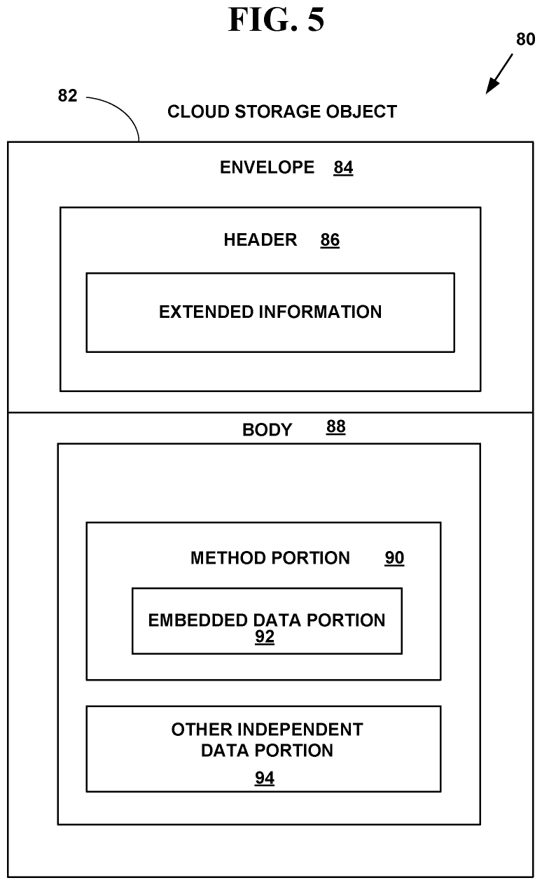

In one embodiment, the one or more server network devices (e.g., 20, 22, 24, 26, etc.) store portions 13′, 15′ of the electronic information 13, 15 (e.g., identification verification and/or location information, etc.) as cloud storage objects 82 (FIG. 5) as is described herein.

The plural server network devices 20, 22, 24 26, may be connected to, but are not limited to, World Wide Web servers, Internet servers, search engine servers, vertical search engine servers, social networking site servers, file servers, other types of electronic information servers, and other types of server network devices (e.g., edge servers, firewalls, routers, gateways, etc.).

The plural server network devices 20, 22, 24, 26 also include, but are not limited to, network servers used for cloud computing providers, etc.

The cloud communications network 18 and non-cloud communications network 18′ includes, but is not limited to, a wired and/or wireless communications network comprising one or more portions of: the Internet, an intranet, a Local Area Network (LAN), a wireless LAN (WiLAN), a Wide Area Network (WAN), a Metropolitan Area Network (MAN), a Public Switched Telephone Network (PSTN), a Wireless Personal Area Network (WPAN) and other types of wired and/or wireless communications networks 18.

The cloud communications network 18 and non-cloud communications network 18′ includes one or more gateways, routers, bridges and/or switches. A gateway connects computer networks using different network protocols and/or operating at different transmission capacities. A router receives transmitted messages and forwards them to their correct destinations over the most efficient available route. A bridge is a device that connects networks using the same communications protocols so that information can be passed from one network device to another. A switch is a device that filters and forwards packets between network segments based on some pre-determined sequence (e.g., timing, sequence number, etc.).

An operating environment for the network devices of the exemplary electronic information display system 10 include a processing system with one or more high speed Central Processing Unit(s) (CPU), processors, one or more memories and/or other types of non-transitory computer readable mediums. In accordance with the practices of persons skilled in the art of computer programming, the present invention is described below with reference to acts and symbolic representations of operations or instructions that are performed by the processing system, unless indicated otherwise. Such acts and operations or instructions are referred to as being “computer-executed,” “CPU-executed,” or “processor-executed.”

It will be appreciated that acts and symbolically represented operations or instructions include the manipulation of electrical information by the CPU or processor. An electrical system represents data bits which cause a resulting transformation or reduction of the electrical information or biological information, and the maintenance of data bits at memory locations in a memory system to thereby reconfigure or otherwise alter the CPU's or processor's operation, as well as other processing of information. The memory locations where data bits are maintained are physical locations that have particular electrical, magnetic, optical, or organic properties corresponding to the data bits.

The data bits may also be maintained on a non-transitory computer readable medium including magnetic disks, optical disks, organic memory, and any other volatile (e.g., Random Access Memory (RAM)) or non-volatile (e.g., Read-Only Memory (ROM), flash memory, etc.) mass storage system readable by the CPU. The non-transitory computer readable medium includes cooperating or interconnected computer readable medium, which exist exclusively on the processing system or can be distributed among multiple interconnected processing systems that may be local or remote to the processing system.

### Exemplary Identification Verification Location Information Display System

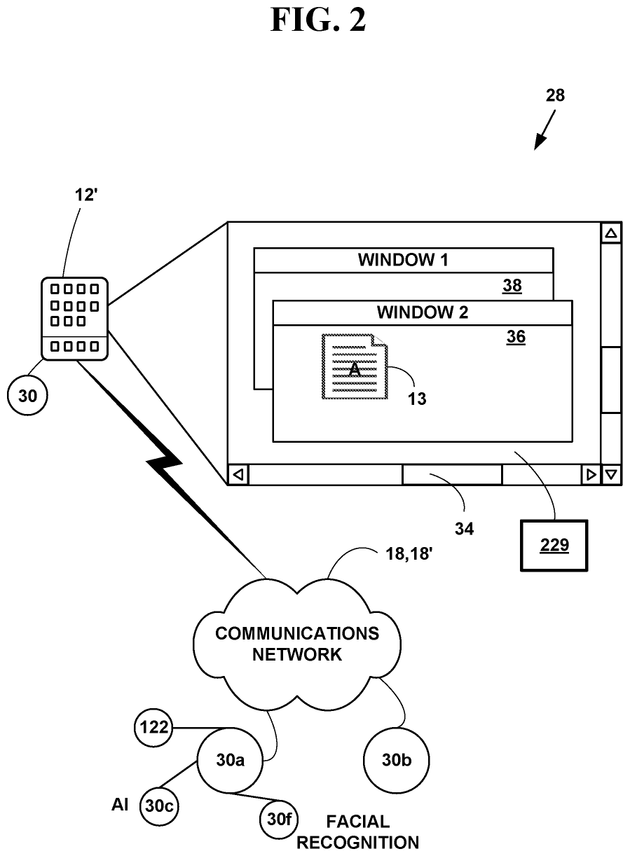

FIG. 2 is a block diagram illustrating an exemplary identification verification and location information display system 28. The exemplary electronic message information display system 12′ includes, but is not limited to a target network device (e.g., 12, etc.) with an application 30 and a display component 32. The application 30 presents a graphical user interface (GUI) 34 on the display 32 component. The GUI 32 presents a multi-window 36, 38, etc. (only two of which are illustrated) interface to a user.

In one embodiment of the invention, the application 30 is a software application. However, the present invention is not limited to this embodiment and the application 30 can be hardware, firmware, hardware and/or any combination thereof. In one embodiment, the application 30 includes a mobile application for a smart phone, electronic tablet and/or other network device. In one embodiment, the application 30 includes web-browser based application. In one embodiment, the application 30 includes a web-chat client application. In another embodiment, the application 30a, 30b, 30c, 30d, 30e, 30f includes a cloud application used on a cloud communications network 18. However, the present invention is not limited these embodiments and other embodiments can be used to practice the invention

In another embodiment, a full application 30 and/or a portion of the application 30 is executing on the target network devices 12, 14, 16, 31, 33, 35, 37, 106-112 and another portion of the application 30a, 30b, 30c, 30d, 30e, 30f is executing on the server network devices 20, 22, 24, 26. The applications also include one or more library applications. However, the present invention is not limited these embodiments and other embodiments can be used to practice the invention.

### Exemplary Networking Protocol Stack

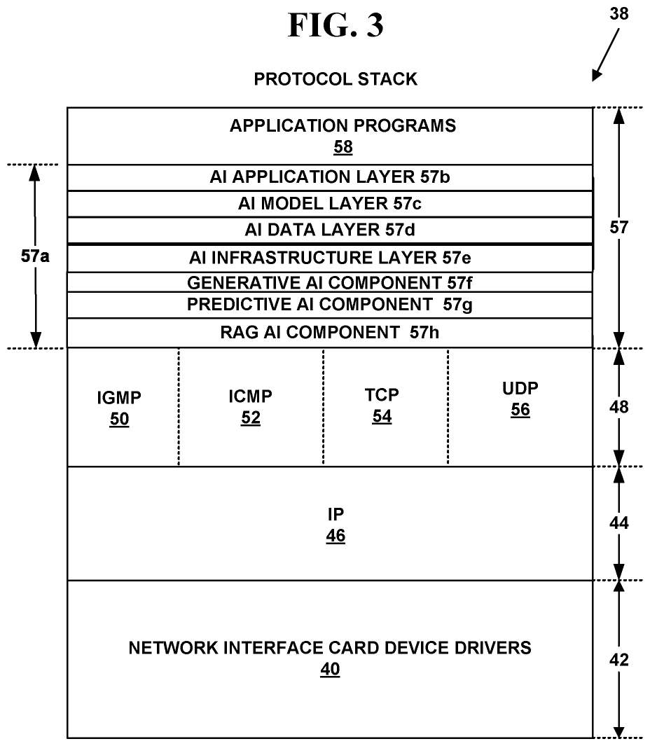

FIG. 3 a block diagram illustrating a layered protocol stack 38 for network devices in the electronic message information display system 10. The layered protocol stack 38 is described with respect to Internet Protocol (IP) suites comprising in general from lowest-to-highest, a link 42, network 44, transport 48 and application 56 layers. However, more or fewer layers could also be used, and different layer designations could also be used for the layers in the protocol stack 38 (e.g., layering based on the Open Systems Interconnection (OSI) model including from lowest-to-highest, a physical, data-link, network, transport, session, presentation and application layer.).

The network devices 12, 14, 16, 31, 33, 35, 37, 106-112 are connected to the communication network 18 with Network Interface Card (NIC) cards including device drivers 40 in a link layer 42 for the actual hardware connecting the network devices 12, 14, 16, 31, 33, 35, 37, 106-112 to the communications network 18, 18′. For example, the NIC device drivers 40 may include a serial port device driver, a digital subscriber line (DSL) device driver, an Ethernet device driver, a wireless device driver, a wired device driver, etc. The device drivers interface with the actual hardware being used to connect the network devices to the communications network 18, 18′. The NIC cards have a Medium Access Control (MAC) address that is unique to each NIC and unique across the whole communications network 18, 18′. The Medium Access Control (MAC) protocol is used to provide a data link layer of an Ethernet LAN system and/or for other network systems.

Above the link layer 42 is a network layer 44 (also called the Internet Layer for Internet Protocol (IP) and IP related protocol suites). The network layer 44 includes, but is not limited to, an IP layer 46.

IP 46 is an addressing protocol designed to route traffic within a network or between networks. However, more, fewer or other protocols can also be used in the network layer 44, and the present invention is not limited to IP 46. For more information on IP 46 see IETF RFC-791, incorporated herein by reference.

Above network layer 44 is a transport layer 48. The transport layer 48 includes, but is not limited to, an optional Internet Group Management Protocol (IGMP) layer 50, a Internet Control Message Protocol (ICMP) layer 52, a Transmission Control Protocol (TCP) layer 52 and a User Datagram Protocol (UDP) layer 54. However, more, fewer or other protocols could also be used in the transport layer 48.

Optional IGMP layer 50, hereinafter IGMP 50, is responsible for multicasting. For more information on IGMP 50 see RFC-1112, incorporated herein by reference. ICMP layer 52, hereinafter ICMP 52 is used for IP 46 control. The main functions of ICMP 52 include error reporting, reachability testing (e.g., pinging, etc.), route-change notification, performance, subnet addressing and other maintenance. For more information on ICMP 52 see RFC-792, incorporated herein by reference. Both IGMP 50 and ICMP 52 are not required in the protocol stack 38. ICMP 52 can be used alone without optional IGMP layer 50.

TCP layer 54, hereinafter TCP 54, provides a connection-oriented, end-to-end reliable protocol designed to fit into a layered hierarchy of protocols which support multi-network applications. TCP 54 provides for reliable inter-process communication between pairs of processes in network devices attached to distinct but interconnected networks. For more information on TCP 54 see RFC-793, incorporated herein by reference.

UDP layer 56, hereinafter UDP 56, provides a connectionless mode of communications with datagrams in an interconnected set of computer networks. UDP 56 provides a transaction-oriented datagram protocol, where delivery and duplicate packet protection are not guaranteed. For more information on UDP 56 see RFC-768, incorporated herein by reference. Both TCP 54 and UDP 56 are not required in protocol stack 38. Either TCP 54 or UDP 56 can be used without the other.

Above transport layer 48 is an application layer 57 where application programs 58 (e.g., 30, 30a, 30b, 30c, 30d, 30e, 30f, etc.) to carry out desired functionality for a network device reside. For example, the application programs 58 for the client network devices 12, 14, 16, 31, 33, 35, 37, 106-112 may include web-browsers or other application programs, application program 30, while application programs for the server network devices 20, 22, 24, 26 may include other application programs (e.g., 30a, 30b, 30c, 30d, 30e, 30f etc.).

In one embodiment, the application layer 57 includes an Artificial Intelligence (AI) technology stack 57a (FIG. 3) is used within AI application 30c (FIG. 1) and includes complete, end-to-end solution that consists of hardware, software, and tools that facilitate the development and deployment of AI applications. The AI technology stack 57a includes specialized tools to support the building of AI models that enable machine learning and deep learning.

The AI technology stack 57a includes, but is not limited to, four foundational layers: an AI application layer 57b (FIG. 3) an AI model layer 57c, an AI data layer 57d, and an AI infrastructure layer 57e.

The AI application layer 57b of the AI tech stack 57a includes any software, user interfaces, and accessibility features that enable users to interact with the underlying AI models and the datasets that power an AI solution. For example, browser-based interfaces allow users to send questions to a Generative AI model like CHATGPT, or a data analytics suite including Predictive AI to provide visualizations in the form of graphs and charts to help users understand the AI model's results and/or Retrieval-Augmented Generation AI (RAG or RAG-AI) reduces LLM limitations.

Generative AI (GenAI, or GAI) is a subset of AI that uses Generative AI models to produce new text, images, videos, and/or other forms of data.

Predictive AI (PredAI or PAI) is also a subset of AI that uses Predictive AI models, machine learning and statistical analysis to forecast future events. Machine learning is a field of study in AI concerned with the development and study of statistical algorithms that can learn from data and generalize to unseen data, and thus perform tasks without explicit instructions.

Retrieval-Augmented Generation AI (RAG or RAG-AI) reduces LLM limitations by grounding AI responses in a defined set of materials (e.g., trusted databases or specific knowledge, e.g., law enforcement, behavior patterns, biometric information, etc.), increasing, accuracy, reducing AI hallucinations, increasing specificity and enabling more current information than the LLM training data alone.

In one embodiment the AI application 30c and/or the AI technology stack 57a, includes but is not limited to, a Generative AI component 57f and/or a Predictive AI component 57g. In one embodiment, the Generative AI component 57f and the Predictive AI component 57g are standalone components of the AI application 30c. In another embodiment, the Generative AI component 57f, the Predictive AI component 57g and the RAG AI component 57h are included as layers in the AI technology stack 57a. However, the present invention is not limited to such embodiments and other embodiments and/or other combinations can be used to practice the invention.

The AI model layer 57c of the AI technology stack 57a is where AI models are developed, trained, and optimized. AI models are developed using a combination of AI frameworks, toolsets, and libraries and are subsequently trained on vast amounts of data to help refine their decision-making processes.

The AI data layer 57d layer focuses on dataset collection, storage, and management, interfacing with and enabling all the other layers. Data from this layer is fed to the AI model layer 57c, new data from the AI application layer 57b is captured here for future model analysis, and the AI infrastructure layer 57e provides the resources needed to scale, secure, and reliably process the data.

The AI infrastructure layer 57e of the AI technology stack 57a includes all hardware and compute resources needed to run AI models in the AI model layer 57c and any user-facing software. This can include enterprise data centers, cloud 18 or non-cloud 18′ server network devices 20, 22, 24, 26, client/target network devices 12, 14, 16, 31, 35, 98-104, etc.

In one embodiment, the AI application 30c, includes but is not limited to, plural different AI agents. However, the present invention is not limited to such an embodiment and other embodiments, with more, fewer and/or other types of AI can be used to practice the invention.

In one exemplary embodiment, the plural AI agents 30c1, 30c2, etc. (FIG. 1), include, but are not limited to, the AI functionality included in Table 1.

```
TABLE 1
1. AI-Powered Generative AI Conversational Agent 30c
Description: Using Generative AI 57f to create advanced conversational agents that leverage
AI messaging to deliver hyper-personalized interactions. These agents can analyze customer
data, past interactions, and real-time context to provide tailored responses, product
recommendations, and support.
    AI Technologies:
      Hosted AI Models: Pre-trained models hosted the platform 204 for general
      use cases (e.g., sentiment analysis, intent recognition).
      Private Trained Models: Custom AI models fine-tuned on proprietary
      customer data to ensure specific tone, compliance, and accuracy.
      Large Language Models (LLMs): Integration with LLMs like GPT or
      proprietary LLMs for natural language understanding and generation.
      Multimodal AI: Combining text, image, and video analysis to enable richer
      interactions (e.g., analyzing a product image sent by a customer and
      suggesting solutions).
2. AI-Powered Predictive AI Analytics Agent 30c for Proactive User Engagement
    Description: Using Predictive AI 57g to analyze behavior, preferences, and historical
    data to predict future needs and proactively engage users via AI messaging. For
    example, predicting next location and sending timely, context-aware messages.
    AI Technologies:
      Public AI Models: Leveraging publicly available models for Predictive
      analytics (e.g., time-series forecasting models).
      Private Trained Models: Custom models trained on proprietary business
      data to predict customer behavior with high accuracy.
      Reinforcement Learning: AI systems that learn optimal engagement
      strategies over time by analyzing customer responses.
      Edge AI: Deploying lightweight AI models on devices to enable real-time
      predictions without relying on cloud infrastructure.
3. AI-Powered Retrieval Augmented Generation (RAG) 57h Agent 30c
    Description: Retrieval Augmented Generation (RAG) is an AI method that
    improves the accuracy and usefulness of an AI system by allowing it to retrieve
    information from external sources on the Internet or other networks before generating
    a response. Instead of relying only on what was learned during LLM training. RAG-
    AI searches documents, databases, websites, PDFs, or other knowledge sources and
    use that information when answering questions.
    AI Technologies
    Traditional AI Large Language Models (LLMs):
    Have a fixed knowledge base from their LLM training data.
    Can become create incomplete context and associations in LLMs.
    Can “hallucinate” (i.e., make up facts).
    Cannot easily access private or proprietary information.
    RAG-AI addresses these limitations by connecting the LLM to external knowledge
  sources and verifying LLM outputs with those external knowledge sources.
    RAG-AI retrieves relevant content and generates a synthesized answer from multiple
  knowledge bases rather than relying solely on the LLM's training data.
```

In one embodiment, application program 30 includes IVL application 30 including an identification verification and location information application 30a, an identification verification and location information application program interface (API) 30b, an Artificial Intelligence (AI) application 30c and/or other applications 30d, 30e, 30f. However, the present invention is not limited to such an embodiment and more, fewer and/or other applications can be used to practice the invention.

However, the protocol stack 38 is not limited to the protocol layers illustrated and more, fewer or other layers and protocols can also be used in protocol stack 38. In addition, other protocols from the Internet Protocol suites, including but not limited to, Simple Mail Transfer Protocol, (SMTP), Hyper Text Transfer Protocol (HTTP), File Transfer Protocol (FTP), Dynamic Host Configuration Protocol (DHCP), Domain Name System (DNS), Short Message Peer-to-Peer (SMPP), and/or other protocols from other protocol suites may also be used in protocol stack 38.

In addition, markup languages such as HyperText Markup Language (HTML), Extensible Markup Language (XML) and others are used.

HyperText Markup Language (HTML) is a markup language for creating web pages and other information that can be displayed in a web browser.

HTML is written in the form of HTML elements consisting of tags enclosed in angle brackets within the web page content. HTML tags most commonly come in pairs although some tags represent empty elements and so are unpaired. The first tag in a pair is the start tag, and the second tag is the end tag (they are also called opening tags and closing tags). In between these tags web designers can add text, further tags, comments and other types of text-based content.

The purpose of a web browser is to read HTML documents and compose them into visible or audible web pages. The browser does not display the HTML tags, but uses the tags to interpret the content of the page.

HTML elements form the building blocks of all websites. HTML allows images and objects to be embedded and can be used to create interactive forms. It provides a means to create structured documents by denoting structural semantics for text such as headings, paragraphs, lists, links, quotes and other items. It can embed scripts written in languages such as JavaScript which affect the behavior of HTML web pages.

Extensible Markup Language (XML) is another markup language that defines a set of rules for encoding documents in a format that is both human-readable and machine-readable. It is defined in the XML 1.0 Specification produced by the W3C, the contents of which are incorporated by reference and several other related specifications, all free open standards.

XML a textual data format with strong support via Unicode for the languages of the world. Although the design of XML focuses on documents, it is widely used for the representation of arbitrary data structures, for example in web services. The oldest schema language for XML is the Document Type Definition (DTD). DTDs within XML documents define entities, which are arbitrary fragments of text and/or markup tags that the XML processor inserts in the DTD itself and in the XML document wherever they are referenced, like character escapes.

The Short Message Peer-to-Peer (SMPP) protocol in the telecommunications industry is an open, industry standard protocol designed to provide a flexible data communication interface for the transfer of short message data between External Short Messaging Entities, Routing Entities (ESME) and Short Message Service Center (SMSC).

A Service Set Identifier (SSID) is a name of a Wi-Fi network that is broadcast by a wireless router or a wireless access point to server network devices 20, 22, 24, 26 and/or client network devices 12, 14, 16, 31, 33, 35, 37, 106-112.

Preferred embodiments of the present invention include network devices and wired and wireless interfaces that are compliant with all or part of standards proposed by the Institute of Electrical and Electronic Engineers (IEEE), International Telecommunications Union-Telecommunication Standardization Sector (ITU), European Telecommunications Standards Institute (ETSI), Internet Engineering Task Force (IETF), U.S. National Institute of Security Technology (NIST), American National Standard Institute (ANSI), Wireless Application Protocol (WAP) Forum, Bluetooth Forum, or the ADSL Forum.

### Wireless Interfaces

In one embodiment of the present invention, the wireless interfaces on network devices 12, 14, 16, 31, 33, 35, 37, 106-112 include but are not limited to, IEEE 802.11a, 802.11b, 802.11g, 802.11n, 802.11ac, 802.11ax, 802.11be, 802.15.4 (ZigBee), “Wireless Fidelity” (Wi-Fi), “Worldwide Interoperability for Microwave Access” (WiMAX), ETSI High Performance Radio Metropolitan Area Network (HIPERMAN) or “RF Home” integral or separate Bluetooth and/or infra data association (IrDA) module for wireless BLUEOOTH and/or other types of wireless communications interfaces. However, the present invention is not limited to such an embodiment other types of wireless communications interfaces can also be used.

802.11b is a short-range wireless network standard. The IEEE 802.11b standard defines wireless interfaces that provide up to 11 Mbps wireless data transmission to and from wireless devices over short ranges. 802.11a is an extension of the 802.11b and can deliver speeds up to 54 Mbps. 802.11g deliver speeds on par with 802.11a. However, other 802.11XX interfaces can also be used and the present invention is not limited to the 802.11 protocols defined. The IEEE 802.11a, 802.11b and 802.11g standards are incorporated herein by reference.

802.11ac is a Wi-Fi standard, also known as Wi-Fi 5, that provides significantly faster and more efficient wireless connections compared to its predecessor, 802.11n. It operates exclusively on the 5 GHz band and uses technologies like wider channels, more spatial streams, multiple input multiple output (MIMO), and improved data encoding to achieve multi-gigabit speeds, making it ideal for high-bandwidth activities like 4K streaming and online gaming.

802.11ax is the technical name for the Wi-Fi 6 standard, a next-generation wireless networking protocol designed to improve speed, efficiency, and capacity, especially in crowded network environments. It uses technologies like Orthogonal frequency-division multiple access (OFDMA) and enhanced multi-user multiple input multiple output (MU-MIMO) to handle more connected devices simultaneously with higher throughput and lower latency compared to its predecessor, 802.11ac (Wi-Fi 5).

802.11be is a formal designation for the Wi-Fi 7 wireless networking standard, which offers significantly higher speeds, lower latency, and improved efficiency compared to previous generations. Key advancements include wider channel widths (up to 320 MHz), enhanced modulation (4096-Quadrature Amplitude Modulation (QAM)), more spatial streams, and the ability to use multiple bands and links simultaneously to improve performance. This results in speeds up to 40 Gbps and makes it suitable for demanding applications like high-definition streaming, large file transfers, and real-time artificial realities and virtual realities.

Wi-Fi is a type of 802.11xx interface, whether 802.11b, 802.11a, 802.11ac, 802.11ax, 802.11be, dual-band, etc. Wi-Fi devices include an RF interface such as 2.4 GHz for 802.11b, 802.11g and others and 5 GHz for 802.11a, 802.11ac, 802.11ax, 802.11be and others.

802.15.4 (Zigbee) is low data rate network standard used for mesh network devices such as sensors, interactive toys, smart badges, remote controls, and home automation. The 802.15.4 standard provides data rates of 250 kbps, 40 kbps, and 20 kbps., two addressing modes; 16-bit short and 64-bit IEEE addressing, support for critical latency devices, such as joysticks, Carrier Sense Multiple Access/Collision Avoidance, (CSMA-CA) channel access, automatic network establishment by a coordinator, a full handshake protocol for transfer reliability, power management to ensure low power consumption for multi-month to multi-year battery usage and up to 16 channels in the 2.4 GHz Industrial, Scientific and Medical (ISM) band (Worldwide), 10 channels in the 915 MHz (US) and one channel in the 868 MHz band (Europe). The IEEE 802.15.4-2003 standard is incorporated herein by reference.

WiMAX is an industry trade organization formed by leading communications component and equipment companies to promote and certify compatibility and interoperability of broadband wireless access equipment that conforms to the IEEE 802.16XX and ETSI HIPERMAN. HIPERMAN is the European standard for metropolitan area networks (MAN).

The IEEE The 802.16a and 802.16g standards are wireless MAN technology standard that provides a wireless alternative to cable, DSL and T1/E1 for last mile broadband access. It is also used as complimentary technology to connect IEEE 802.11XX hot spots to the Internet.

The IEEE 802.16a standard for 2-11 GHz is a wireless MAN technology that provides broadband wireless connectivity to fixed, portable and nomadic devices. It provides up to 50-kilometers of service area range, allows users to get broadband connectivity without needing direct line of sight with the base station, and provides total data rates of up to 280 Mbps per base station, which is enough bandwidth to simultaneously support hundreds of businesses with T1/E1-type connectivity and thousands of homes with DSL-type connectivity with a single base station. The IEEE 802.16g provides up to 100 Mbps.

The IEEE 802.16e standard is an extension to the approved IEEE 802.16/16a/16g standard. The purpose of 802.16e is to add limited mobility to the current standard which is designed for fixed operation.

The ESTI HIPERMAN standard is an interoperable broadband fixed wireless access standard for systems operating at radio frequencies between 2 GHz and 11 GHz.

The IEEE 802.16a, 802.16e and 802.16g standards are incorporated herein by reference. WiMAX can be used to provide a WLP.

The ETSI HIPERMAN standards TR 101 031, TR 101 475, TR 101 493-1 through TR 101 493-3, TR 101 761-1 through TR 101 761-4, TR 101 762, TR 101 763-1 through TR 101 763-3 and TR 101 957 are incorporated herein by reference. ETSI HIPERMAN can be used to provide a WLP.

In one embodiment, the plural server network devices 20, 22, 24, 26 include a connection to plural network interface cards (NICs) in a backplane connected to a communications bus. The NIC cards provide gigabit/second (1×10⁹ bits/second) communications speed of electronic information. This allows “scaling out” for fast electronic content retrieval. The NICs are connected to the plural server network devices 20, 22, 24, 26 and the cloud communications network 18. However, the present invention is not limited to the NICs described and other types of NICs in other configurations and connections with and/or without buses can also be used to practice the invention.

In one embodiment, of the invention, the wireless interfaces also include wireless personal area network (WPAN) interfaces. As is known in the art, a WPAN is a personal area network for interconnecting devices centered around an individual person's devices in which the connections are wireless. A WPAN interconnects all the ordinary computing and communicating devices that a person has on their desk (e.g. computer, etc.) or carry with them (e.g., PDA, mobile phone, smart phone, table computer two-way pager, etc.)

A key concept in WPAN technology is known as “plugging in.” In the ideal scenario, when any two WPAN-equipped devices come into close proximity (within several meters and/or feet of each other) or within a few miles and/or kilometers of a central server (not illustrated), they can communicate via wireless communications as if connected by a cable. WPAN devices can also lock out other devices selectively, preventing needless interference or unauthorized access to secure information. Zigbee is one wireless protocol used on WPAN networks such as cloud communications network 18 or non-cloud communications network 18′.

The one or more target network devices 12, 14, 16, 20, 22, 24, 26, 31, 98-104 and one or more server network devices 20, 22, 24, 26 communicate with each other and other network devices with near field communications (NFC) and/or machine-to-machine (M2M) communications.

“Near field communication (NFC)” is a set of standards for smartphones and similar network devices to establish radio communication with each other by touching them together or bringing them into close proximity, usually no more than a few centimeters. Present applications include contactless transactions, data exchange, and simplified setup of more complex communications such as Wi-Fi. Communication is also possible between an NFC device and an unpowered NFC chip, called a “tag” including radio frequency identifier (RFID) tags and/or RFID sensors and/or RFID network devices 99 including one or more RFID tags, RFID sensors and/or a combination thereof.

NFC standards cover communications protocols and data exchange formats, and are based on existing radio-frequency identification (RFID) standards including ISO/IEC 14443 and FeliCa. These standards include ISO/IEC 1809 and those defined by the NFC Forum, all of which are incorporated by reference.

An “RFID tag” is an object that can be applied to or incorporated into a product, animal, or person for the purpose of identification and/or tracking using RF signals.

An “RFID sensor” and/or RFID network device is a device that measures a physical quantity and converts it into an RF signal which can be read by an observer or by an instrument (e.g., target network devices 12, 14, 16, 20, 22, 24, 26, 31, 33, 35, 37, 98-104, server network devices 20, 22, 24, 26, etc.).

“Machine to machine (M2M)” refers to technologies that allow both wireless and wired systems to communicate with other devices of the same ability. M2M uses a device to capture an event (such as option purchase, etc.), which is relayed through a network (wireless, wired cloud, etc.) to an application (software program), that translates the captured event into meaningful information. Such communication was originally accomplished by having a remote network of machines relay information back to a central hub for analysis, which would then be rerouted into a system like a personal computer.

However, modern M2M communication has expanded beyond a one-to-one connection and changed into a system of networks that transmits data many-to-one and many-to-many to plural different types of devices and appliances. The expansion of IP networks across the world has made it far easier for M2M communication to take place and has lessened the amount of power and time necessary for information to be communicated between machines.

However, the present invention is not limited to such wireless interfaces and wireless networks and more, fewer and/or other wireless interfaces can be used to practice the invention.

### Wired Interfaces

In one embodiment of the present invention, the wired interfaces include wired interfaces and corresponding networking protocols for wired connections to the Public Switched Telephone Network (PSTN) and/or a cable television network (CATV) and/or satellite television networks (SATV) and/or three-dimensional television (3DTV), including HDTV that connect the network devices 12, 14, 16, 31, 33, 35, 37, 106-112 via one or more twisted pairs of copper wires, digital subscriber lines (e.g. DSL, ADSL, VDSL, etc.) coaxial cable, fiber optic cable, other connection media or other connection interfaces. The PSTN is any public switched telephone network provided by AT&T, GTE, Sprint, MCI, SBC, Verizon and others. The CATV is any cable television network provided by the Comcast, Time Warner, etc. However, the present invention is not limited to such wired interfaces and more, fewer and/or other wired interfaces can be used to practice the invention.

### Television Services

In one embodiment, the cloud applications 30, 30a, 30b, 30c, 30d, 30e, 30f provide cloud SaaS 64 services and/or non-cloud application services from television services over the cloud communications network 18 or application services over the non-cloud communications network 18′. The television services include digital television services, including, but not limited to, cable television, satellite television, high-definition television, three-dimensional, televisions and other types of network devices.

However, the present invention is not limited to such television services and more, fewer and/or other television services can be used to practice the invention.

### Internet Television Services

In one embodiment, the cloud applications 30, 30a, 30b, 30c, 30d, 30e, 30f provide cloud SaaS 64 services and/or non-cloud application services from Internet television services over the cloud communications network 18 or non-cloud communications network 18′.

The television services include Internet television, Web-TV, and/or Internet Protocol Television (IPtv) and/or other broadcast television services.

“Internet television” allows users to choose a program or the television show they want to watch from an archive of programs or from a channel directory. The two forms of viewing Internet television are streaming content directly to a media player or simply downloading a program to a viewer's set-top box, game console, computer, or other network device.

“Web-TV” delivers digital content via broadband and mobile networks. The digital content is streamed to a viewer's set-top box, game console, computer, or other network device.

“Internet Protocol television (IPtv)” is a system through which Internet television services are delivered using the architecture and networking methods of the Internet Protocol Suite over a packet-switched network infrastructure, e.g., the Internet and broadband Internet access networks, instead of being delivered through traditional radio frequency broadcast, satellite signal, and cable television formats.

However, the present invention is not limited to such Internet Television services and more, fewer and/or other Internet Television services can be used to practice the invention.

### General Search Engine Services

In one embodiment, the cloud applications 30, 30a, 30b, 30c, 30d, 30e, 30f provide cloud SaaS 64 services and/or non-cloud application services from general search engine services. A search engine is designed to search for information on a cloud communications network 18 or non-cloud communications network 18′ such as the Internet including World Wide Web servers, HTTP, FTP servers etc. The search results are generally presented in a list of electronic results. The information may consist of web pages, images, electronic information, multimedia information, and other types of files. Some search engines also mine data available in databases or open directories. Unlike web directories, which are maintained by human editors, search engines typically operate algorithmically and/or are a mixture of algorithmic and human input.

In one embodiment, the cloud applications 30, 30a, 30b, 30c, 30d, 30e, 30f provide cloud SaaS 64 services and/or non-cloud application services from general search engine services. In another embodiment, the cloud applications 30, 30a, 30b, 30c, 30d, 30e, 30f provide general search engine services by interacting with one or more other public search engines (e.g., GOOGLE, BING, YAHOO, etc.) and/or private search engine services.

In another embodiment, the cloud applications 30, 30a, 30b, 30c, 30d, 30e, 30f provide cloud SaaS 64 services and/or non-cloud application services from specialized search engine services, such as vertical search engine services by interacting with one or more other public vertical search engines and/or private search engine services.

However, the present invention is not limited to such general and/or vertical search engine services and more, fewer and/or other general search engine services can be used to practice the invention.

### Social Networking Services

In one embodiment, the cloud applications 30, 30a, 30b, 30c, 30d, 30e, 30f provide cloud SaaS 64 services and/or non-cloud application services from one more social networking services including to/from one or more social networking web-sites (e.g., FACEBOOK, YOUTUBE, TWITTER-X, TICTOK, INSTAGRAM, etc.). The social networking web-sites also include, but are not limited to, social couponing sites, dating web-sites, blogs, RSS feeds, podcasts and other types of information web-sites in which messages can be left or posted for a variety of social activities.

However, the present invention is not limited to the social networking services described and other public and private social networking services can also be used to practice the invention.

### Security and Encryption

Network devices 12, 14, 16, 20, 22, 24, 26, 31, 33, 35, 37, 106-112 with wired and/or wireless interfaces of the present invention include one or more of the security and encryptions techniques discussed herein for secure communications on the cloud communications network 18 or non-cloud communications network 18′.

Application programs 58 (FIG. 2) include security and/or encryption application programs integral to and/or separate from the applications 30, 30a, 30b, 30c, 30d. Security and/or encryption programs may also exist in hardware components on the network devices (12, 14, 16, 20, 22, 24, 26, 31, 33, 35, 37, 106-112) described herein and/or exist in a combination of hardware, software and/or firmware.

Wireless Encryption Protocol (WEP) (also called “Wired Equivalent Privacy) is a security protocol for WiLANs defined in the IEEE 802.11b standard. WEP is cryptographic privacy algorithm, based on the Rivest Cipher 4 (RC4) encryption engine, used to provide confidentiality for 802.11b wireless data.

RC4 is cipher designed by RSA Data Security, Inc. of Bedford, Massachusetts, which can accept encryption keys of arbitrary length, and is essentially a pseudo random number generator with an output of the generator being XORed with a data stream to produce encrypted data.

WEP is used at the two lowest layers of the OSI model, the physical layer and the data link layer, therefore, it does not offer end-to-end security. WEP also uses encryption keys are static rather than dynamic. To update WEP encryption keys, an individual has to manually update a WEP key. WEP also typically uses 40-bit static keys for encryption and thus provides “weak encryption,” making a WEP device a target of hackers.

The IEEE 802.11 Working Group is working on a security upgrade for the 802.11 standard called “802.11i.” This supplemental draft standard is intended to improve WiLAN security. It describes the encrypted transmission of data between systems 802.11X WiLANs. It also defines new encryption key protocols including the Temporal Key Integrity Protocol (TKIP). The IEEE 802.11i draft standard, version 4, completed Jun. 6, 2003, is incorporated herein by reference.

The 802.11i standard is based on 802.1x port-based authentication for user and device authentication. The 802.11i standard includes two main developments: Wi-Fi Protected Access (WPA) and Robust Security Network (RSN).

WPA uses the same RC4 underlying encryption algorithm as WEP. However, WPA uses TKIP to improve security of keys used with WEP. WPA keys are derived and rotated more often than WEP keys and thus provide additional security. WPA also adds a message-integrity-check function to prevent packet forgeries.

RSN uses dynamic negotiation of authentication and selectable encryption algorithms between wireless access points and wireless devices. The authentication schemes proposed in the draft standard include Extensible Authentication Protocol (EAP). One proposed encryption algorithm is an Advanced Encryption Standard (AES) encryption algorithm.

Dynamic negotiation of authentication and encryption algorithms lets RSN evolve with the state of the art in security, adding algorithms to address new threats and continuing to provide the security necessary to protect information that WiLANs carry.

The NIST developed a new encryption standard, the Advanced Encryption Standard (AES) to keep government information secure. AES is intended to be a stronger, more efficient successor to Triple Data Encryption Standard (3DES).

DES is a popular symmetric-key encryption method developed in 1975 and standardized by ANSI in 1981 as ANSI X.3.92, the contents of which are incorporated herein by reference. As is known in the art, 3DES is the encrypt-decrypt-encrypt (EDE) mode of the DES cipher algorithm. 3DES is defined in the ANSI standard, ANSI X9.52-1998, the contents of which are incorporated herein by reference. DES modes of operation are used in conjunction with the NIST Federal Information Processing Standard (FIPS) for data encryption (FIPS 46-3, October 1999), the contents of which are incorporated herein by reference.

The NIST approved a FIPS for the AES, FIPS-197. This standard specified “Rijndael” encryption as a FIPS-approved symmetric encryption algorithm that may be used by U.S. Government organizations (and others) to protect sensitive information. The NIST FIPS-197 standard (AES FIPS PUB 197, November 2001) is incorporated herein by reference.

The NIST approved a FIPS for U.S. Federal Government requirements for information technology products for sensitive but unclassified (SBU) communications. The NIST FIPS Security Requirements for Cryptographic Modules (FIPS PUB 140-2, May 2001) is incorporated herein by reference.

RSA is a public key encryption system which can be used both for encrypting messages and making digital signatures. The letters RSA stand for the names of the inventors: Rivest, Shamir and Adleman. For more information on RSA, see U.S. Pat. No. 4,405,829, now expired and incorporated herein by reference.

“Hashing” is the transformation of a string of characters into a usually shorter fixed-length value or key that represents the original string. Hashing is used to index and retrieve items in a database because it is faster to find the item using the shorter hashed key than to find it using the original value. It is also used in many encryption algorithms.

Secure Hash Algorithm (SHA), is used for computing a secure condensed representation of a data message or a data file. When a message of any length <2⁶⁴ bits is input, the SHA-1 produces a 160-bit output called a “message digest.” The message digest can then be input to other security techniques such as encryption, a Digital Signature Algorithm (DSA) and others which generates or verifies a security mechanism for the message. SHA-512 outputs a 512-bit message digest. The Secure Hash Standard, FIPS PUB 180-1, Apr. 17, 1995, is incorporated herein by reference.

Message Digest-5 (MD-5) takes as input a message of arbitrary length and produces as output a 128-bit “message digest” of the input. The MD5 algorithm is intended for digital signature applications, where a large file must be “compressed” in a secure manner before being encrypted with a private (secret) key under a public-key cryptosystem such as RSA. The IETF RFC-1321, entitled “The MD5 Message-Digest Algorithm” is incorporated here by reference.

Providing a way to check the integrity of information transmitted over or stored in an unreliable medium such as a wireless network is a prime necessity in the world of open computing and communications. Mechanisms that provide such integrity check based on a secret key are called “message authentication codes” (MAC). Typically, message authentication codes are used between two parties that share a secret key in order to validate information transmitted between these parties.

Keyed Hashing for Message Authentication Codes (HMAC), is a mechanism for message authentication using cryptographic hash functions. HMAC is used with any iterative cryptographic hash function, e.g., MD5, SHA-1, SHA-512, etc. in combination with a secret shared key. The cryptographic strength of HMAC depends on the properties of the underlying hash function. The IETF RFC-2101, entitled “HMAC: Keyed-Hashing for Message Authentication” is incorporated here by reference.

An Electronic Code Book (ECB) is a mode of operation for a “block cipher,” with the characteristic that each possible block of plaintext has a defined corresponding cipher text value and vice versa. In other words, the same plaintext value will always result in the same cipher text value. Electronic Code Book is used when a volume of plaintext is separated into several blocks of data, each of which is then encrypted independently of other blocks. The Electronic Code Book has the ability to support a separate encryption key for each block type.

Diffie and Hellman (DH) describe several different group methods for two parties to agree upon a shared secret in such a way that the secret will be unavailable to eavesdroppers. This secret is then converted into various types of cryptographic keys. A large number of the variants of the DH method exist including ANSI X9.42. The IETF RFC-2631, entitled “Diffie-Hellman Key Agreement Method” is incorporated here by reference.

Perceptual hashing is a method for creating a short digital fingerprint of digital media usually an image, video frame, video clip and/or audio clip, etc. based on how it appears or is perceived, rather than its exact file data. Unlike a cryptographic hash such as SHA-512, perceptual hashes are designed so that visually similar files produce similar hash values.

Perceptual hashes are often compared using Hamming distance, which counts how many bits differ between two hashes. A small Hamming distance means the media items are probably similar. Typical uses include duplicate image detection, copyright monitoring, content moderation, malware-image clustering, and finding altered versions of the same picture.

A Hamming distance is a measure of how many positions differ between two strings of equal length. It is commonly used with binary data, error-correcting codes, and perceptual hashes. In perceptual hashing systems, the Hamming distance is often the primary metric used to determine how visually similar two images are.

For example, aHash, an average perceptual hash, compares pixels to the image's average brightness, dHash, a difference perceptual hash looks at brightness differences between neighboring pixels; pHash, a general perceptual hash uses frequency analysis, often with a discrete cosine transform, to capture the image's visual structure; and wHash, a wavelet perceptual hash uses wavelet transforms to compare broader visual features.

The HyperText Transport Protocol (HTTP) Secure (HTTPs), is a standard for encrypted communications on the World Wide Web. HTTPs is actually just HTTP over a Secure Sockets Layer (SSL). For more information on HTTP, see IETF RFC-2616 incorporated herein by reference.

The SSL protocol is a protocol layer which may be placed between a reliable connection-oriented network layer protocol (e.g. TCP/IP) and the application protocol layer (e.g. HTTP). SSL provides for secure communication between a source and destination by allowing mutual authentication, the use of digital signatures for integrity, and encryption for privacy.

The SSL protocol is designed to support a range of choices for specific security methods used for cryptography, message digests, and digital signatures. The security methods are negotiated between the source and destination at the start of establishing a protocol session. The SSL 2.0 protocol specification, by Kipp E.B. Hickman, 1995 is incorporated herein by reference.

Transport Layer Security (TLS) provides communications privacy over the Internet. The protocol allows client/server applications to communicate over a transport layer (e.g., TCP) in a way that is designed to prevent eavesdropping, tampering, or message forgery. For more information on TLS see IETF RFC-2246, incorporated herein by reference.

In one embodiment, the security functionality includes Cisco Compatible EXtensions (CCX). CCX includes security specifications for makers of 802.11xx wireless LAN chips for ensuring compliance with Cisco's proprietary wireless security LAN protocols. As is known in the art, Cisco Systems, Inc. of San Jose, California is supplier of networking hardware and software, including router and security products.

However, the present invention is not limited to such security and encryption methods described herein and more, fewer and/or other types of security and encryption methods can be used to practice the invention. The security and encryption methods described herein can also be used in various combinations and/or in different layers of the protocol stack 38 with each other.

### Cloud Computing Networks

FIG. 4 is a block diagram 60 illustrating an exemplary cloud computing network 18. The cloud computing network 18 is also referred to as a “cloud communications network” 18. However, the present invention is not limited to this cloud computing model and other cloud computing models can also be used to practice the invention. The exemplary cloud communications network includes both wired and/or wireless components of public and private networks.

In one embodiment, the cloud computing network 18 includes a cloud communications network 18 comprising plural different cloud component networks 72, 74, 76, 78. “Cloud computing” is a model for enabling, on-demand network access to a shared pool of configurable computing resources (e.g., public and private networks, servers, storage, applications, and services) that are shared, rapidly provisioned and released with minimal management effort or service provider interaction.

This exemplary cloud computing model for electronic information retrieval promotes availability for shared resources and comprises: (1) cloud computing essential characteristics; (2) cloud computing service models; and (3) cloud computing deployment models. However, the present invention is not limited to this cloud computing model and other cloud computing models can also be used to practice the invention.

Exemplary cloud computing essential characteristics appear in Table 2. However, the present invention is not limited to these essential characteristics and more, fewer or other characteristics can also be used to practice the invention.

```
TABLE 1
1. On-demand identification, verification and/or location information
  services. Automatic identification, verification and/or location
  information services can unilaterally provision computing capabilities,
  such as server time and network storage, as needed automatically
  without requiring human interaction with each network server 20, 22,
  24, 26 on the cloud communications network 18.
2. Broadband network access. Automatic identification, verification and/or
  location information services capabilities are available over plural
  broadband communications networks and accessed through standard
  mechanisms that promote use by heterogeneous thin or thick client
  platforms (e.g., network devices, 12, 14, 16, 31, 33, 35, 37, 106-112,
  etc.). The broadband network access includes high speed network
  access such as 3G, 4G and 5G wireless and/or wired and broadband
  and/or ultra-broad band (e.g., WiMAX, etc.) network access.
3. Resource pooling. Automatic identification, verification and/or location
  information services resources are pooled to serve multiple requesters
  using a multi-tenant model, with different physical and virtual resources
  dynamically assigned and reassigned according to demand. There is
  location independence in that a requester of services has no control and/
  or knowledge over the exact location of the provided by the
  identification, verification and/or location information service resources
  but may be able to specify location at a higher level of abstraction (e.g.,
  country, state, or data center). Examples of pooled resources include
  storage, processing, memory, network bandwidth, virtual server
  network device and virtual target network devices.
4. Rapid elasticity. Capabilities can be rapidly and elastically provisioned,
  in some cases automatically, to quickly scale out and rapidly released to
  quickly scale for identification, verification and/or location information
  service collaboration. For automatic identification, verification and/or
  location information services, multi-media collaboration converters, the
  automatic identification, verification and/or location information
  services, collaboration and analytic conversion capabilities available for
  provisioning appear to be unlimited and can be used in any quantity at
  any time.
5. Measured Services. Cloud computing systems automatically control and
  optimize resource use by leveraging a metering capability at some level
  of abstraction appropriate to the type of automatic identification,
  verification and/or location information services (e.g., storage,
  processing, bandwidth, custom electronic content retrieval applications,
  etc.). Electronic Automatic RCS interoperability services collaboration
  conversion usage is monitored, controlled, and reported providing
  transparency for both the automatic RCS interoperability services
  provider and the automatic identification, verification and/or location
  information service requester of the utilized electronic content storage
  retrieval service.
```

Exemplary cloud computing service models illustrated in FIG. 4 appear in Table 3. However, the present invention is not limited to these service models and more, fewer or other service models can also be used to practice the invention.

```
TABLE 2
1. Cloud Computing Software Applications 62 for identification,
  verification and/or location information services (CCSA, SaaS 64).
  The capability to use the provider's applications 30, 30a, 30b,
  30c, 30d, 30e, 30f running on a cloud infrastructure 66. The cloud
  computing applications 62, are accessible from the server network
  device 20, 22, 24, 26 from various client devices 12, 14, 16, 31,
  33, 35, 37, 106-112 through a thin client interface such as a web
  browser, etc. The user does not manage or control the underlying
  cloud infrastructure 66 including network, servers, operating
  systems, storage, or even individual application 30, 30a, 30b,
  30c, 30d, 30e, 30f capabilities, with the possible exception of
  limited user-specific application configuration settings.
2. Cloud Computing Infrastructure 66 for identification, verification and/or
  location information services (CCI 68). The capability provided to the
  user is to provision processing, storage and retrieval, networks 18, 72,
  74, 76, 78 and other fundamental computing resources where the
  consumer is able to deploy and run arbitrary software, which can
  include operating systems and applications 30, 30a, 30b, 30c, 30d, 30e,
  30f. The user does not manage or control the underlying cloud
  infrastructure 66 but has control over operating systems, storage,
  deployed applications, and possibly limited control of select networking
  components (e.g., host firewalls, etc.).
3. Cloud Computing Platform 70 for identification, verification and/or
  location information services (CCP 71). The capability provided to the
  user to deploy onto the cloud infrastructure 66 created or acquired
  applications created using programming languages and tools supported
  servers 20, 22, 24, 26, etc. The user not manage or control the
  underlying cloud infrastructure 66 including network, servers, operating
  systems, or storage, but has control over the deployed applications 30a,
  30b, 30c, 30d, 30e, 30f and possibly application hosting environment
  configurations.
```

Exemplary cloud computing deployment models appear in Table 4. However, the present invention is not limited to these deployment models and more, fewer or other deployment models can also be used to practice the invention.

```
TABLE 3
1. Private cloud network 72. The cloud network infrastructure is operated
  solely for identification, verification and/or location information
  services. It may be managed by the electronic content retrieval or a third
  party and may exist on premise or off premise.
2. Community cloud network 74. The cloud network infrastructure is
  shared by several different organizations and supports a specific
  electronic content storage and retrieval community that has shared
  concerns (e.g., mission, security requirements, policy, compliance
  considerations, etc.). It may be managed by the different organizations
  or a third party and may exist on premise or off premise.
3. Public cloud network 76. The cloud network infrastructure such as the
  Internet, PSTN, SATV, CATV, Internet TV, etc. is made available to
  the general public or a large industry group and is owned by one or
  more organizations selling cloud services.
4. Hybrid cloud network 78. The cloud network infrastructure 66 is a
  composition of two and/or more cloud networks 18 (e.g., private 72,
  community 74, and/or public 76, etc.) and/or other types of public
  and/or private networks (e.g., intranets, etc.) that remain unique entities
  but are bound together by standardized or proprietary technology that
  enables data and application portability (e.g., cloud bursting for load-
  balancing between clouds, etc.)
```

Cloud software 64 for electronic content retrieval takes full advantage of the cloud paradigm by being service oriented with a focus on statelessness, low coupling, modularity, and semantic interoperability for electronic content retrieval. However, cloud software services 64 can include various states.

Cloud storage of desired electronic content on a cloud computing network includes agility, scalability, elasticity and multi-tenancy. Although a storage foundation may be comprised of block storage or file storage such as that exists on conventional networks, cloud storage is typically exposed to requesters of desired electronic content as cloud objects.

In one exemplary embodiment, the cloud application 30, 30a, 30b, 30c, 30d, 30e, 30f offers cloud services for identification verification and/or location information of the desired person 41. The application 30, 30a, 30b, 30c, 30d, 30e, 30f offers the cloud computing Infrastructure 66, 68 as a Service 62 (IaaS), including a cloud software infrastructure service 62, the cloud Platform 70, 71 as a Service 62 (PaaS) including a cloud software platform service 62 and/or offers Specific cloud software services as a Service 64 (SaaS) including one or more specific cloud software services 64 for multi-layer copyright verification and collaboration services 203 requested by a user 39. The IaaS, PaaS and SaaS include one or more of cloud services 62 comprising networking, storage, server network device, virtualization, operating system, middleware, run-time, data and/or application services, or plural combinations thereof, on the cloud communications network 18.

FIG. 5 is a block diagram 80 illustrating an exemplary cloud storage object 82. One or more server network devices (e.g., 20, 22, 24, 26, etc.) store portions 13′, 15′ of the electronic message content 13, 15 (e.g., electronic identification verification and/or location information, etc.) as cloud storage objects 82 (FIG. 5) as is described herein.

The cloud storage object 82 includes an envelope portion 84, with a header portion 86, and a body portion 88. However, the present invention is not limited to such a cloud storage object 82 and other cloud storage objects and other cloud storage objects with more, fewer or other portions can also be used to practice the invention.

The envelope portion 84 uses unique namespace Uniform Resource Identifiers (URIs) and/or Uniform Resource Names (URNs), and/or Uniform Resource Locators (URLs) unique across the cloud communications network 18 to uniquely specify, location and version information and encoding rules used by the cloud storage object 82 across the whole cloud communications network 18. For more information, see IETF RFC-3305, Uniform Resource Identifiers (URIs), URLs, and Uniform Resource Names (URNs), the contents of which are incorporated by reference.

The envelope portion 84 of the cloud storage object 82 is followed by a header portion 86. The header portion 86 includes extended information about the cloud storage objects such as authorization and/or transaction information, etc.

The body portion 88 includes methods 90 (i.e., a sequence of instructions, etc.) for using embedded application-specific data in data elements 92. The body portion 88 typically includes only one portion of plural portions of application-specific data 92 and independent data 94 so the cloud storage object 82 can provide distributed, redundant fault tolerant, security and privacy features described herein.

Cloud storage objects 82 have proven experimentally to be a highly scalable, available and reliable layer of abstraction that also minimizes the limitations of common file systems. Cloud storage objects 82 also provide low latency and low storage and transmission costs.

Cloud storage objects 82 are comprised of many distributed resources, but function as a single storage object, are highly fault tolerant through redundancy and provide distribution of desired electronic content across public communication networks 76, and one or more private networks 72, community networks 74 and hybrid networks 78 of the cloud communications network 18. Cloud storage objects 82 are also highly durable because of creation of copies of portions of desired electronic content across such networks 72, 74, 76, 78 of the cloud communications network 18. Cloud storage objects 82 includes one or more portions of desired electronic content and can be stored on any of the 72, 74, 76, 78 networks of the cloud communications network 18. Cloud storage objects 82 are transparent to a requester of desired electronic content and are managed by cloud applications 30, 30a, 30b, 30c, 30d, 30e, 30f.

In one embodiment, cloud storage objects 82 are configurable arbitrary objects with a size up to hundreds of terabytes, each accompanied by with a few kilobytes of metadata. Cloud objects are organized into and identified by a unique identifier (e.g., Universally Unique Identifier (UUID), etc.) unique across the whole cloud communications network 18. However, the present invention is not limited to the cloud storage objects described, and more fewer and other types of cloud storage objects can be used to practice the invention.

A Universally Unique Identifier (UUID), is a 128-bit number used to uniquely identify an object, record, device, transaction, file, or other entity across systems without requiring a central authority. UUIDs are widely used in modern software systems because they allow millions of computers to create identifiers independently while maintaining an extremely high probability of uniqueness and a high probability that no two software systems will create the same UUID.

Cloud storage objects 82 present a single unified namespace or object-space and manages desired electronic content by user or administrator-defined policies storage and retrieval policies. Cloud storage objects includes: Representational state transfer (REST), Simple Object Access Protocol (SOAP), Lightweight Directory Access Protocol (LDAP) and/or Application Programming Interface (API) objects and/or other types of cloud storage objects. However, the present invention is not limited to the cloud storage objects described, and more fewer and other types of cloud storage objects can be used to practice the invention.

REST is a protocol specification that characterizes and constrains macro-interactions storage objects of the four components of a cloud communications network 18, namely origin servers, gateways, proxies and clients, without imposing limitations on the individual participants.

SOAP is a protocol specification for exchanging structured information in the implementation of cloud services with storage objects. SOAP has at least three major characteristics: (1) Extensibility (including security/encryption, routing, etc.); (2) Neutrality (SOAP can be used over any transport protocol such as HTTP, SMTP or even TCP, etc.), and (3) Independence (SOAP allows for almost any programming model to be used, etc.)

LDAP is a software protocol for enabling storage and retrieval of electronic content and other resources such as files and devices on the cloud communications network 18. LDAP is a “lightweight” version of Directory Access Protocol (DAP), which is part of X.500, a standard for directory services in a network. LDAP may be used with X.509 security and other security methods for secure storage and retrieval. X.509 is public key digital certificate standard developed as part of the X.500 directory specification. X.509 is used for secure management and distribution of digitally signed certificates across networks.

An API is a particular set of rules and specifications that software programs can follow to communicate with each other. It serves as an interface between different software programs and facilitates their interaction and provides access to automatic identification verification and/or location information of a desired person services in a cloud or non-cloud environment. In one embodiment, the API for RCS interoperability services is available to network devices 12, 14, 16, 20, 22, 24, 26, 31, 33, 35, 37, 98-104 and networks 18, 18′. However, the present invention is not limited to such an embodiment and other embodiments can be used to practice the invention.

### Wearable Devices

Wearable technology” and/or “wearable devices” are clothing and accessories incorporating computer and advanced electronic technologies. Wearable network devices provide several advantages including, but not limited to: (1) Quicker access to notifications. Important and/or summary notifications are sent to alert a user to view the whole message. (2) Heads-up information. Digital eye wear allows users to display relevant information like directions without having to constantly glance down; (3) Always-on Searches.

Wearable devices provide always-on, hands-free searches; and (4) Recorded data and feedback. Wearable devices take telemetric data recordings and providing useful feedback for users for exercise, health, fitness, etc. activities.

FIG. 6 is a block diagram with 96 illustrating wearable devices. The wearable devices include one or more processors and include, but are not limited to, wearable digital glasses 98, clothing 100, jewelry 102 (e.g., smart rings, smart earrings, etc.) and/or watches 104. However, the present invention is not limited to such embodiments and more, fewer and other types of wearable devices can also be used to practice the invention.

In one specific embodiment, the application 30, 30a, 30b, 30c, 30d, 30e, 30f interacts with wearable devices 98-104 automatic identification verification and/or location information services for the desired person 41 with the methods described herein. However, the present invention is not limited this embodiment and other embodiments can also be used to practice the invention.

### Artificial Intelligence (AI) and Big Data

“Artificial intelligence” (AI), also known as machine intelligence (MI), is intelligence demonstrated by machines, in contrast to the natural intelligence (NI) displayed by humans and other animals. AI research is defined as the study of “intelligent agents.” Intelligent agents are any software application or hardware device that perceives its environment and takes actions that maximize its chance of successfully achieving its goals. Colloquially, the term “artificial intelligence” is applied when a machine mimics “cognitive” functions that humans associate with human brains, such as learning, problem solving and comparing large number of data points. In one embodiment, the present invention uses one or more AI methods including, but are not limited to, AI knowledge-based methods 30c for identification verification and/or location information services for a desired person 41, including but not limited to: providing a plurality of different permissions and at a plurality of different security layers including: (a) a first security layer including authorization for only summary identification verification and location information for a desired person; (b) a plurality of second advanced security layers including: a multi-layer identity verification layer comprising: (1) biometrics layer including: a facial recognition sublayer, eye scan sublayer, and identifying other unique biometric markers sublayer, to verify an identity of a desired person with a pre-determined level of precision, (2) location tracking layer, (3) proximity detection layer, (4) geofencing layer, (5) pattern recognition layer, (6) event recording layer, (7) secure data records layer, (8) data analytics layer (9) electronic chain of custody layer, and (10) law enforcement records layer; However, the present invention is not limited to such an embodiment and more, fewer and/or other AI methods can be used to practice the invention.

In one embodiment, SaaS 64 includes and AI application 30c with the AI methods described herein. In another embodiment, the AI application 30c is a standalone application. However, the present invention is not limited to such an embodiment, and the AI application 30c can be provided in other than the SaaS 64.

“Big Data” refers to the use of predictive analytic methods that extract value from data, and to a particular size of data set. The quantities of data used are very large, at least 100,000 data points and more typically 500,000 to 1 Million+data points. Analysis of Big Data sets are used to find new correlations and to spot trends. In one embodiment, SaaS 64 includes and Big Data application 30d with the Big Data described herein.

In one embodiment, the AI methods described herein collect data information to create and store (e.g., in cloud storage object 82, etc.) a Big Data that is used to analyze trends find new correlations and to spot trends. However, the present invention is not limited to such an embodiment and the AI methods described herein can be used without Big Data sets.

### Short Message Service (Sms) Messaging

Short Message Service (SMS) is an electronic text messaging service component of phone, Web, or mobile communication systems. It uses standardized communications protocols to allow fixed line or mobile phone devices to exchange short text messages.

SMS messages were defined in 1985 as part of the Global System for Mobile Communications (GSM) series of standards as a means of sending messages of up to 160 characters to and from GSM mobile handsets. Though most SMS messages are mobile-to-mobile text messages, support for the service has expanded to include other mobile technologies as well as satellite and landline networks.

The SMS Internet Engineering Task Force (IETF) Request for Comments (RFC) 5724, ISSN: 2070-1721, 2010, is incorporated herein by reference.

### Direct and Instant Messages

A “direct message” (DM) is a private form of communication between social media users that is only visible to the sender and recipient(s). INSTAGRAM, TWITTER, FACEBOOK, etc. and other platforms, allow for direct messages between their users, with varying restrictions by platform.

An “instant message” (IM) is a type of online chat allowing real-time text transmission over the Internet or another computer network. Messages are typically transmitted between two or more parties, when each user inputs text and triggers a transmission to the recipient, who are all connected on a common network.

### Multimedia Messaging Service (Mms)

Multimedia Messaging Service (MMS) is a standard way to send messages that include multimedia content to and from a mobile phone over a cellular network. Users and providers may refer to such a message as a PXT, a picture message, and/or a multimedia message.

The MMS Internet Engineering Task Force (IETF) Request for Comments (RFC) 4355 and 4356, are incorporated herein by reference.

### Rich Communication Suite (Rcs)

Rich Communications Suite/Rich Communications System (RCS) is a communication protocol between mobile telephone carriers, between phones and carriers, and between individual devices aiming at replacing SMS messages with a message system that is richer, provides phonebook polling (e.g., for service discovery, etc.), and can transmit in-call multimedia. It is also marketed under the names of Advanced Messaging, Advanced Communications, Chat, joyn, Message+ and SMS+. RCS is also a communication protocol available for device-to-device (D2D) exchanges without using a telecommunications carrier for devices that are in close physical proximity (e.g., between two IoT devices, smart phones, smart phone and electronic tablet, etc.).

One advantage RCS Messaging has over SMS is that RCS enables users to send rich, verified messages including photos, videos and audio messages, group messages, read receipts, indicators to show other users are typing a message, carousel messages, suggested chips, chat bots, barcodes, location integration, calendar integration, dialer integration, and other RCS messaging features. RCS messaging includes person-to-person (P2P), application-to-person (A2P), application-to-application (A2A), application-to-device (A2D) and/or device-to-device (D2D) messaging.

The RCS Interworking Guidelines Version 14.0, 13 Oct. 2017, GSM Association, Rich Communication Suite RCS API Detailed Requirements, version 3.0, Oct. 19, 2017, Rich Communication Suite 8.0 Advanced Communications Services and Client Specification Version 9.0, 16 May 2018, RCS Universal Profile Service Definition Document Version 2.2, 16 May 2018, and Rich Communication Suite Endorsement of OMA CPM 2.2 Conversation Functions Version 9.0, 16 Oct. 2019, are all incorporated herein by reference.

The Rich Communication Suite-Enhanced (RCS-e) includes methods of providing first stage interoperability among Mobile Network Operators (MNOs). RCS-e is a later version of RCS which enables mobile phone end users to use instant messaging (IM), live video sharing and file transfer across any device on any MNO.

The RCS functionality of the present invention includes, but is not limited to, one and two-way, rich, verified, multimedia messages including photos, videos and audio messages, group messages, read receipts, indicators to show other users are typing a message, predefined quick-reply suggestions, rich cards, carousels, action buttons, maps, click-to-call, calendar integration, geo-location, etc. The RCS functionality also includes RCS emulators and/or thin RCS applications that provide full and/or selected features of available RCS functionality. However, the present invention is not limited to such embodiments and other embodiments can be used to practice the invention.

### Identification Verification, Tracking and Location Information Services for a Desired Person or Object

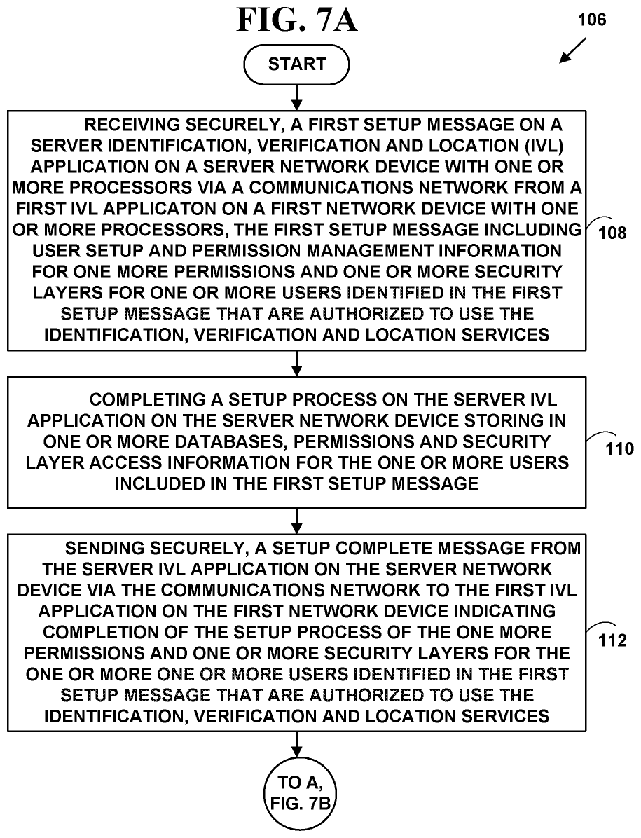

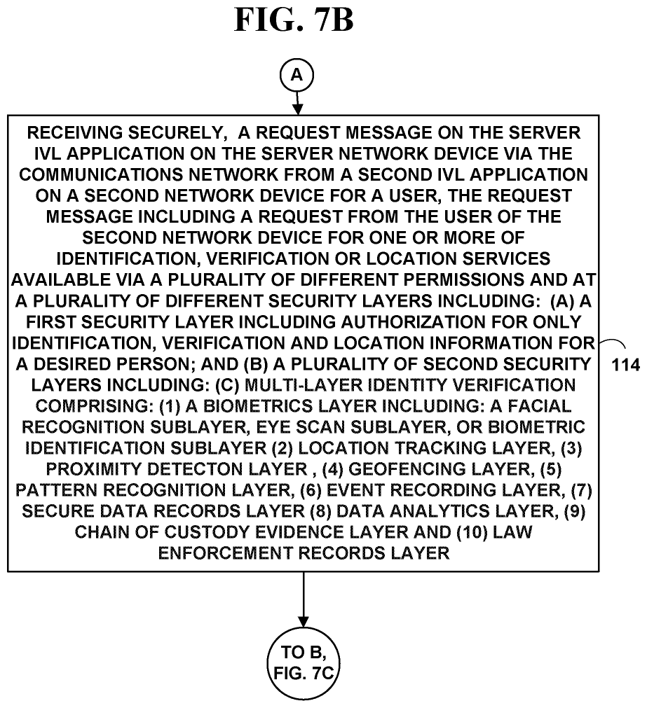

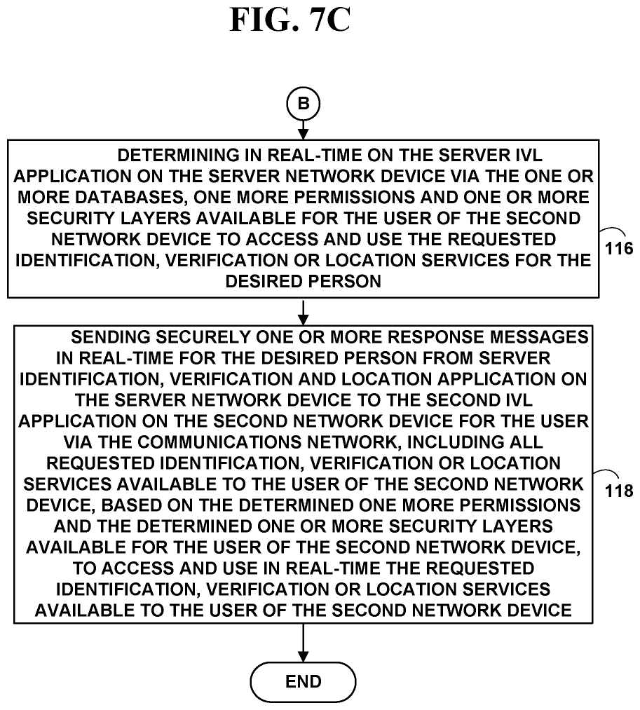

FIGS. 7A, 7B and 7C are a flow diagram illustrating a Method 106 for providing identification verification and location services for a desired person.

In FIG. 7A at Step 108, receiving securely, a first setup message on a server identification verification and location (IVL) application on a server network device with one or more processors via a communications network from a first IVL application on a first network device with one or more processors, the first setup message including user setup and permission management information for one more permissions and one or more security layers for one or more users identified in the first setup message that are authorized to use the identification verification and location services; At Step 110, completing a setup process on the server IVL application on the server network device storing in one or more databases, permissions and security layer access information for the one or more users included in the first setup message; At Step 112, sending securely, a setup complete message from the server IVL application on the server network device via the communications network to the first IVL application on the first network device indicating completion of the setup process of the one more permissions and one or more security layers for the one or more one or more users identified in the first setup message that are authorized to use the identification verification and location services; In FIG. 7B, at Step 114, receiving securely, a request message on the server IVL application on the server network device via the communications network from a second IVL application on a second network device for a user, the request message including a request from the user of the second network device for one or more of identification verification or location services available via a plurality of different permissions and at a plurality of different security layers including: (a) a first security layer including authorization for only summary identification verification and location information for a desired person; (b) a plurality of second advanced security layers including: a multi-layer identity verification layer comprising: (1) a biometrics layer including: a facial recognition sublayer, eye scan sublayer, and identifying other unique biometric markers sublayer, to verify an identity of a desired person with a pre-determined level of precision, (2) location tracking layer, (3) proximity detection layer, (4) geofencing layer, (5) pattern recognition layer, (6) event recording layer, (7) secure data records layer, (8) data analytics layer (9) electronic chain of custody layer, and (10) law enforcement records layer; At Step 116, determining in real-time on the server IVL application on the server network device via the one or more databases, one more permissions and one or more security layers available for the user of the second network device to access and use the requested identification verification or location services for the desired person; and in FIG. 7C at Step 118, sending securely one or more response messages for the desired person in real-time from server IVL application on the server network device to the second IVL application on the second network device for the user via the communications network, including all requested identification verification or location services available to the user of the second network device, based on the determined one more permissions and the determined one or more security layers available for the user of the second network device, to access and use in real-time the requested identification verification or location services available to the user of the second network device for the desired person.

The present invention is illustrated with an exemplary embodiment. However, the present invention is not limited to such an embodiment and other embodiments can be used to practice the invention.

In such an exemplary embodiment in FIG. 7A at Step 108, receiving securely, a first setup message 13s, 15s on a server identification verification and location (IVL) application 30a on a server network device 20, 22, 24, 24 with one or more processors via a communications network 18, 18′ from a first IVL application 30 on the first network device 12, 14, 16, 20, 22, 24, 26, 31, 98-104 with one or more processors, the first setup message including user setup and permission management information for one more permissions and one or more security layers for one or more users 29 identified in the first setup message 13s, 15s that are authorized to use the identification verification and location services.

In one embodiment, the first setup message 13s, 15s is received securely using one or more of the encryption and/or security methods described herein. However, the present invention is not limited to such an embodiment and other encryption and/or security methods can be used to practice the invention.

In one embodiment, the server IVL application 30a an identification verification and location information application 30a, includes a separate identification verification and location information application program interface (API) 30b, an Artificial Intelligence (AI) application 30c and/or other applications 30d, 30e, 30f. In such an embodiment the server IVL application 30a makes calls to the IVL API 30b and AI application 30c to provide the identification verification, tracking and location functionality. In another embodiment, the identification verification and location information application program interface (API) 30b, the Artificial Intelligence (AI) application 30c and/or other applications 30d, 30e, 30f are integral to server IVL application 30a. However, the present invention is not limited to such an embodiment and other embodiments and applications in other configurations can be used to practice the invention.

In one embodiment, the first application 30 on the first network device 12, 14, 16, 20, 22, 24, 26, 31, 98-104 includes IVL application 30 including an identification verification and location information application 30a, identification verification tracking and location information application program interface (API) 30b, an Artificial Intelligence (AI) application 30c and/or other applications 30d, 30e, 30f. However, the present invention is not limited to such an embodiment and more, fewer and/or other applications can be used to practice the invention.

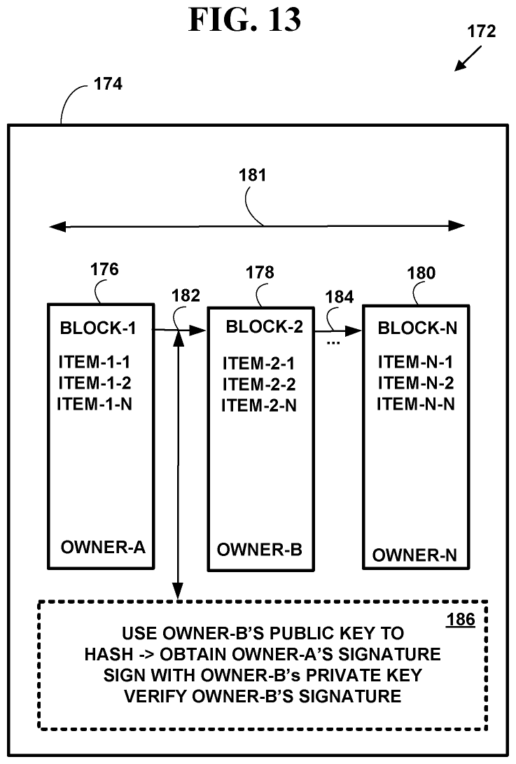

At Step 110, completing a setup process on the server IVL application 30a on the server network device 20, 22, 24, 26 by storing in one or more databases 20′, 22′, 24′, 26′ and/or a block chain 174 (FIG. 13 and Table 5) permissions and security layer access information for the one or more users 29 included in the first setup message 13s, 15s.

In one embodiment, the setup process includes, but is not limited to, user 39 setup and permission management, allowing the server IVL application 30a and/or IVL application 30, to define which individuals are authorized to use the identification verification and location services. The setup process includes setting permissions for access points, actions, and data visibility. However, the present invention is not limited to such an embodiment, and other embodiments with other actions completed in the setup process.

In one embodiment, the setup process includes, but is not limited to, the server IVL application 30a on the server network device 20, 22, 24, 26 setting up one or more user profiles for the one or more users included in the first setup message 13s, 15s in a database 20′, 22′, 24′, 26′ and/or a block chain 174 (FIG. 13). A user profile includes, but is not limited to, a type of user designation (e.g., vendor, employee, manager, law enforcement, military, government, etc.) and a list of a plurality of user permissions. However, the present invention is not limited to such an embodiment and other embodiments with more, fewer and/or other information included in a user profile can be used to practice the invention.

In one embodiment, the server IVL application 30a on the server network device 20, 22, 24, 26 and/or IVL application 30 on the target network device 12, 14, 16, 20, 22, 24, 26, 31, 98-104 provides IVL functionality as one or more SaaS 64 and stores the user setup profile in one or more cloud storage objects 82 in one more cloud storage databases 20′, 22′, 24′, 26′ and/or a block chain 174 (FIG. 13) on a cloud communications network 18. However, the present invention is not limited to such an embodiment and other embodiments without cloud services can be used to practice the invention.

In one embodiment, the server IVL application 30a on the server network device 20, 22, 24, 26 includes the list of the plurality of user permissions in a permission hierarchy, including but not limited to, a data structure comprising a search tree, an array and/or a block chain 174. A search tree is a tree data structure used for locating specific keys within a data set. In order for a tree to function as a search tree, a key for each node must be greater than any keys in subtrees on the left, and less than any keys in subtrees on the right. The advantage of search trees is their efficient search time given the tree is reasonably balanced, which is to say the leaves at either end are of comparable depths. Various search-tree data structures exist, several of which also allow efficient insertion and deletion of elements, which operations then have to maintain tree balance. Search trees are often used to implement an associative array. The search tree algorithm uses the key from the key-value pair to find a location in the tree, and then stores the entire key-value pair at that particular location. However, the present invention is not limited to such an embodiment and hierarchies, data structures and tree data structures can be used to practice the invention.

In one embodiment, the search tree includes a binary search tree data structure. A binary search tree is a node-based data structure where each node contains a key and two subtrees, the left and right. For all nodes, the left subtree's key must be less than the node's key, and the right subtree's key must be greater than the node's key. These subtrees must all qualify as binary search trees. The worst-case time complexity for searching a binary search tree is the height of the tree, which can be as small as Big-O of log₁₀ of n (O (log₁₀(n))) for a binary tree with n elements. Algorithmic complexities are classified according to the type of function appearing in the Big-O notation (e.g., log₁₀(n), etc.). However, the present invention is not limited to such an embodiment and other hierarchies, data structures and tree structures can be used to practice the invention.

In one embodiment, the setup process includes permission management, including, but not limited to, permission management for: (1) Access Points: which identification verification and location service access point a user can enter; (2) Actions: What actions the user is permitted to do with selected identification verification and location services, including: sending data, receiving data, retrieving data, adding data, editing data and/or viewing reports; and (3) Data Visibility: Which data a user can see or not see, so sensitive information is only visible to those who need it and/or are authorized to see it. However, the present invention is not limited to such an embodiment and other embodiments with more, fewer and/or other permissions can be used to practice the invention.

In one embodiment, the setup process includes security layer management, including but not limited to, security layer management with a data structure for: (1) a First Layer of Security-Authorization Features Use: Before users can go further, the server IVL application 30 checks the created user profiles stored in the database 20′, 22′, 24′, 26′ and/or a block chain 174 (FIG. 13) to make sure the users 39 are authorized to use the identification verification and location services. Only authorized users 39 can enter the First Layer of Security-Authorization which provides only identification verification and location information for a desired person 41 (e.g., criminal, terrorist, solider, missing person, professional (e.g., doctor, lawyer, nurse, etc.), student, ride share driver, etc.); and (2) a plurality of Second Layers of Security-Advanced Features Use: Once inside the Second Layers of Security, approved users 39 can access deeper features of the identification verification and location services (e.g., Table 5, etc.), but only if they have permission for each feature. These deeper features are not available to just anyone; they require extra security clearances, making sure only designated users 39 can use them. The security layer management setup helps make sure that only approved users 39 get past the first layer, and only those users 39 with specific permissions can access the more sensitive parts of the identification verification and location services to apply to the desired person 41. This layered security approach keeps everything secure. However, the present invention is not limited to such an embodiment and other embodiments with more, fewer and/or other security layers can be used to practice the invention.

The second advanced security features, include but are not limited to, those illustrated in Table 5. However, the present invention is not limited to such an embodiment and other embodiments with more, fewer and/or other advance security features can be used to practice the invention.

TABLE 4
The second advanced security 128 features, comprising a plurality of different security
layers including, but not limited to:

| | |
|---|---|
| 1. | Multi-layer identity verification layer 130, comprising: a facial recognition |
| | sublayer 130a, eye scan sublayer 130b, or biometric markers identification |
| | sublayer 130c, to verify an identity of a desired person 41 with a pre- |
| | determined level of precision. |
| 2. | Location tracking layer 132, for tracking physical location of the desired person |
| | 41 including but not limited to GPS, network and/or other location information. |
| 3. | Proximity detection layer 134, to determine a proximity of the desired person |
| | 41 to other people 41′ or other network devices 12, 14, 16, 20, 22, 24, 26, 31, |
| | 98-104 within a pre-determined range of the desired person and any network |
| | devices (e.g., 12, 14, 16, 20, 22, 24, 26, 31, 98-104) being used by the desired |
| | person 41. |
| 4. | Geofencing layer 136, for creating an electronic geofence around the desired |
| | person 41. |
| 5. | Pattern recognition layer 138, for determining patterns including current actions |
| | or previously recorded actions and habits of the desired person 41 stored in a |
| | database 20, 22, 24, 26, cloud storage object 82 and/or blockchain 174. |
| 6. | Event recording layer 140, for recording events completed by the desired |
| | person 41 in a database 20, 22, 24, 26, cloud storage object 82 and/or |
| | blockchain 174. |
| 7. | Secure data records layer 142, for creating and storing secure data records for |
| | the desired person 41 in a database 20, 22, 24, 26, cloud storage object 82 |
| | and/or blockchain 174. |
| 8. | Data analytics layer 144, for the desired person 41 including Artificial |
| | Intelligence (AI) methods 30c and non-AI analytic methods for analyzing any |
| | information collected for the desired person 41. |
| 9. | Electronic chain of custody layer 146, for securely collecting and storing |
| | electronic evidence within a chain of custody for the desired person 41 in a |
| | database 20, 22, 24, 26, cloud storage object 82 and/or blockchain 174. |
| 10. | Law enforcement records layer 148, including links arrest, conviction and |
| | criminal and civil records for the desired person 41. |

In one embodiment, the server IVL application 30a on the server network device 20, 22, 24, stores permissions and security layer access information for the one or more users 29 included in the first setup message 13s, 15s in a block chain 174 (FIG. 13).

In one embodiment, the security layer data structure, includes, but is not limited to a search tree data structure. In one embodiment, the search tree data structure includes a binary search tree data structure. However, the present invention is not limited to such an embodiment and other embodiments with more, fewer and/or other security layer data structures can be used to practice the invention.

At Step 112, sending securely, a setup complete message 13c, 15c from the server IVL application 30a on the server network device 20, 24, 26, 28 via the communications network 18, 18′ to the first IVL application 30 on the first network device 12, 14, 16, 20, 22, 24, 26, 31, 33, 35, 37, 98-104 indicating completion of the setup process of the one more permissions and one or more security layers for the one or more one or more users 29 identified in the first setup message 13s, 15s that are authorized to use the identification verification and location services.

In one embodiment, the setup complete message 13c, 15c is sent securely using one or more of the encryption and/or security methods described herein. However, the present invention is not limited to such an embodiment and other encryption and/or security methods can be used to practice the invention.

In FIG. 7B, at Step 114, receiving securely, a request message 13r, 15r on the server IVL application 30a on the server network device 20, 22, 24, 26 via the communications network 18, 18′ from a second IVL application 30 on a second network device 12, 14, 16, 20, 22, 24, 26, 31, 33, 35, 37, 98-104 for a user 39, the request message 13r, 15r including a request from the user 39 of the second network device 12, 14, 16, 20, 22, 24, 26, 31, 33, 35, 37, 98-104 for one or more of identification verification or location services available via a plurality of different permissions and a plurality of different security layers 122-148 including: (a) a first security layer 124 including authorization for providing only summary identification verification and location information 43, 126 for a desired person; (b) a plurality of second advanced security layers 128-148 including: (c) multi-layer identity verification layer 129 comprising: a biometrics layer 130 including: a facial recognition sublayer 130a, eye scan sublayer 130b, and biometric markers identification sublayer 130c, (2) location tracking layer 132, (3) proximity detection layer 134 (4) geofencing layer 136, (5) pattern recognition layer 138, (6) event recording layer 140, (7) secure data records layer 142, (8) data analytics layer 144, (9) electronic chain of custody layer 146, and (10) law enforcement records layer 148.

In one embodiment, all message communications between the server IVL application 30a on the server network device 20, 22, 24, 26 and the first IVL application 30 on the first network device 12, 14, 16, 20, 22, 24, 26, 31, 33, 35, 37, 98-104 and the second IVL application 30 on the second network device 12, 14, 16, 20, 22, 24, 26, 31, 33, 35, 37, 98-104 via the communications network 18, 18′ include end-to-end encryption including one or more of the encryption methods described herein. In another embodiment, are completed on secure messaging applications such as WHATSAPP, TELEGRAM, SIGNAL, etc. However, the present invention is not limited to such an embodiment and other embodiments with more, fewer and/or other end-to-end encryption can be used to practice the invention.

In one embodiment, the server IVL application 30a on the server network device 20, 22, 24, 26 and the first IVL application 30 on the first network device 12, 14, 16, 20, 22, 24, 26, 31, 33, 35, 37, 98-104 further include object information in the one or more security layers 122-148 including the first initial security layer 124 allowing access to basic functionality of the identification verification and location services, including only summary identification verification and location information for one or more desired objects 59, and including object information in plurality of second advanced security layers 128-148 including advanced functionality of the identification verification and location services, including the individual security layers 128-148 for accessing the one or more of the plurality of different permissions and at the plurality of different security layers including all available summary identification verification and location information for one or more desired objects 59. However, the present invention is not limited to such an embodiment and other embodiments can be used to practice the invention.

The server IVL application 30a on the server network device 20, 22, 24, 26 creates a continuous feedback cycle that to function as a comprehensive identification, tracking and verification system, adaptable across various, law enforcement, employment, background, goods (e.g., tickets, etc.) and/or services purchases 227 (e.g., medical services, etc.). However, the present invention is not limited to such an embodiment and other embodiments can be used to practice the invention.

The server IVL application 30a on the server network device 20, 22, 24, 26 includes feedback and adaptive learning, including AI and machine learning and AI neural networks to learn and adapt its behavior based on user 39 interactions and IVL requests made for desired persons 39. For example, the server IVL application 30a collects information on car jackings, burglaries, robberies, etc., techniques that are used, time such crimes typically occur, etc. sending alerts to users 39, increasing identity checks of persons 41, flagging potential threats as they happen before a corresponding crime and/or other event may occur. However, the present invention is not limited to such an embodiment and other embodiments can be used to practice the invention.

The server IVL application 30a on the server network device 20, 22, 24, 26 creates and stores contextual triggers for a plurality of different scenarios based on user 39 interactions, requests made for desired persons 41, 41′ and prior and current behaviors of desired persons 41, 41′. For example, an exemplary contextual trigger may include detecting a person is spotted by security camera near an entrance of a building at 2:00 am carry a bag of tools. A facial recognition 130a is triggered and the pattern recognition layer 138 is activated. The contextual trigger may then send alerts to a user 39 who is in charge of security for the building. However, the present invention is not limited to such an embodiment and other embodiments can be used to practice the invention.

The server IVL application 30a on the server network device 20, 22, 24, 26 is in communications with one or more other third-party APIs, databases, other block chains and other systems via the communications network 18, 18′ to expand its IVL functionality. However, the present invention is not limited to such an embodiment and other embodiments can be used to practice the invention.

The server IVL application 30a on the server network device 20, 22, 24, 26 and IVL applications 30 on the network devices 12, 14, 16, 20, 22, 24, 26, 31, 33, 35, 37, 98-104 include a method for conserving device power including battery life on the non-server network devices 12, 14, 16, 31, 33, 35, 37, 98-104, including real-time adaptive scanning intervals, adaptive activation and deactivation, etc. However, the present invention is not limited to such an embodiment and other embodiments can be used to practice the invention.

In one embodiment, one or more of the security layers 122, including the first security layer 124 and the plurality of second advanced security layers 128-148 include a separate encryption key for each layer. However, the present invention is not limited to such an embodiment and other embodiments can be used to practice the invention.

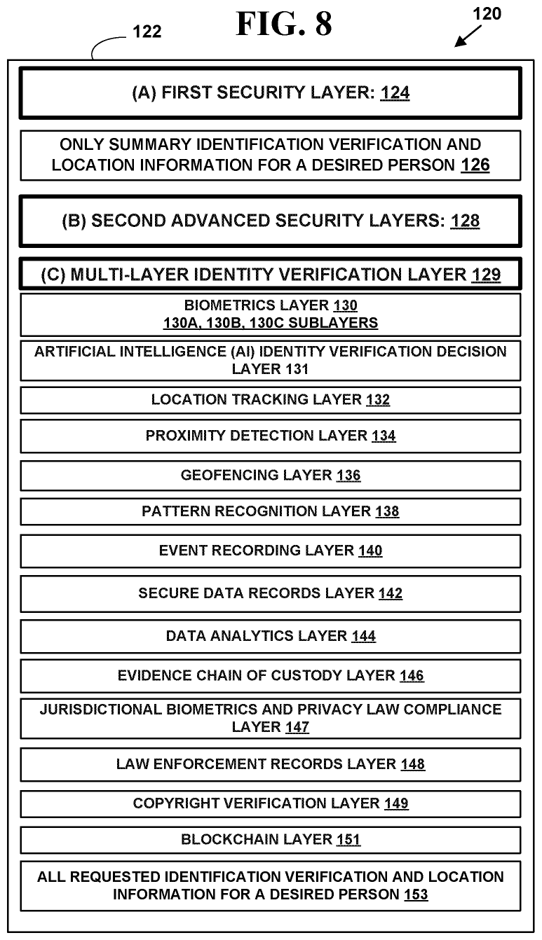

FIG. 8 is a block diagram 120 illustrating a plurality of different security layers 122 available on the server identification verification and location application 30a on the server network device 20, 22, 24, 26.

FIG. 8 illustrates, a first security layer 124 including authorization for providing only summary identification verification and location information 43, 126 for a desired person 41; (b) a plurality of second advanced security layers 128 including: (c) multi-layer identity verification layer 129 comprising: a biometric layer including: a facial recognition sublayer, eye scan sublayer, and identifying other unique biometric markers sublayer, to verify an identity of a desired person with a pre-determined level of precision, (2) location tracking layer 132 (3) proximity detection layer 134, (4) geofencing layer 136, (5) pattern recognition layer 138 (6) event recording layer 140, (7) secure data records layer 142, (8) data analytics layer 144, (9) evidence chain of custody layer 146, and (10) law enforcement records layer 148. Also illustrates all requested identification verification and location information 45, 153 for the desired person 41. However, the present invention is not limited to such an embodiment and other embodiments with more, fewer and/or other security layers can be used to practice the invention.

In one embodiment, the summary identification verification and location information 43, 126 for the desired person 41, includes but is not limited to, name, address, phone number, vehicle and license plate information, email identifiers, social media identifiers, tattoos, digital photograph, location information including real-time current physical location, arrest, conviction, outstanding arrest warrants, outstanding traffic tickets, Be-On-the-LOokout (BOLO) lists, most wanted lists (e.g., U.S. Marshall, FBI, Interpol, Scotland Yards, etc.) criminal complaint, criminal sentencing, criminal and/or civil judgments, (i.e., for civil legal actions, etc.) and/or other types of law enforcement and/or criminal and/or civil legal information for the desired person 41. However, the present invention is not limited to such an embodiment and other embodiments with more, fewer and/or other summary information items can be used to practice the invention.

In one embodiment, the first and second layers, include, but is not limited to a hierarchy comprising a tree, binary tree and/or an array data structure. An array is a data structure consisting of a collection of elements (e.g., values, variables, cloud services, etc.), of same memory size, each identified by at least one array index or key. An array is stored such that a position of each element can be computed from its index tuple by a mathematical formula. However, the present invention is not limited to such an embodiment and other embodiments with more, fewer and/or other security layer data structures can be used to practice the invention.

Returning to FIG. 7C at Step 114, in one embodiment, the request message 13r, 15r is securely received using one or more of the encryption and/or security methods described herein. However, the present invention is not limited to such an embodiment and other encryption and/or security methods can be used to practice the invention.

The biometric layer 130, includes, but is not limited to, a facial recognition sublayer 130a, eye scan sublayer 130b, and identifying other unique biometric marker sublayer 130c, to verify an identity of a desired person 41 with a pre-determined level of precision (e.g., 80%, 90%, 100%, etc. level of certainty, etc.). However, the present invention is not limited to such embodiments and more, fewer and other sublayers can be used to practice the invention.

The facial recognition sublayer 130a, includes, but is not limited to, technology capable of matching a human face from a digital image or a video frame against a database of faces to confirm an individual's identity. Facial recognition algorithms can be categorized into two main types: feature-based methods and holistic methods. Feature-based facial recognition methods use facial attributes, like jawline, cheek apples, eye sockets, eye focus, mouth shape, lips shape, etc. Using these facial data points, it calculates relative distances between these facial features to build faceprints and uniquely identify individuals. In one embodiment, facial recognition is conducted in real-time using live scanning through front-facing cameras on network devices 12, 14, 16, 20, 22, 24, 26, 31, 33, 35, 37, 98-104. In another embodiment, the feature-based facial recognition is not conducted using live scanning. Holistic face recognition utilizes global information from a large number of different faces to perform face recognition. The global information from faces is fundamentally represented by a small number of features, which are directly derived from pixel information of face images. However, the present invention is not limited to such embodiments and other facial recognition methods can be used to practice the invention.

The eye scan sublayer 130b, includes, but are not limited to, retinal scans, cornea scans and iris scans of a person. A retinal scan is a biometric technique that uses unique patterns on a person's 41 retina blood vessels. An iris scan is an eye vein verification that uses scleral veins in the eye of the person 41. However, the present invention is not limited to such embodiments and other eye scan methods can be used to practice the invention.

The identifying other unique biometric marker sublayer 130c, includes, but are not limited to, collecting, finger prints, DeoxyriboNucleic Acid (DNA), eye color, hear color, tattoos, gait, voice, height, weight, and/or other unique biometric makers. However, the present invention is not limited to these unique biometric markers and more, fewer and/or other biometric markers can be used to practice the invention.

The location tracking layer 132, includes, but is not limited to, context-aware and location tracking services, including GPS or Wi-Fi-based geofencing.

The Global Positioning System (GPS), includes, but is not limited to, GPS data (e.g., time, longitude, latitude, elevation, etc.) about a physical position, movement and time for an object such as the desired person 41, a vehicle 37 the desired person 41 is driving, etc. via GPS satellites. GPS is a space-based radio-navigation system that uses satellites, ground stations, and receivers to calculate an exact physical location of an object such as the desired person 41, a vehicle 37 the desired person 41 is driving, etc. However, the present invention is not limited to such an embodiment and other location tracking components be used to practice the invention.

The server IVL application 30a on the server network device 20, 22, 24, 26 provides via the location tracking layer 132 provides: (1) Location Services: The server IVL application 30a on the server network device 20, 22, 24, 26 uses tools like GPS or Wi-Fi to determine where the desired person 41 is. Boundaries and/or zones are set, including specific streets, buildings and/or rooms; (2) Activating Features by Location: When a desired person 41 enters set boundaries, the server IVL application 30a on the server network device 20, 22, 24, 26 automatically turns on specific advanced security features (e.g., 130, 134, 138, etc.)

For example, if someone is in a secure area, the server IVL application 30a on the server network device 20, 22, 24, 26 activates extra security checks, like the facial recognition sublayer, etc.; and (3) Responding to Events or Security Needs: The server IVL application 30a on the server network device 20, 22, 24, 26 adapts to different security situations based on location of the desired person 41. In an event space, it activates guest check-in features with the multi-layer identification layer 129, the location tracking layer 132 and/or the geofencing layer 136, while in high-security areas, it activates the multi-layer identification layer 129, the location tracking layer 132, the geofencing layer 136 and/or the pattern recognition layer 138, etc.

The AI identify verification decision layer 131, includes but is not limited to, Artificial Intelligence (AI) identity verification decision layer 131, for determining and verifying an identity of a person 41 with biometric data including facial recognition and other biometric data automatically without human intervention. The AI identify verification decision layer 131 includes AI models, methods and large language models (LLMs) for Generative AI 57f and/or predictive AI 57g and/or Retrieval Augmented Generation (RAG) AI 57h.

AI identify verification decision layer 131 includes any software, user interfaces, and accessibility features that enable users to interact with the underlying AI models, methods, LLMs, Big datasets, neural networks and machine learning that power the AI identify verification decision layer 131 with generative AI and/or predictive AI and/or RAG AI.

Generative AI (GenAI, or GAI) 57f is a subset of AI that uses Generative AI models to produce new text, images, videos, and/or other forms of data.

Predictive AI (PredAI or PAI) 57g is also a subset of AI that uses Predictive AI models, machine learning, neural networks and statistical analysis to forecast future events. Machine learning is a field of study in AI concerned with the development and study of statistical algorithms that can learn from data and generalize to unseen data, and thus perform tasks without explicit instructions and/or without human intervention.

Retrieval-Augmented Generation AI (RAG or RAG-AI) 57 h reduces LLM limitations by grounding AI responses in a defined set of materials (e.g., trusted databases or specific knowledge, e.g., law enforcement, behavior patterns, biometric information, etc.), increasing, accuracy, reducing AI hallucinations, increasing specificity and enabling more current information than the LLM training data alone. An AI RAG method takes the skills of the trained model and tells it to use those skills but limits the library of information to the trusted knowledge base that it is pointed at. RAG-AI also verifies information it provides actually exist and is not an AI hallucination.

An AI hallucination occurs when an AI system generates information that sounds plausible and confident but is actually incorrect, fabricated, misleading, or unsupported by its training data or available evidence. In large language models (LLMs), hallucinations occur because the LLM is fundamentally predicting a most likely next word based on context and association patterns it has learned, rather than retrieving verified facts from a database, a search engine search, etc.

In one embodiment the AI application 30c and/or the AI identify verification decision layer 131, includes but is not limited to, a Generative AI component and/or a Predictive AI component. In one embodiment, the Generative AI component and the Predictive AI component are standalone components of the AI application 30c. In another embodiment, the Generative AI component and/or the Predictive AI component and/or RAG AI component are included as layers in the AI identify verification decision layer 131. However, the present invention is not limited to such embodiments and other embodiments and/or other combinations can be used to practice the invention.

The location tracking layer 132 includes but is not limited to, providing a current physical location of a desired person 41 and helping to determine, define and/or create geographic boundaries where the server IVL application 30a on the server network device 20, 22, 24, 26 activates other advanced security layers, making the system responsive to a desired person's 41 physical location, on a street, on public transportation (e.g., via card swiping for fee payment cards, etc.), in a vehicle (e.g., via electronic toll payment pass, etc.), in restaurants, in event spaces, such as concerts, sports, etc. in secure and un-secure spots in a building, etc.

The proximity detection layer 134, includes but is not limited to, detecting proximity of a desired person 41 to other people 41′ or other network devices 12, 14, 16, 20, 22, 24, 26, 31, 33, 35, 37, 98-104 within a pre-determined range of the desired person 41 and any network devices 12, 14, 16, 20, 22, 24, 26, 31, 33, 35, 37, 98-104 being used by the desired person 41. The proximity detection layer 134 on the server IVL application 30a on the server network device 20, 22, 24, 26 determines with RFID, BLUETOOTH, infrared ultra sound, and/or Wi-Fi signals, if the desired person 41 is within a pre-determined distance (e.g., within 3-5 feet) of other people 41′ so other security layers can be activated (e.g., 130, 132, 138, 140, etc.). For example, when teams of people including the desired person 41 are transporting items (e.g., art, currency, jewels, weapons, guns, etc.) the p detection layer 134 is activated.

Ultra sound, includes but is not limited to, technology that uses high-energy sound waves to determine characteristics of a person.

For example, sending out RFID, BLUETOOTH, infrared ultra sound, and/or Wi-Fi signals and when the signals are absorbed by the human body of the desired person, determining a location of that person.

The proximity detection layer 134 on the server IVL application 30a on the server network device 20, 22, 24, 26 detects when people or network devices 12, 14, 16, 20, 22, 24, 26, 31, 33, 35, 37, 98-104 are close enough to start an interaction with the desired person 41 including for teams of people transporting valuable items. The proximately detection layer 134 provides: (1) Proximity Detection: When authorized team members or their network devices are within a predetermined range (e.g., three to five feet) of the desired person 41, the proximity detection layer 134 recognizes they are close enough to interact. This recognition also includes using the multi-layer identity layer verification layer 129 and one or more of its sublayers; (2) Identification and Verification: Once team members are within range, the proximity detection layer 134 quickly identifies and verifies each person's identity to ensure they're authorized to handle or transport the valuable items; (3) Enhanced Security for Transport: For teams moving valuable items, this proximity detection ensures that only the right people interacting with the desired person 41 are involved, adding an additional layer of security. If an unauthorized person tries to get close to the desired person, the proximity detection layer 134 on the server IVL application 30a on the server network device 20, 22, 24, 26 takes preventive actions such as alerting the team and/or temporarily locking down access to a vehicle, a room in a building, etc.

In one embodiment, when the proximity detection layer 134 on the server IVL application 30a on the server network device 20, 22, 24, 26 detects a person or network device nearby the desired person 41, it checks the person's identity with a biometric scan. For example: (1) Proximity Detection: The proximity detection layer 134 on the server IVL application 30a on the server network device 20, 22, 24, 26 first confirms that a person 41 or network device is within the pre-determined distance; (2) Biometric Verification: Once the proximity detection layer 134 on the server IVL application 30a on the server network device 20, 22, 24, 26 determines other people and/or other network devices are nearby the desired person 14, it automatically triggers a more secure identity check with other advanced security layers (e.g., 130, 132, 138, 140, etc.). However, the present invention is not limited to such an embodiment and other embodiments can be used to practice the invention.

The geofencing layer 136, includes but is not limited to, creating a virtual perimeter for a real-world geographic area for a desired person 41. A geofence is dynamically generated (e.g., as in a radius around a point location) or statically matched to a predefined set of boundaries (e.g., such as school zones, neighborhood boundaries, etc.). The use of a geofence is called geofencing, and one example of use involves a location-aware network device the server IVL application 30a on the server network device 20, 22, 24, 26 of a location-based service (LBS) (e.g., GPS, etc.) for the desired person 41 entering or exiting a geofence. Geofencing is based on the observation that desired persons 41 move from one place to another and then stay at that place for a while. This method combines awareness of the desired persons 41 current location with awareness of the user's proximity to locations that may be of interest. This activity triggers an alert as well as messaging to the geofence operator which includes, but is not limited to, the server IVL application 30a on the server network device 20, 22, 24, 26. This alert information, includes a physical location of the network device 12, 14, 16, 20, 22, 24, 26, 31, 33, 35, 37, 98-104, and can also be sent to a mobile telephone 14, an email account, etc.

The pattern recognition layer 138, includes but is not limited to, recognizing patterns of current actions or previously recorded habits of the desired person 41, and includes a method and process of continuously collecting and storing data and identifying patterns in the data and assigning them to a class or category. Patten recognition is used to analyze data in many forms, including images, text, social media, voice, video, biometrics, etc. Pattern data is continuously by the collected by the server IVL application 30a on the server network device 20, 22, 24, 26 and stored in the databases 20′, 22′, 24′, 26′ and/or in a block chain 174 (FIG. 13) on a plurality of persons and/or the desired person 41, to detect patterns, track high-frequency interactions, and identify unusual and/or potentially suspicious behavior.

The server IVL application 30a on the server network device 20, 22, 24, 26 continuously collects pattern data and analyzes patterns of habits, behaviors, actions and interactions between people. Common patterns, habits, actions or interactions that happen frequently are detected. For example, the desired person 41 may buy a cup of coffee every morning at 7:30 am at a same coffee shop. Then anything unusual or potentially suspicious, like the desired person 41 going to a meeting with another person at 7:30 am is detected.

Pattern recognition is performed by both AI and non-AI methods described herein. There are three main types of pattern recognition server IVL application 30a on the server network device 20, 22, 24, 26, dependent on a desired mechanism used for classifying the pattern data input. These three types are: statistical, structural and/or syntactic, and neural network pattern matching.

Statistical pattern recognition (SPR) is a field of data analysis that uses statistics (e.g., mean, medium, mode, etc.) mathematical models and algorithms to identify patterns from large datasets. It can be used for various tasks, such as handwriting or speech recognition, classification of objects in images, and natural language processing.

Structural and or syntactic pattern recognition is a method used to check a value (e.g., percentage value, certainty value, etc.) against a pattern (e.g. a sequence of words, etc.), extracting parts of the value if the pattern matches.

Neural pattern recognition is a technique that uses AI methods described herein and artificial neural networks (ANNs) to recognize patterns in data. ANNs are computational systems that mimic the human brain's neural network architecture, allowing them to learn to recognize patterns in a variety of data types.

However, the present invention is not limited to these embodiments and other types of pattern recognition can be used to practice the invention.

The event recording layer 140, includes but is not limited to, capturing and storing event data points in an event log on the server IVL application 30a on the server network device 20, 22, 24, 26 including a timestamp, location, verified identity, and any associated network device 12, 14, 16, 31, 33, 35, 37, 98-104 identifiers (e.g., network identifier, smart phone identifier, etc.) for a desired person 41. This event log provides a complete record of interactions, offering transparency and auditability. In one embodiment the event data points are stored in a block chain 174 (FIG. 13).

The server IVL application 30a on the server network device 20, 22, 24, 26 detects and logs usual and unusual events. For example, every time an event occurs, like the desired person 41 entering a secure area, the desire person 41, swiping a key card at a regular and/or unusual time on a subway, etc. the server IVL application 30a on the server network device 20, 22, 24, 26 detects the event and creates an event log entry in the database 20′, 22′ 24′, 26′ and/or a block chain 174 (FIG. 13).

The secure data records layer 142, includes, but is not limited to detecting and recording important details in a secure record for each desired event and action, ensuring secure, reliable records that can be reviewed anytime. The server IVL application 30a on the server network device 20, 22, 24, 26 provides secure data records collection and logging and feeds them directly into the analytics layer 144, allowing the server IVL application 30a on the server network device 20, 22, 24, 26 to build a historical record that directly supports behavior tracking and pattern identification as well The event logs over time create a large set of data and are used by AI and non-AI methods described herein to show behavior and trends of the desired person 41 and/or other persons. However, the present invention is not limited to these embodiments and other embodiments may be used to practice the invention.

The data analytics layer 144, includes, includes but is not limited to, providing Artificial Intelligence (AI) methods 30c and non-AI analytic methods for analyzing any information collected for the desired person 41, and providing an electronic data analytics notebook application to organize and analyze all the data the server IVL application 30a on the server network device 20, 22, 24, 26 has collected. Insightful data processing, feedback and system optimization is provided in this layer. The server IVL application 30a on the server network device 20, 22, 24, 26 provides automated insights from the data analytics layer providing broader data analysis operations, leading to refined authorization policies, improved security protocols, and/or improved and/or customized user permissions. The collected data is also used by the data analytics layer to detect patterns, track high-frequency interactions, and/or identify unusual and/or potentially suspicious behavior of the desired person 41 and/or other persons. However, the present invention is not limited to these embodiments and other embodiments may be used to practice the invention.

The electronic chain of custody evidence layer 146, includes but is not limited to, creating and recording a chain of custody record of a chronological handling of electronic evidence (e.g., voice, video, electronic text, etc.), from its collection to its presentation in a court of law for the desired person 41. The server IVL application 30a on the server network device 20, 22, 24, 26 securely collects, stores logs and documents, when and where the evidence was collected, how it was collected, and how it was stored, who handled the evidence and how it transferred via the chain of custody layer. The chain of custody evidence layer provides: (1) Evidence validity: helping prove that evidence is valid and authentic, and that it can be directly linked to a defendant in a criminal and/or civil litigation; (2) Evidence integrity: helping maintain the integrity of the evidence, and protects it from contamination or tampering; and (3) Investigation success: helping achieve success of a criminal investigation. However, the present invention is not limited to these embodiments and other embodiments may be used to practice the invention.

Jurisdictional biometrics and privacy law compliance layer 147, includes but is not limited to, one or more compliance tables including United States federal and state biometrics and privacy laws for all states. The one or more compliance tables include federal statutes, federal code of regulations (CFR), state statutes, state rules for biometrics including facial recognition, and privacy.

The law enforcement records layer 148, includes, but is not limited to, arrest, conviction, warrant and/or other criminal and/or civil records for the desired person 41. This law enforcement records layer includes but is not limited to, providing real-time access via the server IVL application 30a on the server network device 20, 22, 24, 26, to municipal, state, federal and/or international, law enforcement, legal including criminal and/or civil databases, court system docketing and documents for pending and/or concluded cases and/or other databases for a user 39. The server IVL application 30a on the server network device 20, 22, 24, 26 provides this real-time access to allow the user 39 to obtain any arrest, conviction, outstanding arrest warrants, outstanding traffic tickets, vehicle and license plate information, be on the lookout (bolo) lists, most wanted lists (e.g., U.S. Marshall, FBI, Interpol, Scotland Yards, etc.) criminal complaint, judgment, (i.e., for civil legal actions, etc.) and/or other types of law enforcement and/or criminal and/or civil legal information for the desired person 41. However, the present invention is not limited to these embodiments and other embodiments may be used to practice the invention.

Returning to FIG. 7C at Step 116, determining in real-time on the server IVL application 30a on the server network device 20, 22, 24, 26 via the one or more databases 20′, 22′, 24′ 26 and/or a block chain 174 (FIG. 13), one or more permissions and one or more security layers available for the user 39 of the second network device 12, 14, 16, 20, 22, 24, 26, 31, 33, 35, 37, 98-104 to access and use the requested identification verification or location services for the desired person 41.

In one embodiment, the server IVL application 30a on the server network device 20, 22, 24, 26 determines at Step 116, the one or more permissions and one or more security layers available for the user 39 from one or more cloud storage objects 82 in one more cloud storage databases 20′, 22′, 24′, 26′ and/or a block chain 174 (FIG. 13) on a cloud communications network 18. However, the present invention is not limited to such an embodiment and other embodiments without cloud services can be used to practice the invention.

In one embodiment, the server IVL application 30a on the server network device 20, 22, 24, 26 uses a user profile previously created for the user 39. However, the present invention is not limited to such an embodiment and other embodiments can be used to practice the invention.

At Step 118, sending securely one or more response messages 13rs, 15rs in real-time for the desired person 41 from server IVL application 30a on the server network device 20, 22, 24, 26 for the desired person 41, to the second IVL application 30 on the second network device 12, 14, 16, 20, 22, 24, 26, 31, 33, 35, 37, 98-104 for the user 39 via the communications network 18, 18′, including all requested identification verification and location services information 45, 153 for the desired person 41 available to the user 39 of the second network device 12, 14, 16, 20, 22, 24, 26, 31, 33, 35, 37, 98-104, based on the determined one more permissions and the determined one or more security layers available for the user 39 of the second network device 12, 14, 16, 20, 22, 24, 26, 31, 33, 35, 37, 98-104, to access and use in real-time the requested identification verification or location services available to the user 39 of the second network device 12, 14, 16, 20, 22, 24, 26, 31, 33, 35, 37, 98-104 for the desired person 41.

In one embodiment, the one or more response messages 13rs, 15rs are sent securely using one or more of the encryption and/or security methods described herein. However, the present invention is not limited to such an embodiment and other encryption and/or security methods can be used to practice the invention.

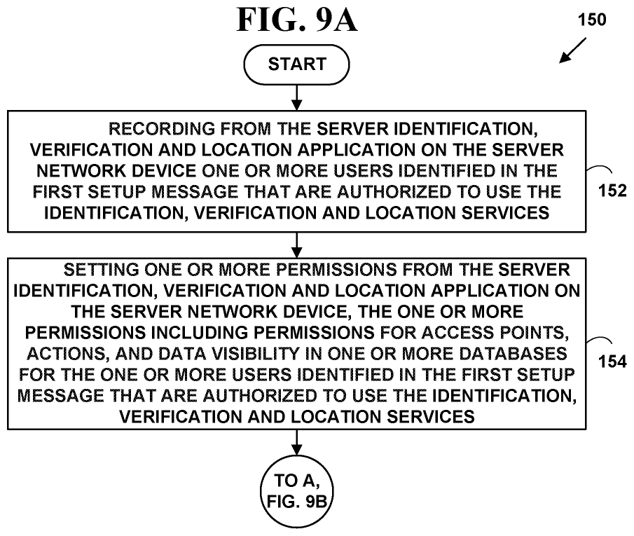

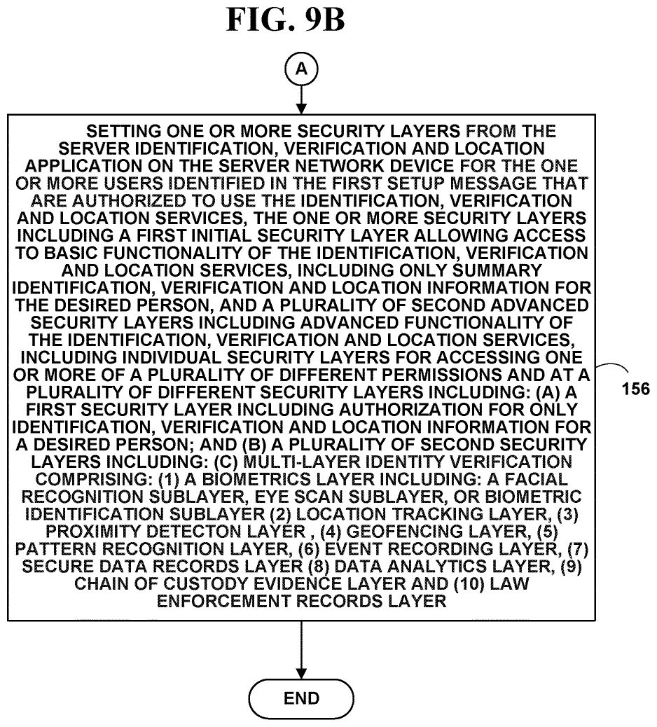

FIGS. 9A and 9B are a flow diagram illustrating a Method 150 for providing identification verification and location services.

In FIG. 9A at Step 152, recording from the server identification verification and location application on the server network device one or more users identified in the first setup message that are authorized to use the identification verification and location services; At Step 154, setting one or more permissions from the server identification verification and location application on the server network device, the one or more permissions including permissions for access points, actions, and data visibility in one or more databases for the one or more users identified in the first setup message that are authorized to use the identification verification and location services; In FIG. 9B, at Step 156, setting one or more security layers from the server identification verification and location application on the server network device for the one or more users identified in the first setup message that are authorized to use the identification verification and location services, the one or more security layers including a first initial security layer allowing access to basic functionality of the identification verification and location services, including only summary identification verification and location information for the desired person, and a plurality of second advanced security layers including advanced functionality of the identification verification and location services, including individual security layers for accessing one or more of a plurality of different permissions and at a plurality of different security layers including: (a) a first security layer including authorization for only summary identification verification and location information for a desired person; (b) a plurality of second security layers including: (1) multi-layer identity verification layer comprising: a facial recognition sublayer, eye scan sublayer, or biometric markers identifier sublayer (2) location tracking layer, (3) proximity layer, (4) geofencing of the desired person, (5) pattern recognition layer, (6) event recording layer, (7) secure data records layer, (8) data analytics layer, (9) electronic chain of custody layer, and (10) law enforcement records layer.

In FIG. 9B at Step 156, setting one or more security layers 122-148 from the server identification verification and location application 30a on the server network device 20, 22, 24, 26 for the one or more users 39 identified in the first setup message 13s, 15s, that are authorized to use the identification verification and location services, the one or more security layers 122-124 including a first initial security layer 124 allowing access to basic functionality of the identification verification and location services, including only summary identification verification and location information 43, 126 for the desired person, and a plurality of second advanced security layers 128-148 including advanced functionality of the identification verification and location services, including individual security layers for accessing one or more of a plurality of different permissions and at a plurality of different security layers including: (a) a first security layer 124 including authorization for only summary identification verification and location information 126 for a desired person 41; (b) a plurality of second security layers plurality of different security layers 122-148 including: (a) a first security layer 124 including authorization for providing only summary identification verification and location information 43, 126 for a desired person; (b) a plurality of second advanced security layers 128-148 including: (1) multi-layer identity verification layer 129 comprising: a biometric layer 130 including: a facial recognition sublayer 130a, eye scan sublayer 130b, and biometric markers identification sublayer 130c, (2) location tracking layer 132, (3) proximity detection layer 134 (4) geofencing layer 136, (5) pattern recognition layer 138, (6) event recording layer 140, (7) secure data records layer 142, (8) data analytics layer 144, (9) electronic chain of custody layer 146, and (10) law enforcement records layer 148.

The present invention is illustrated with an exemplary embodiment. However, the present invention is not limited to such an embodiment and other embodiments can be used to practice the invention.

In such an exemplary embodiment in FIG. 9A at Step 160, recording from the server identification verification and location application 30a on the server network device 20, 22, 24, 26, one or more users 39 identified in the first setup message 13s, 15s that are authorized to use the identification verification and location services.

At Step 154, setting one or more permissions from the server identification verification and location application 30a on the server network device 20, 22, 24 26, the one or more permissions including permissions for access points, actions, and data visibility in one or more databases 20′, 22′, 24′, 26′ and/or a block chain 174 (FIG. 13) for the one or more users 39 identified in the first setup message 13s, 15s that are authorized to use the identification verification and location services.

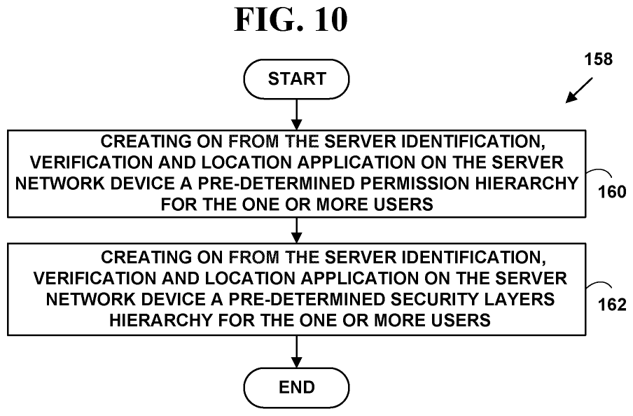

FIG. 10 is a flow diagram illustrating a Method 158 for providing identification verification and location services.

In FIG. 10, at Step 160 creating on from the server identification verification and location application on the server network device a pre-determined permission hierarchy for the one or more users; and at Step 162 creating on from the server identification verification and location application on the server network device a pre-determined security layers hierarchy for the one or more users.

The present invention is illustrated with an exemplary embodiment. However, the present invention is not limited to such an embodiment and other embodiments can be used to practice the invention.

In such an exemplary embodiment in FIG. 10 at Step 160, creating on from the server identification verification and location application 30a on the server network device 20, 22, 24, 26 a pre-determined permission hierarchy for the one or more users 39.

At Step 162, creating on from the server identification verification and location application 30a on the server network device 20, 22, 24, 26 a pre-determined security layers hierarchy for the one or more users 39.

In one embodiment, the pre-determined permission hierarchy and the pre-determined security layers hierarchy, include, but is not limited to a hierarchy comprising a tree, binary tree and/or an array data structure. An array is a data structure consisting of a collection of elements (e.g., values, variables, cloud services, etc.), of same memory size, each identified by at least one array index or key. An array is stored such that a position of each element can be computed from its index tuple by a mathematical formula. However, the present invention is not limited to such an embodiment and other embodiments with more, fewer and/or other security layer data structures can be used to practice the invention.

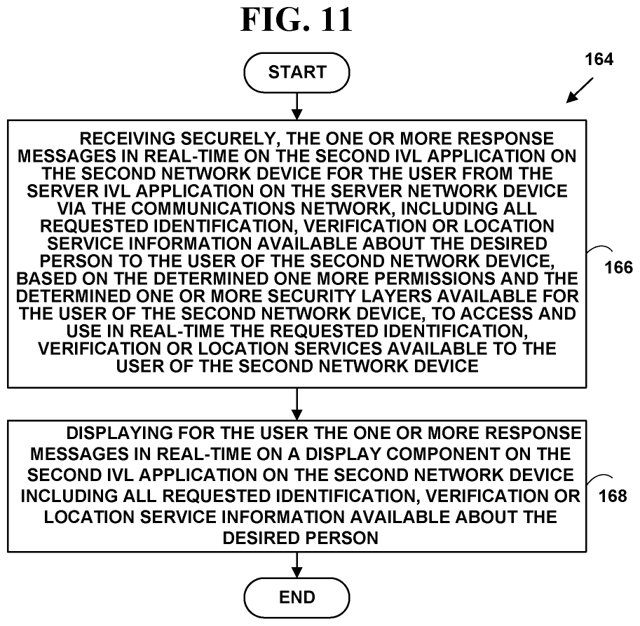

FIG. 11 is a flow diagram illustrating a Method 164 for providing identification verification and location services.

In FIG. 11 at Step 166, receiving securely, the one or more response messages in real-time on the second IVL application on the second network device for the user from the server IVL application on the server network device via the communications network, including all requested identification verification or location service information available about the desired person to the user of the second network device, based on the determined one more permissions and the determined one or more security layers available for the user of the second network device, to access and use in real-time the requested identification verification or location services available to the user of the second network device; and at Step 168, displaying for the user the one or more response messages in real-time on a display component on the second IVL application on the second network device including all requested identification verification or location service information available about the desired person.

The present invention is illustrated with an exemplary embodiment. However, the present invention is not limited to such an embodiment and other embodiments can be used to practice the invention.

In such an exemplary embodiment in FIG. 11 at Step 166, receiving securely, the one or more response messages 13rs, 15rs in real-time on the second IVL application 30 on the second network device 12, 14, 16, 20, 22, 24, 26, 31, 33, 35, 37, 98-104 for the user from the server IVL application 30a on the server network device 20, 22, 24, 26 via the communications network, 18, 18′ including all requested identification verification or location service information 45, 153 available about the desired person 41 to the user 39 of the second network device 12, 14, 16, 20, 22, 24, 26, 31, 33, 35, 37, 98-104, based on the determined one more permissions and the determined one or more security layers 124-148 available for the user of the second network device 12, 14, 16, 20, 22, 24, 26, 31, 33, 35, 37, 98-104, to access and use in real-time the requested identification verification or location services available to the user 39 of the second network device 12, 14, 16, 20, 22, 24, 26, 31, 33, 35, 37, 98-104.

At Step 168, displaying for the user the one or more response messages 13rs, 15rs in real-time on a display component 24 via the second IVL application 30 on the second network device 12, 14, 16, 20, 22, 24, 26, 31, 33, 35, 37, 98-104 including all requested identification verification or location service information 45, 153 available about the desired person 41.

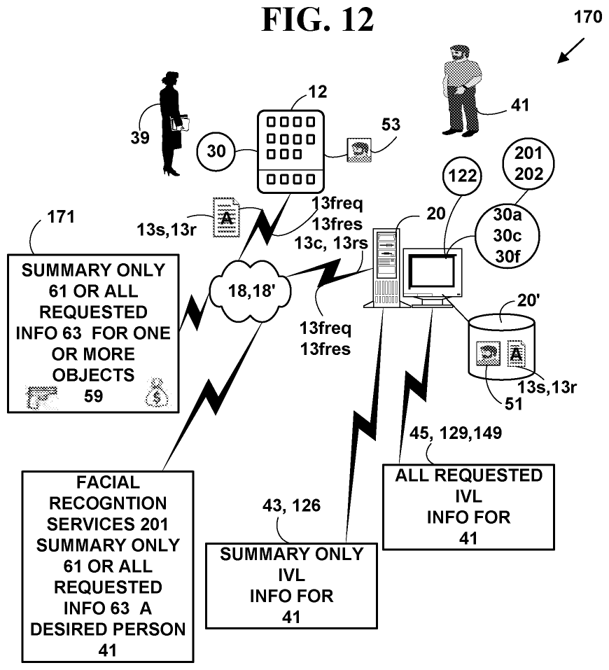

FIG. 12 is a block diagram illustrating a data flow 170 for providing identification verification and location services.

In FIG. 12 a selected user 39 (e.g., law enforcement officer, etc.) is only authorized and/or only requests IVL summary information 43, 126 for a desired person 41 (e.g., a criminal offender, etc.) and/or is authorized and receives all requested IVL information 45, 153 for the desired person. However, the present invention is not limited to such an embodiment and other embodiments can be used to practice the invention.

In one embodiment, Methods 106, 150, 154, 158, 164 further include creating IVL information 171 including authorized information 61 and/or summary IVL information collected 63 for one or more objects 59 (e.g., ticket, valuable object, dangerous object, financial object, e-commerce object, food object, machine object, etc.) instead of a desired person 41. However, the present invention is not limited to such an embodiment and other embodiments can be used to practice the invention.

FIG. 12 also illustrates IVL information 171 including authorized information 61 and summary IVL information collected 63 for the one or more objects 59 (e.g., ticket, valuable object, dangerous object, financial object, e-commerce object, food object, machine object, etc.) However, the present invention is not limited to such an embodiment and other embodiments can be used to practice the invention.

### Block Chains

A “block chain” is a public ledger of all transactions that have ever been executed. It is constantly growing as completed blocks are added to it with a new set of recordings. The blocks are added to the block chain in a linear, chronological order. Block chains are used on P2P networks and other networks such as cloud communications networks. Each P2P node gets a copy of the block chain, which gets downloaded automatically upon joining P2P. The block chain has complete information about the block owners and block content right from the first block to the most recently completed block.

A “block chain is also a digital ledger that records every transaction that has ever occurred. Block chains and transactions on block chains are typically protected by cryptography. More importantly, though, the block chain does not reside in a single server, but across a distributed network of servers and computer such as a cloud computing network and a P2P computing network.

Accordingly, whenever new transactions occur, a new block chain 174 is authenticated across this distributed network, then the transaction is included as a new “block” on the “chain.” A block chain implementation comprises of two kinds of records: transactions and blocks.

“Transactions” are the content to be stored in the block chain (e.g., financial transactions, etc.). Transactions are created by participants using the system. In the case of cryptocurrencies, a transaction is created any time a cryptocurrency owner sends cryptocurrency to someone.

A transaction is also a transfer of value between digital wallets that gets included in the block chain. Digital wallets, including the cryptocurrency BITCOIN wallets, store a secret piece of data called a “private key” or, which is used to digitally sign transactions, providing a mathematical proof that the digital signature has actually come from the owner of the digital wallet.

System users create transactions that are passed from node to node on a best-effort basis. The system implementing the block chain defines a valid transaction. In cryptocurrency applications, a valid transaction must be digitally signed, spend one or more unspent outputs of previous transactions, and the sum of transaction outputs must not exceed the sum of inputs.

Blocks record and confirm when and in what sequence transactions enter and are logged in the block chain. Blocks are created by users known as “miners” who use specialized software or equipment designed specifically to create blocks.

In a cryptocurrency system, miners are incentivized to create blocks to collect two types of rewards: a pre-defined per-block award, and fees offered within the transactions themselves, payable to any miner who successfully confirms the transaction.

Block chains are decentralized and do not require a “central authority” or “middleman.” Every node in a decentralized system has a copy of the block chain. This avoids the need to have a centralized database managed by a trusted third party. Block chain transactions are broadcast to a network using software applications. Network nodes can validate transactions, add them to their copy and then broadcast these additions to other nodes. To avoid the need for a trusted third party to timestamp transactions, decentralized block chains use various timestamping schemes, such as proof-of-work.

The core advantages of the block chain architecture include, but are not limited to those described in Table 6.

```
TABLE 5
  The ability for independent nodes to converge on a consensus of the
latest version of a large data set such, as a ledger, even when the nodes are
run anonymously, have poor interconnectivity and have operators who are
dishonest or malicious.
  The ability for any well-connected node to determine, with reasonable
certainty, whether a transaction does or does not exist in the data set.
  The ability for any node that creates a transaction to, after a
confirmation period, determine with a reasonable level of certainty
whether the transaction is valid, able to take place and become final
(i.e., that no conflicting transactions were confirmed into the blockchain
elsewhere that would invalidate the transaction, such as the same
currency units “double-spent” somewhere else).
  A prohibitively high cost to attempt to rewrite or alter transaction
history.
  Automated conflict resolution that ensures that conflicting
transactions (such as two or more attempts to spend the same balance in
different places) never become part of the confirmed data set.
```

A “digital wallet” is a software program where block chains are stored. A digital wallet stores a private encryption key for every block chain address that is saved in the digital wallet of the person who owns the balance. Digital wallets facilitate sending and receiving block chains and gives ownership of the block chain balance, if it includes financial information such as cryptocurrency (e.g., BITCOINS, etc.) to a user.

A digital wallet stored on a communications network, allows a user to use block chains from anywhere, on any browser and/or any mobile network device and/or any smart network device and/or any wearable network device. Storing a digital wallet must be done carefully since it stores private encryption keys for the block chains online.

FIG. 13 is a block diagram 172 illustrating an exemplary block chain 174.

In FIG. 13, the block chain 174 includes plural blocks 176, 178, 180 (only three of which are illustrated) in a blockchain ledger 181 which include one or more items, and plural transactions 182, 184 (only two of which are illustrated). Exemplary transaction 182 includes, for example, includes taking Owner-B's public key 186 for block 176 in block chain 174, running it through a hash algorithm (e.g., SHA-256, etc.) and obtaining Owner-A's digital signature, Owner-B signs the block 176 with its private key and Owner-B's signature is verified on the next block 178, etc. Transaction 184 includes identical steps as was illustrated in transaction 182. However, the present invention is not limited to this embodiment and more, fewer or other exemplary block chain transactions can be used to practice the invention.

In one embodiment, the summary identification verification and location information 43, 126 for the desired person 41 and/or all requested identification verification location services information 45, 153 for the desired person 41 are stored in block chain blocks, 176, 178, 180, in a block chain 174. However, the present invention is not limited to such an embodiment and other embodiments, with and/or without block chains can be used to practice the invention.

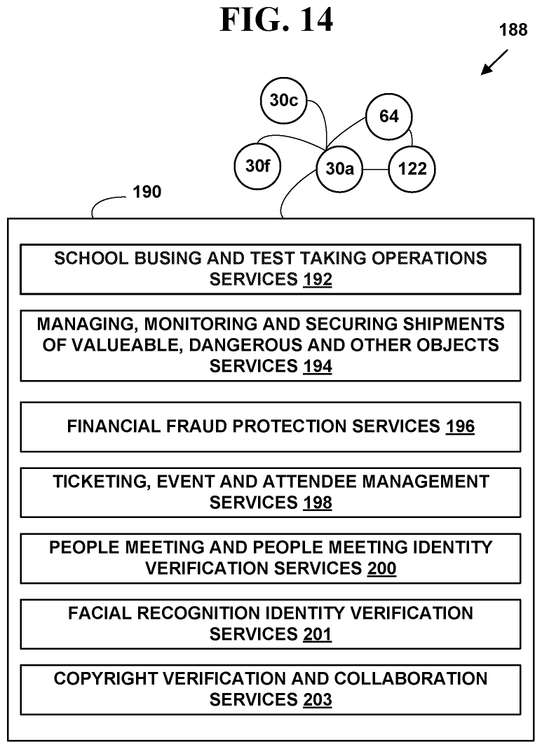

FIG. 14 is a block diagram 188 illustrating plural different services available on the server identification verification and location application on the server network device.

FIG. 14 illustrates the server identification verification and location application 30a on the server network device 20, 22, 24, 26, providing plural real-time services 190 for: (1) school, busing and testing operations 192; (2) identification verification, tracking and location information for valuable and/or dangerous objects 59 and/or other types of objects; (3) financial fraud protection for merchants, financial institutions, law enforcement and consumers 196; (4) ticketing, event and attendee management 198; (5) people meeting and people verification management services 200; and (6) facial recognition identify verification services 201 available to verify an identity of desired persons 41 within all services 192-200.

### School, Busing and Test Taking Operation Services 192

The server identification verification and location (IVL) application 30a on the server network device 20, 22, 24, 26 and/or the IVL application 30 on the target network device 12, 14, 16, 31, 33, 35, 37, 106-112 with the plurality of different security layers 122-148 provides real-time services 192 for school, bussing and test taking operations 192. The services 192 include cloud SaaS 64 services and non-cloud services.

The services 192 includes summary identification verification and location information 43, 126 for a desired person 41 and/or all requested identification verification and location services information 45, 153 for the desired person 41 including secure critical school and test-related processes, including child drop-offs and pickups, bus operations, and test-taking activities.

The IVL application 30a/30 uses as facial recognition, block chain, real-time notifications, and data analytics to provide a comprehensive and a user-friendly platform for schools, parents, bus companies, and testing organizations. The server IVL application 30a ensures accountability, security, and efficiency for school, busing and test taking operations.

Some advantages of using the IVL application 30a with the plurality of different security layers 122-148 for school, busing and testing operations services 192 include, but are not limited to those described in Table 7.

```
TABLE 6
1. School Operations:
  Provides facial recognition and GPS tracking of students.
  Manages secure student drop-offs and pickups at school, day care, after care,
  sports practice, music practice, drama practice, sports games, music and drama
  performances, etc.
  Provides real-time notifications to parents, guardians, grandparents and other
  authorized individuals.
  Tracks access points, timestamps, and authorized individuals.
2. Bus Operations:
  Provides facial recognition and GPS tracking for buses and students on buses.
  Logs student pickups and drop-offs with identity verification.
  Notifies parents of bus arrivals, departures, and completed drop-offs.
3. Testing Operations:
  Facilitates test registration, payment, and identity verification for students for
  every day academic testing, college and professional license testing.
  Provides facial recognition and GPS tracking of test takers.
  Allows proctors to securely manage test sessions, attendance, and
  accommodations.
  Provides testing organizations (e.g., Advance Placement, (AP), ACT, SAT,
  LSAT, MCAT, insurance licensing, financial professional licensing, medical
  licensing, medical board certifications, dental licensing, law licensing, certified
  public accountant (CPA), general securities representative exams (GSRE) (e.g.,
  Series 7, etc.) real-estate licensing, etc.) with comprehensive analytics and
  reporting.
4. Parent and Guest Access:
  Provides facial recognition and GPS tracking.
  Parents manage authorized pickup persons, receive notifications, and access
  records.
  Guests use electronic links (e.g., SMS, DM, email, etc.) for secure, temporary
  or permanent pickup authorizations.
5. Continuing Education:
  Facilitates registration, payment, and identity verification for individuals taking
  professional continuing education classes (e.g., law, medical, insurance,
  accounting, etc.).
```

### Managing, Monitoring, Tracking and Securing Shipments of Valuable or Dangerous Object Services 194

The server identification verification and location (IVL) application 30a on the server network device 20, 22, 24, 26 and/or the IVL application 30 on the target network device 12, 14, 16, 31, 33, 35, 37, 106-112 with the plurality of different security layers 122-148 provides real-time services 194 for, summary identification verification, tracking and location information for valuable and/or dangerous objects and other types of objects such as food shipments, machinery, etc. The services 194 include cloud SaaS 64 services and non-cloud services.

The server identification verification and location (IVL) application 30a as AI 30c, block chain 174, and IoT 33 technologies for high-value objects (e.g., physical currencies and cryptocurrencies, stock certificates, bond certificates, gems, such diamonds, rubies, etc., metals such as gold, silver, platinum, etc.) and sensitive shipments (e.g., guns, military arms, ammunitions, munitions, military equipment, radio-active materials, etc.) from e-commerce to government and military operations, ensuring security, tracking, transparency, location verification, delivery verification and operational flexibility.

Some advantages of using the IVL application 30a/30 with the plurality of different security layers 122-148 for providing real-time services 194 for summary identification verification, tracking and location information for valuable and/or dangerous objects, include, but are not limited to those described in Table 8.

```
TABLE 7
1. AI 30c Integration for Predictive and Proactive Risk Mitigation
    Dynamic Risk Assessment: Leverages AI 30c to continuously analyze real-time
  and historical data, assigning dynamic risk scores to shipments based on factors
  like
  route conditions, package value, and security features. This allows for proactive
  adjustments to mitigate theft, delays, or tampering risks.
    Route Optimization: AI 30c driven algorithms optimize delivery routes in real
  time,
  accounting for traffic, weather, and security risks to ensure timely and efficient
  shipments.
    Anomaly Detection: AI 30c monitors handler behavior, package movement, and
  geofence compliance to detect unusual activity, triggering alerts and automated
  protective measures when necessary, including for food shipments when listeria
  and/or salmonella outbreaks are detected.
2. Blockchain 174 Security for Immutable Transparency
    Chain-of-Custody Logging: Shipment interaction, from creation to final delivery,
  is immutably logged on the blockchain 174. This ensures a transparent, tamper-
  proof
  record of all events including serial numbers, other identifiers, including handoffs,
  tampering alerts, and manual overrides.
    Dispute Resolution and Accountability: Blockchain 174 logs provide indisputable
  evidence for resolving disputes, verifying chain-of-custody, and maintaining
  regulatory compliance.
    Dedicated Blockchain 174 Architecture: For high-security applications, such as
  government
  or military operations, Customizable, dedicated blockchains 174 to ensure
  data isolation and enhanced security.
3. Payments and Financial Management:
    Processes payments for shipments, including customizable security tiers and
  premium features.
    Tracks payment history, invoices, and outstanding balances.
    Provides revenue analytics to monitor financial performance.
4. Incident Management and Overrides:
    Allows administrators to respond to incidents, such as tampering alerts or
  recipient
  verification failures.
    Offers manual override tools for situations requiring customer support
  intervention.
    Logs all overrides and incident resolutions on the blockchain for transparency.
5. Mapping System:
    Provides an interactive map showing shipment locations, routes, and geofences.
    Displays event markers for incidents like tampering or geofence breaches.
    Allows administrators to modify geofences and optimize delivery routes in real-
  time.
6. Adaptability Across Industries
    Modular Design: The applications 30a modular architecture allows
    shippers, receivers, vendors/partners, and government/military entities, ensuring a
    tailored user experience for each stakeholder.
    Scalability: designed to handle everything from small business shipments
    to enterprise-level logistics, with multi-language support and global integration
    capabilities.
    Cross-Sector Applications: The application 30a supports diverse industries,
    including:
      E-commerce: Secure, trackable deliveries with biometric recipient
      verification.
      Healthcare: Temperature-controlled tracking for sensitive medical shipments.
      Government and Military: Secure logistics with geofencing, encrypted data,
      and
      capabilities for classified operations.
7. Operational Flexibility and Reliability
    Manual Override Systems: Built-in override protocols allow administrators to
    resolve issues like verification failures, geofence breaches, or tampering alerts
    without disrupting shipment progress.
    Offline Mode: Critical shipment data and actions remain accessible during
    connectivity outages, with automatic syncing upon restoration.
    Multi-Modal Tracking: Redundant tracking technologies, including GPS, cellular
    triangulation, and RFID, ensure reliable location monitoring even in challenging
    environments.
8. Advanced Security and Compliance
    Biometric and electronic link verification: Ensures only authorized personnel
  handle to send or receive packages, with logs stored immutably on the blockchain
  174.
    Tamper-Proof Packaging: IoT 33-enabled lockboxes and tamper-evident seals
  provide real-time alerts for potential breaches.
    Regulatory Compliance: The application 30a adheres to global data privacy and
  security standards, such as the European Union (EU) General Data Protection
  Regulation (GDPR) and the United States Health Insurance Portability and
  Accountability Act (HIPAA), making it ideal for handling sensitive
  shipments.
```

### Financial Fraud Protection Services 196

The server identification verification and location (IVL) application 30a on the server network device 20, 22, 24, 26 and/or the IVL application 30 on the target network device 12, 14, 16, 31, 33, 35, 37, 106-112 with the plurality of different security layers 122-148 provides real-time services 196 for financial fraud protection for merchants, financial institutions, securities instructions, law enforcement and consumers. The services 196 include cloud SaaS 64 services and non-cloud services.

Some advantages of using the IVL application 30a/30 with the plurality of different security layers 122-148 for providing real-time services 196 for financial fraud protection include, but are not limited to those described in Table 9.

```
TABLE 8
1. Real-Time Fraud Detection and Prevention for Merchants
  Provides merchants cutting-edge fraud detection tools to protect
  businesses and institutions from losses.
  AI 30cPowered Fraud Scoring:
  Identifies suspicious behavior in real time using machine learning algorithms
  and dynamic risk profiling.
  Transaction Monitoring:
  Alerts merchants immediately about high-risk or flagged transactions.
  Enables instant manual overrides with identity verification tools, including live
  photo capture and ID matching.
  Employee Accountability:
  Tracks employee-related fraud patterns, identifying specific registers or
  individuals with unusually high fraudulent activity.
  Provides analytics for merchants to mitigate internal risks effectively.
2. Financial Institution and Securities Institutions Integration
  Banks, brokers, and credit card issuers benefit from robust fraud prevention
  capabilities.
  Dynamic Safety Features:
  Allows banks to toggle security features (e.g., facial recognition, spending
  limits) for each cardholder based on risk profiles.
  Fraud History Analysis:
  Enables banks to query individuals for prior grand larceny or fraud incidents
  before issuing new credit cards or adjusting credit limits.
  Dispute Management:
  Streamlines chargeback workflows, ensuring swift and accurate resolutions
  between banks, merchants, and consumers.
3. Law Enforcement Dashboard and Collaboration
  Provides law enforcement with a powerful, user-friendly dashboard designed
  to streamline investigations:
  Accusatory Instrument Generation:
  Automatically compiles detailed reports, including purchaser photos,
  transaction details, and fraud likelihood scores, for use in grand larceny cases.
  Geographic Focus Tools:
  Allows officers to analyze flagged transactions in specific areas to identify
  fraud hotspots.
  Cross-Merchant Collaboration:
  Enables law enforcement to connect fraud patterns across multiple merchants
  for broader investigations.
4. Vehicle and Vessel Fraud Prevention
  High-value purchases, such as vehicles 37, trucks, aircraft and boats, are a key
  focus area.
  Dedicated Purchase Tab:
  Tracks VINs, hull identification numbers, and other unique identifiers for
  vehicles and vessels.
  Identity Verification:
  Ensures purchaser legitimacy through real-time ID checks and biometric tools
  like facial recognition.
  Post-Sale Monitoring:
  Tracks high-value items to prevent fraudulent resales and aids in recovering
  stolen property.
5. Consumer Protection
  Prioritizes consumer trust and safety with features tailored for cardholders:
  Real-Time Alerts:
  Notifies users of every transaction, including flagged purchases with photo
  verification.
  User-Friendly Dispute Resolution:
  Allows cardholders to confirm or deny transactions instantly, triggering fraud
  investigations if necessary.
  Educational Tools:
  Provides cardholders with tips and resources for spotting and preventing fraud.
6. Scalable Design for Global Reach
  Built to handle massive transaction volumes, leveraging:
  Cloud-Native and Blockchain 174 architecture:
  Ensures elastic scalability for growing user bases.
  Secondary System:
  Provides operational continuity during blockchain or network downtime.
  International Integration:
  Enables cross-border fraud detection and global database cross-referencing for
  stolen goods.
```

### Ticketing, Event and Attendee Management Services 198

The server identification verification and location (IVL) application 30a on the server network device 20, 22, 24, 26 and/or the IVL application 30 on the target network device 12, 14, 16, 31, 33, 35, 37, 106-112 with the plurality of different security layers 122-148 provides real-time services 198 for ticketing, event and attendee management. The services 198 include cloud SaaS 64 services and non-cloud services.

Some advantages of using the IVL application 30a/30 with the plurality of different security layers 122-148 for providing real-time services 198 for financial fraud protection include, but are not limited to those described in Table 10.

```
TABLE 9
1. Biometric-Based Ticketing:
  Eliminates the need for phones or physical tickets by providing biometric based
  ticketing relying on facial recognition, gait analysis and/or other biometrics
  (e.g., voice, finger prints, iris scanning, retinal scan, vein scan, tattoos, etc.) for
  event access.
2. Geofencing:
  Enables real-time attendee monitoring and dynamic venue management.
3. Wearable 98-102 Safety Devices:
  Provides enhanced safety for children and special needs individuals through
  real-time tracking and notifications via wearable devices 98-102.
4 Advanced Analytics:
  Offers event organizers actionable insights, including demographic
  breakdowns, behavioral patterns, and payment trends.
5. Fraud Prevention Mechanisms:
  Validates ticket authenticity and prevents unauthorized access through
  biometric and geofence-linked systems.
6. Post-Event Tools:
  Features user-generated content sharing and memorabilia integration to enhance
  the attendee experience and drive engagement.
7. Augmented Reality (AR)/Virtual Reality (VR) Navigation:
  Provides AR/VR overlays to guide users in physical venues.
8. Crowd-Aware Navigation:
  Uses live crowd density data to dynamically adjust AR navigation paths,
  optimizing attendee movement and preventing congestion.
  Provides real-time route changing based on foot traffic and predicted movement
  trends.
9. User-Centric Customization:
  Allows attendees to personalize their AR interface, choosing overlays for
  different needs
  (e.g., food stalls, restrooms, family areas, or accessibility paths).
  A customizable AR navigation system tailored to individual attendee
  preferences.
10: AI 30c Powered Wayfinding:
  AI applications 30 c to predict attendee destinations based on behavior (e.g.,
  seat location, event schedule) and proactively display directions.
  An attendee walking toward the food court sees suggested paths with wait times
  and nearby deals.
11. Dynamic Ticket Pricing:
  Uses machine learning to adjust prices based on demand.
12. Predictive Behavioral Pricing:
  Ticket Use a hybrid approach combining historical data and real-time behavior
  (e.g., how long a user views specific tickets) to calculate dynamic pricing.
  Behavioral pricing algorithms that predict willingness to pay based on in-app
  interactions.
13. Sharing and Group Discounts:
  Provides dynamic group pricing where discounts scale based on the size of the
  group and proximity of their seats.
  Adjacent seat bundling discounts for families or friends booking together.
14. Gamified Pricing Models:
  Enable users to participate in time-sensitive games (e.g., “beat the clock”
  discounts or challenges) to secure dynamic pricing offers.
  Gamification of ticket pricing tied to real-time engagement.
15. Integration into a Unified Platform:
  Independent User Profiles Across Events:
  Uses of decentralized user profile system where attendee data is stored locally
  and shared temporarily with venues only for specific events.
  Profiles can be deleted or reset after events, ensuring no long-term storage of
  personal information by venues- if the user wants their data deleted.
  Unified Dashboard with Predictive Analytics:
  Provides venues with a dashboard that predicts attendee behavior across events,
  using anonymized behavioral patterns rather than direct user data.
  Provides predictive attendee analytics based on anonymized cross-event
  behavior.
16. Tokenized Ticketing System:
  Replaces traditional ticketing with a blockchain-based system that creates
  unique, event-specific tokens for each attendee.
  Tokens are transferred securely and can include embedded AR features for
  post-event engagement.
17. Dynamic Event-Specific Smart Contracts
  Self-Updating Tickets: Use blockchain smart contracts to create tickets that
  adapt dynamically:
  Changes access levels (e.g., general admission upgrades to VIP based on
  availability or user engagement).
  Unlocks perks or features (e.g., special discounts for frequent attendees or free
  merchandise).
  Automates refunds if events are canceled, ensuring trust.
18. Non-Fungible Token (NFT) Tickets with Evolving Features
  Each ticket is minted as a unique NFT that evolves:
  After the event, tickets can convert into collectibles with exclusive perks like
  access to event
  photos, videos, or signed memorabilia.
  Embeds gamified elements, such as unlocking rare, tradable NFT items only
  available to attendees.
  Offers limited-edition, themed ticket NFTs for special events to drive
  exclusivity.
19. Provenance and Ownership Tracking
  Showcases the entire history of a ticket:
  Buyers can view the ticket's origin, price changes, and ownership transfers
  directly on the Blockchain 174.
  Transparency builds trust and discourages scalping.
20. Interoperable Ticketing Ecosystem
  Leverage cross-event compatibility:
  Tickets purchased for one event grant access to another partner event or
  discounts,
  creating a unified ecosystem of experiences.
  Tokenized tickets integrate with loyalty programs or enable cross-platform use
  (e.g., in gaming, music, or travel).
21. Anti-Scalping and Secure Resale Markets
  Includes resale control mechanisms:
  Resale prices are governed by smart contracts to cap scalping.
  Blockchain verifies authenticity and ownership of tickets in the secondary
  market, preventing counterfeiting.
  Uses identity-linked NFTs to ensure tickets cannot be sold without proper
  verification, reducing fraud.
22. Decentralized Ticket Wallets
  Instead of centralized storage, attendees store their tickets in decentralized
  wallets:
  This ensures attendees own their tickets outright, increasing trust and user
  autonomy.
  Enables seamless ticket management across multiple devices and platforms.
23. Blockchain Analytics and Audience Insights
  Uses blockchains 174 to provide transparent, anonymized data to event
  organizers:
  Views attendance patterns, resale trends, and engagement metrics on-chain.
  Offers event-specific tokens or badges based on user behavior (e.g., frequent
  attendee rewards).
23. Revenue Sharing via Tokenomics
  Provides revenue-sharing models:
  A portion of ticket sales is redistributed to artists, event staff, or even loyal
  attendees using blockchain 174 tokens.
  Implements royalty features so creators or organizers receive a percentage of
  resale profits on
  the blockchain 174.
24. Token-Gated Experiences
  Uses blockchain to create exclusive, token-gated experiences:
  Only attendees with a specific NFT ticket can access certain event features,
  AR/Virtual Reality (VR).
  experiences, or post-event content.
  Allows NFT holders to vote on event-related decisions, creating a decentralized
  fan-driven event.
25. Blockchain for Reputation and Trust
  Establishes a reputation system for attendees:
  Tracks attendance history and engagement using blockchain tokens.
  Rewards frequent attendance with priority access to future events or discounted
  tickets.
  Builds trust with event partners by providing an immutable ledger of ticket
  sales, revenue splits, and attendance data.
26. Sustainable and Transparent Ticketing
  Uses eco-friendly blockchains to reduce the carbon footprint of ticketing.
  Includes detailed, blockchain-verified reporting of sustainability initiatives tied
  to the event (e.g.,
  funds donated to green causes).
27. Universal Blockchain 174 Integration
  Integrates with multiple blockchain 174 networks:
  Allow attendees to choose their preferred blockchain for ticket storage.
```

### People Identification and People Identity Verification Management Services 200

The server identification verification and location (IVL) application 30a on the server network device 20, 22, 24, 26 and/or the IVL application 30 on the target network device 12, 14, 16, 31, 33, 35, 37, 106-112 with the plurality of different security layers 122-153 provides real-time services 200 for people meeting and people meeting identity verification services 200. The services 200 include cloud SaaS 64 services and non-cloud services.

The services 200 include people meeting identity verification services for identifying and verifying identifies of people at schools, day-care, dating sites, employment interviews, professional meetings, networking events, professional appointments (e.g., medical, legal, real-estate, accounting, etc.) goods pick-up and drop-off, goods transport, taxi drivers, baby sitters, contractors, repair people, rideshare drivers, rideshare vehicles, curriers, messengers, concerts, sporting events, movies, community events, banks, hospitals, medical clinics, urgent care clinics, automated teller machines (ATM), doorbell cameras, security cameras, trail cameras, traffic cameras, airport security screening, etc.

Some advantages of using the IVL application 30a/30 with the plurality of different security layers 122-153 for providing real-time services 200 for people meeting and people identity verification include, but are not limited to those described in Table 11.

```
TABLE 10
1. Automatic Biometric Recognition and Identify verification:
  Automatic real-time facial recognition, voice, finger prints, iris scanning,
  retinal scan, vein scanning, gait analysis, tattoos, etc. to verify an identity of a
  desired person 41 with a pre-determined level of precision.
2. Automated Identity Verification for On-Line Meetings:
  Automatic real-time facial recognition, voice, finger prints, iris scanning,
  retinal scan, vein scanning, gait analysis, tattoos, etc.to verify an identity of a
  desired person 41 with a pre-determined level of precision for personal on-line
  meetings, video chats, professional on-line meetings (e.g., telemedicine, legal,
  etc.).
3. Automatic Collection and Linking of Social Media Profiles and Social Media Posts:
  Use of AI 30c and blockchains 174 to collect and analyze, pictures, user
  profiles social media posts, for comprehensive insights.
4. Automated Search Engine Analysis:
    Use of AI 30c and blockchains 174 to collect and analyze search engine
  information including information from news articles, professional meetings,
  family events, community events, etc.
5. Automated Behavioral analysis:
  Use of AI 30c and blockchains 174 for user-driven flagging and pattern
  recognition to aid in the identification of individuals and the determination of if
  the individual(s) is/are dangerous, have a prior criminal record, have a negative
  dating history, dating site complaints, have been cited in a negative way in a
  news article, social media post, etc.
6. Automated Collection Analysis of Law Enforcement and Legal Databases:
  Use of AI 30c and blockchains 174 to collect and analyze arrest, conviction and
  criminal records, arrest warrants, BOLOs, most wanted information and/or civil
  records.
7. Automated Collection and Analysis of Credit Information:
    Use of AI 30c and blockchains 174 to collect and analyze credit information
  including credit reports, loan information, etc.
8. Automated Collection and Analysis of Prior Employment Information:
  Use of AI 30c and blockchains 174 to collect and analyze prior employment
  information.
```

The methods and systems described herein have been described with respect to people 41 and objects 59. However, the methods and systems are not limited to such embodiments and the methods and system can be used to identify, locate, track, secure and verify animals such as pets, livestock, wild animals, and other objects such as construction equipment, sports equipment and/other types of objects. However, the present invention is not limited to such embodiments sand other embodiments can be used to practice the invention.

### Copyright Verification and Collaboration Services 203

The server identification verification and location (IVL) application 30a on the server network device 20, 22, 24, 26 and/or the IVL application 30 on the target network device 12, 14, 16, 31, 33, 35, 37, 106-112 with the plurality of different security layers 122-153 provides real-time services for copyright verification and collaboration services 203 including a copyright verification collaboration platform 204. The services 203 include cloud SaaS 64 services and non-cloud services 30, 30a.

The real-time services for copyright verification and collaboration services 203 including the copyright verification collaboration platform 204 integrates copyrighted content upload, identity verification, content documentation, and behavioral analytics into a unified architecture. The platform enables users to document original copyrighted content, record and retrieve authorship records on a blockchain 174, monitor content use and reuse, derivative works and enforce real-time identity verification using biometric inputs.

Some advantages of using the IVL application 30a/30 with the plurality of different security layers 122-148 for providing real-time services 198 for copyright verification and collaboration services 203 and include, but are not limited to those described in Table 12. However, the present invention is not limited to such an embodiment and the copyright verification and collaboration services 203 may include, more, fewer and/other services.

TABLE 12
The biometric identity enforcement service 206 includes a facial recognition system
130a configured to authenticate a user 39, 41 prior to granting access to features of the
copyright verification service 206. The biometric identity enforcement service 206
accesses a camera or image capture sensor connected to the copyright verification and
collaboration application 30 on the network device 12, 14, 16, 31, 33, 35, 37, 106-112
to record a live biometric facial scan. The biometric identity enforcement service 206
processes the biometric facial scan using an AI convolutional neural network to
generate an identity vector. The biometric identity enforcement service 206 compares
the generated identity vector to stored identity templates associated with previously
enrolled users 39, 41 and compute a similarity score. If the similarity score exceeds a
pre-defined verification threshold, the biometric identity enforcement service 206
passes an authentication token to IVL application 30a on the server network device and
log the result in a blockchain documentation service 214.
The content upload service interface service 210 includes a digital media input
interface component configured to collect and transmit user-generated content to other
services. The content upload service interface service 210 allow users 39, 41 to select
one or more original copyrighted digital media 101 files, enter descriptions, attach
metadata, and/or toggle documentation preferences. Once a user 39, 41 completes the
upload input flow, the content upload service interface service 210 transmits the
uploaded original copyrighted digital media 101 to the blockchain documentation
service 214 for authorship and/or co-authorship recording in a block chain 174 and to
the derivative content workflow service 216 for similarity detection. The content
upload service interface service 210 also interacts with the display interface service
222 on a GUI 34 to show upload confirmation, legal disclaimers, billing prompts
and/or other information.
The legal execution interface service 230 includes a document signing interface
configured to process agreements, contracts, or forms executed by the user 39, 41.
The legal execution interface service 230 presents a preview of a document, capture
optional input fields, and requires the user 39, 41 to perform a live facial scan as a
binding verification step. The legal execution interface service 230 uses the
biometric identity enforcement service 206 to validate the signer's 39, 41 identity and
may then pass the document to the biometric identity enforcement service 206 for
recording. The legal execution interface service 230 generates a certification report
including a hash, timestamp, facial scan metadata, and IP address, which may be
stored in the blockchain 174.
The blockchain documentation service 214 includes a blockchain 174 service
configured to record a unique biometric including a facial scan, finger print, etc.
and/or of user-submitted content on a blockchain ledger 181. The blockchain
documentation service 214 receives receive digital content from the content upload
service interface service 210 and processes the digital content using a hash function,
to generate a cryptographic hash and/or non-cryptographic hash. The blockchain
documentation service 214 combines the hash with metadata such as a user 39, 41
identifier, geolocation, timestamp, content title, content type, etc. The blockchain
documentation service 214 generates a transaction payload and submits the payload
to a blockchain 174 via a secure API connection. The blockchain documentation
service 214 monitors for confirmation of the transaction and store the blockchain
record identifier in blockchain 174.
The derivative content workflow service 216 includes a digital content analysis
service configured to detect whether newly uploaded copyrighted digital content is
identical or a derivative of existing blockchain-documented content. The derivative
content workflow service 216 receives new digital content submissions from the
content upload interface service 210 and extracts digital content features using
perceptual hashing, watermark detection, or audio/video fingerprinting techniques. The
derivative content workflow service 216 compares these signature features against a
reference set of hashes and content biometrics stored in the blockchain 174. If a
similarity threshold is exceeded, the derivative content workflow service 216 triggers a
portion of a GUI via the display interface service 222, allowing the uploaded original
copyrighted digital content 101 owner 39, 41′ to approve reuse or flag uploaded
original copyrighted digital content 101 for moderation.
° The behavioral analytics service 218 includes a real-time analytics processing
service configured to monitor and analyze authenticated user 39, 41 and viewer
39′, 41′ interaction patterns in the copyright document verification service 206. The
behavioral analytics service 218 logs metrics such as first-click platform icons,
hover durations, tap sequences, or feed navigation order. Authenticated users 39, 41
and viewer 39′, 41′ behaviors linked to the authenticated users 39, 41 from the
biometric identity enforcement service 208. The behavioral analytics service 218
processes this data using rule-based filters and/or clustering algorithms and/or AI
methods using Generative AI 57f, predictive AI 57g and/or RAG AI 57h to generate
behavior profiles, trend maps, and/or curiosity indexes. The behavioral analytics
service 218 outputs structured analytics records that are stored in the blockchain
174 and/or used to influence adaptive, dynamic GUI 34 interface rendering in the
display interface service 222.
The search engine interface service 220 includes a contextual retrieval interface
configured to allow authenticate users 39, 41 to find past copyrighted digital content
101, interactions, and/or identity-linked records. The search engine interface service
220 includes input fields for facial images, text keywords, named contacts,
geolocation information, event tags, locations, and/or temporal filters. The search
engine interface service 220 includes search parameters to search sites 20′, 22′, 24′,
26′ on the communications network and includes a backend indexer integrated with
the blockchain 174. The search engine interface service 220 also retrieves matching
records that include blockchain 174 documented content, profile interactions, legal
documents, and/or media tagged with specific identity parameters. Search engine
results from the communications network 18, 18′ are returned with relevance scores,
confidence levels, and supplemental context blocks.
The display interface service 222 includes a front-end rendering engine configured
to generate graphical user interfaces 34 for all user-facing functions of the copyright
document verification service 206. The display interface service 222 generates
uploaded copyrighted original digital media graphical content views, post
composition windows, signature panels, notification prompts, status indicators, and
dynamic interaction overlays. The display interface service 222 adapts layouts and
styling based on real-time context, including whether the privacy mode toggle
interface service 224 is active or whether a behavioral analytics event requires a
personalized tap message. The display interface service 222 communicates with all
other services 206-220 and 224 to receive display inputs and relay interface
interactions to the copyright document verification service 206.
The privacy mode toggle interface 224 includes a GUI 34 interface -level control
element configured to activate a browsing state that disables automatic engagement
actions. The privacy mode toggle interface 224 is rendered by the display interface
service 222 as a graphical switch, button, and/or icon and stores its activation state
in a session-level variable managed by the copyright document verification service
206. When the privacy mode toggle interface 224 is active, any interaction attempts
by an authorized user 39, 41 or a viewer 39′, 41′ such as a like, comment, follow, or
tag is intercepted by the display interface service 222. The display interface service
222 presents a confirmation prompt asking the authorized user 39, 41 to explicitly
authorize the engagement action before the action proceeds and is logged by the
behavioral analytics service 218 and/or the legal execution interface service 230. If
the authorized user 39, 41 does not confirm, the action is discarded without being
transmitted or logged by the behavioral analytics service 218 and/or the legal
execution interface service 230.

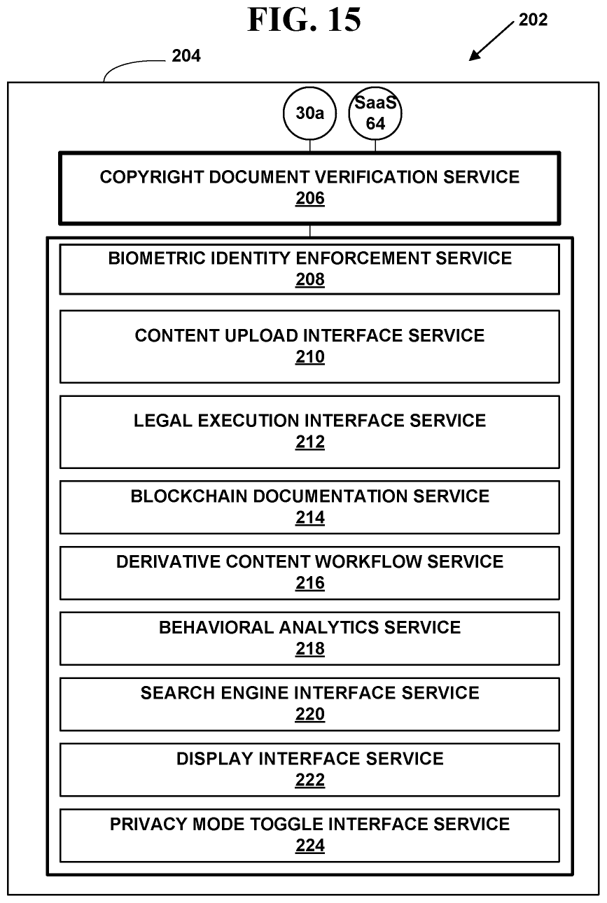

FIG. 15 is a block diagram 202 illustrating a copyright verification and collaboration platform 204.

In FIG. 15 the copyright verification and collaboration platform 204 includes, but is not limited to:
a copyright document verification service 206 provided by the copyright verification layer 149 of the IVL application 30a on the server network device 20, 22, 24, 26 configured for providing:
a biometric identity enforcement service 208 provided by the biometrics layer 130, the location tracking layer 132, and the Artificial Intelligence (AI) identity verification decision and scoring layer 131 of the IVL application 30a on the server network device 20, 22, 24, 26 configured for authenticating a single user 39, 41 as a creator of original copyrighted digital media 101 or two or more users 39, 41 as co-creators of original copyrighted digital media 101 through facial recognition 130a and/or other biometric identification and restricting access to a set of core features until the authentication is completed, the set of core features including digital media uploading, collaboration, or messaging;
a content upload interface service 210 provided by the secure data records layer 142 of the IVL application 30a on the server network device 20, 22, 24, 26 configured for receiving submissions of original copyrighted digital media 101 from the authenticated user 39, 41, content versioning for updating the original copyrighted digital media 101 as new versions in a digital version chain including original authors 39, 41 and co-authors, 39, 41 receiving copies of the of original copyrighted digital media 101 from other users 39′, 41′, receiving other submissions altered versions of the received original copyrighted digital media 101 from the other users 39′, 41′ as derivative works 101d via the communications network and storing on the IVL application 30a on the server network device 20, 22, 24, 26 the received submissions of the original copyrighted digital media 101 from the authenticated user 39, 41 and the received other submissions of altered versions of the received original copyrighted digital media from the other users 39′, 41′;
a legal execution interface service 212 provided by the AI identity verification decision and scoring layer 131, biometrics layer 130, blockchain layer 151, evidence chain of custody layer 146 and secure data records layer 142 on the IVL application 30a on the server network device 20, 22, 24, 26 configured for receiving a non-removable text 101t from the authenticated user on a digital document created from the received submissions of original copyrighted digital media 101, validating the non-removeable text 101t on the created digital document using real-time facial recognition 130a with the biometrics layer 130, storing the created digital document in a secure digital vault, and generating a blockchain 174 based audit trail for the signed created digital document via the blockchain layer 151;
a blockchain documentation service 214 provided by the blockchain layer 151 of the IVL application 30a on the server network device 20, 22, 24, 26 configured for generating a plaintext hash or a cryptographic hash of the received original copyrighted digital media 101 uploaded via the content upload interface 210, associating the plaintext hash or cryptographic hash with an unique identifier for the authenticated user 39, 41 and a timestamp, a network address (e.g., IP 46, MAC, SSID, etc.) and transmitting a transaction record comprising the plaintext hash or cryptographic hash, the unique identifier, the network address and the timestamp to a blockchain 174 ledger 181 prior to posting the uploaded original copyrighted digital media 101;
a derivative content workflow service 216 provided by the copyright verification layer 149 of the IVL application 30a on the server network device 20, 22, 24, 26 configured for analyzing the received submissions of original copyrighted digital media 101 from the authenticated user 39, 41, for analyzing the received other submissions of altered versions of the original copyrighted digital media 101 from other users 39′, 41′ detecting portions of the received other submissions of altered versions of the original copyrighted digital media 101 from the other users 39′, 41′ in the received submissions of the original copyrighted digital media 101 from the authenticated use 39, 41 or that matches or derives from the received submissions of original copyrighted digital media 101, and notifying the authenticated users 39, 41 with selectable options to either approve reuse of the matching content, reject reuse of the matching content or flag the matching content for moderation;
a behavioral analytics service 218 provided by the pattern recognition layer 138, the event recording layer 140 and the data analytics layer 144 of the IVL application 30a on the server network device 20, 22, 24, 26 configured for monitoring engagement interactions by third-party users 39′, 41′ with web-site content and social media content associated with a user 39, 41 on web-sites, social media platforms, recording data regarding an order and frequency of web-site content selection social media content selection and generating demographic-based trend information based on the recorded data;
a search engine interface service 220 provided by copyright verification layer 149 of the IVL application 30a on the server network device 20, 22, 24, 26 configured for receiving queries from the authenticated user 39, 41, the queries comprising one or more of: a facial image, a keyword, a name, a location, a check-in reference, or a time range, and to provide content results based on a match to a user 39, 41 identity and contextual relevance, sending queries to other sites 20′, 22′, 24′, 26′ on the communications network 18, 18′ to search for copies of the uploaded the original copyrighted digital media 101;
a display interface service 222 provided by copyright verification layer 149 of the IVL application 30a on the server network device 20, 22, 24, 26 configured for providing a graphical user interface (GUI) 34 to display the original copyrighted digital media 101, copies of the original copyrighted digital media 101 and derivative works 101d created from the original copyrighted digital media 101; and
a privacy mode toggle interface 224 service provided by the copyright verification layer 149 of the IVL application 30a on the server network device 20, 22, 24, 26 including an interface configured for enabling and disabling: automatic storage of the original copyrighted digital media 101, automatic execution of engagement actions including co-authorship and collaboration during browsing of the original copyrighted digital media 101 by the authenticated user 39, 41 and other users 39′, 41′ on the communications network 18, 18′ and requiring manual confirmation or automatic confirmation prior to completing any such engagement actions.

However, the present is not limited to such an embodiment and more, fewer and/or other services may be included in the copyright verification and collaboration services 203 and can be used to practice invention.

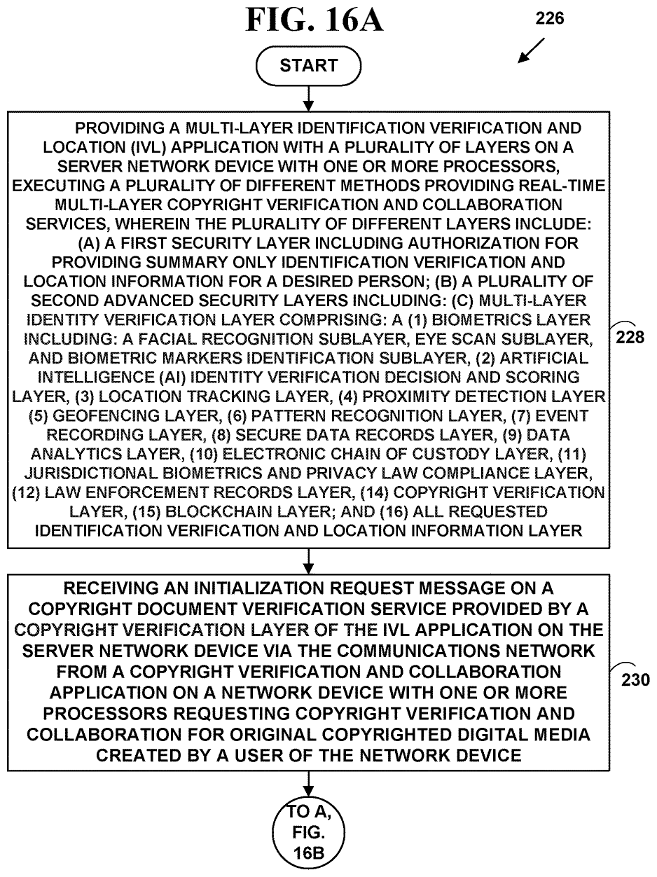

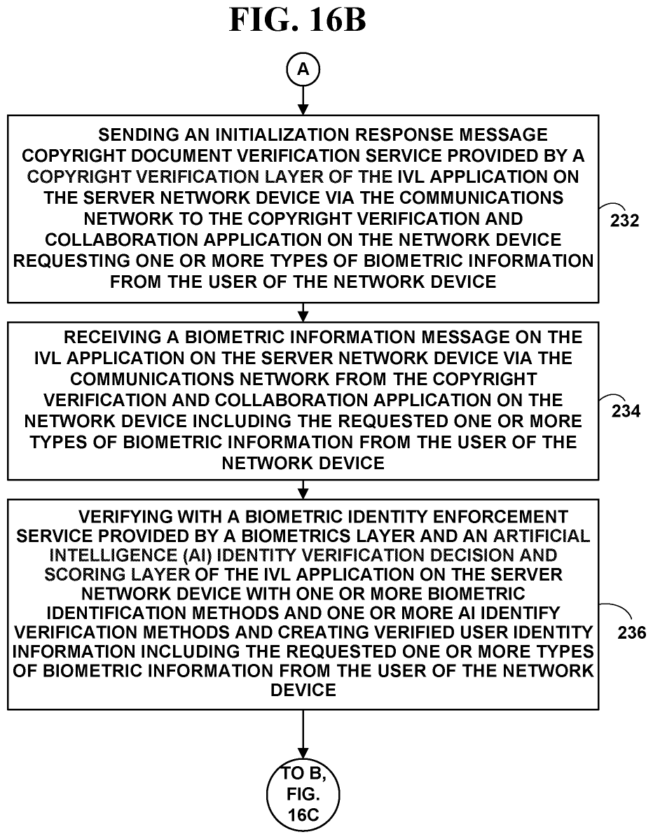

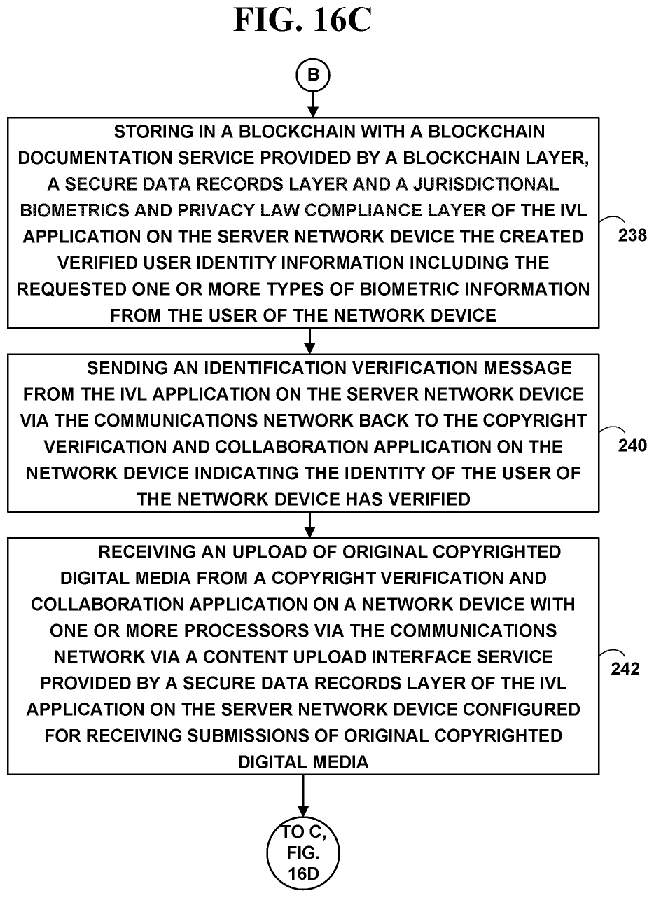

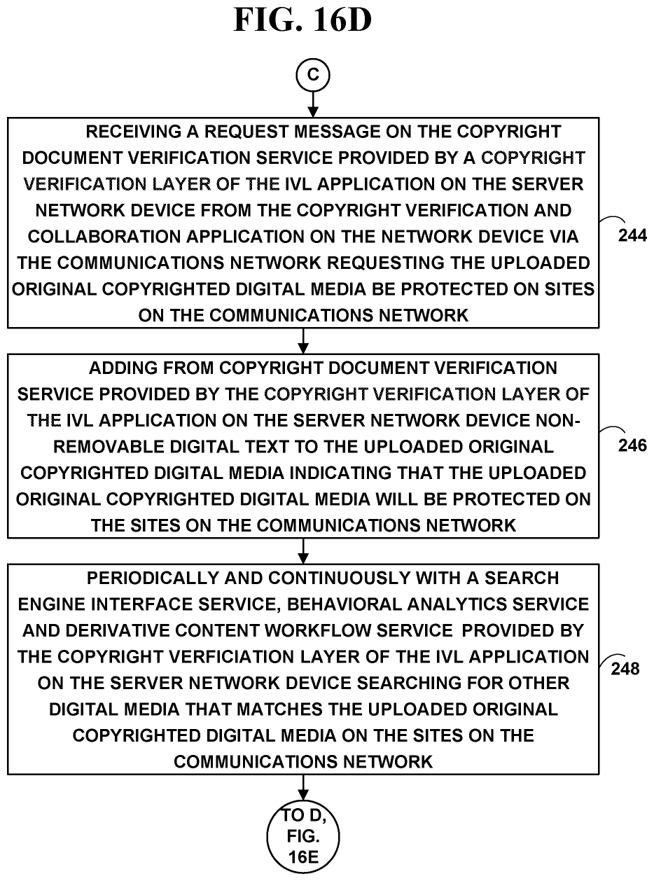

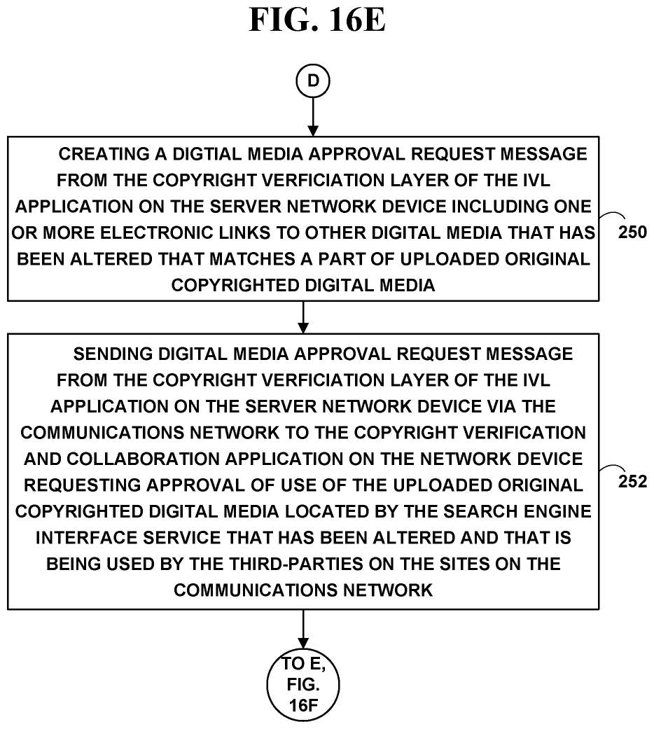

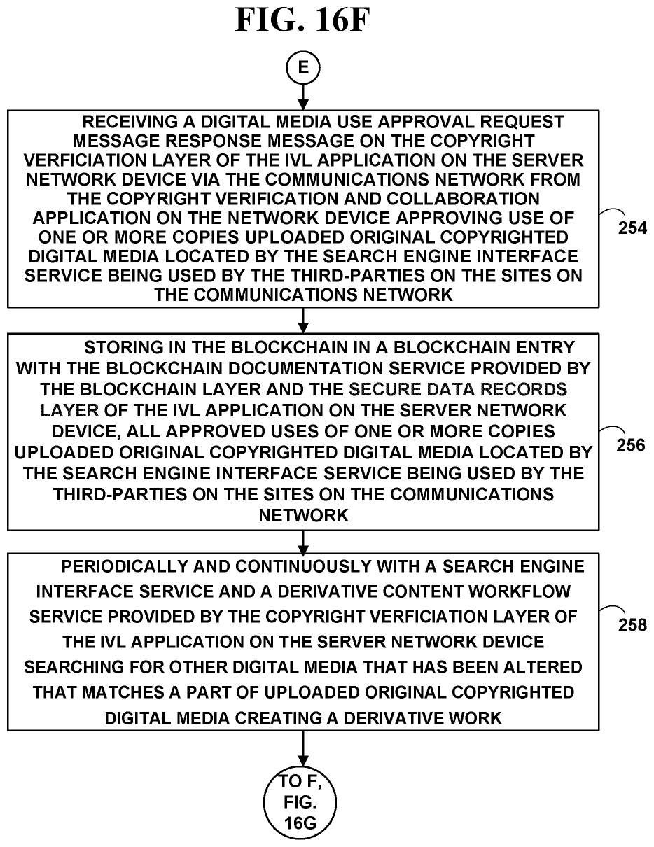

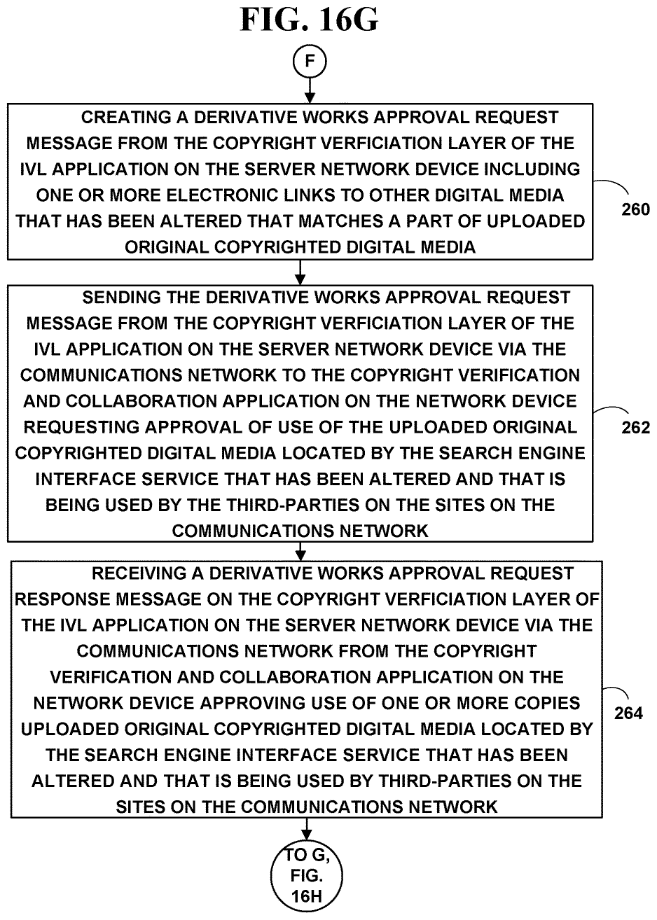

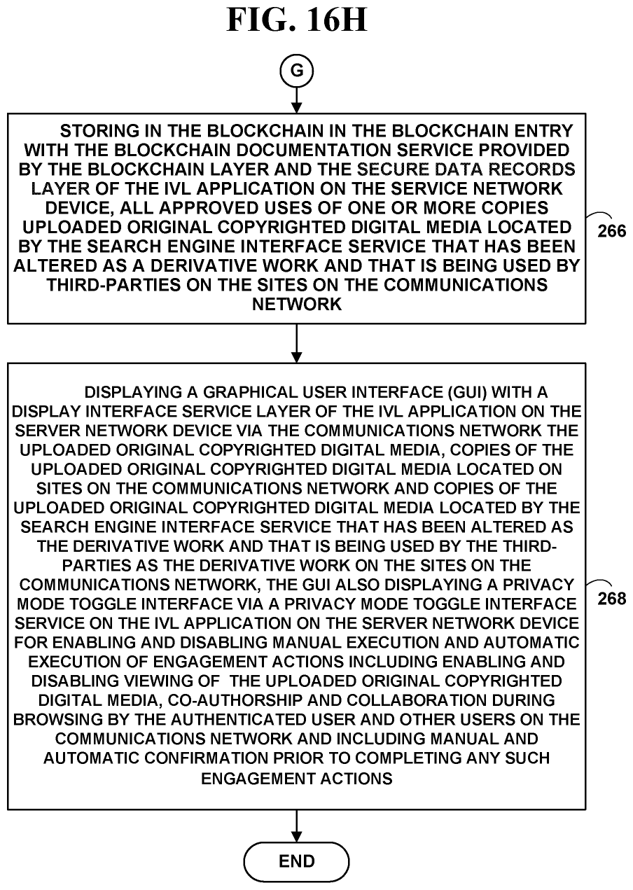

FIGS. 16A, 16B, 16C, 16D, 16E and 16F are a flow diagram including Method 226 for a providing copyright verification and collaboration platform.

In FIG. 16A, at Step 228, providing a multi-layer identification verification and location (IVL) application with a plurality of layers on a server network device with one or more processors, executing a plurality of different methods providing real-time multi-layer copyright verification and collaboration services, wherein the plurality of different layers include: (a) a first security layer including authorization for providing summary only identification verification and location information for a desired person; (b) a plurality of second advanced security layers including: (c) multi-layer identity verification layer comprising: a (1) biometrics layer including: a facial recognition sublayer, eye scan sublayer, and biometric markers identification sublayer, (2) Artificial Intelligence (AI) identity verification decision and scoring layer, (3) location tracking layer, (4) proximity detection layer (5) geofencing layer, (6) pattern recognition layer, (7) event recording layer, (8) secure data records layer, (9) data analytics layer, (10) electronic chain of custody layer, (11) jurisdictional biometrics and privacy law compliance layer, (12) law enforcement records layer, (14) copyright verification layer, (15) blockchain layer; and (16) all requested identification verification and location information layer; At Step 230, receiving an initialization request message on a copyright document verification service provided by a copyright verification layer of the IVL application on the server network device via the communications network from a copyright verification and collaboration application on a network device with one or more processors requesting copyright verification and collaboration for original copyrighted digital media created by a user of the network device; In FIG. 16B at Step 232, sending an initialization response message on the copyright document verification service provided by a copyright verification layer of the IVL application on the server network device via the communications network to the copyright verification and collaboration application on the network device requesting one or more types of biometric information from the user of the network device; At Step 234, receiving a biometric information message on the IVL application on the server network device via the communications network from the copyright verification and collaboration application on the network device including the requested one or more types of biometric information from the user of the network device; At Step 236, verifying with a biometric identity enforcement service provided by a biometrics layer and an Artificial Intelligence (AI) identity verification decision and scoring layer of the IVL application on the server network device with one or more biometric identification methods and one or more AI identify verification methods and creating verified user identity information including the requested one or more types of biometric information from the user of the network device; In FIG. 16C, at Step 238, storing in a blockchain with a blockchain documentation service provided by a blockchain layer, a secure data records layer and a jurisdictional biometrics and privacy law compliance layer of the IVL application on the server network device the created verified user identity information including the requested one or more types of biometric information from the user of the network device; At Step 240, sending an identification verification message from the IVL application on the server network device via the communications network back to the copyright verification and collaboration application on the network device indicating the identity of the user of the network device has verified; At Step 242, receiving an upload of original copyrighted digital media from a copyright verification and collaboration application on a network device with one or more processors via the communications network via a content upload interface service provided by a secure data records layer of the IVL application on the server network device configured for receiving submissions of original copyrighted digital media; In FIG. 16D at Step 244, receiving a request message on the copyright document verification service provided by a copyright verification layer of the IVL application on the server network device from the copyright verification and collaboration application on the network device via the communications network requesting the uploaded original copyrighted digital media be protected on sites on the communications network; At Step 246, adding from legal execution interface service provided by the copyright verification layer of the IVL application on the server network device non-removable digital text to the uploaded original copyrighted digital media indicating that the uploaded original copyrighted digital media will be protected on the sites on the communications network; At Step 248, periodically and continuously with a search engine interface service, a behavioral analytics service and a derivative content workflow service provided by the copyright verification layer of the IVL application on the server network device searching for other digital media that has been altered as a derivative work that matches a part of uploaded original copyrighted digital media; In FIG. 16E, at Step 250, creating a derivative works approval request message from the copyright verification layer of the IVL application on the server network device including one or more electronic links to other digital media that has been altered as the derivative work that matches a part of uploaded original copyrighted digital media; At Step 252, sending the derivative works approval request message from the copyright verification layer of the IVL application on the server network device via the communications network to the copyright verification and collaboration application on the network device requesting approval of use of the uploaded original copyrighted digital media located by the search engine interface service that has been altered as the derivative work and that is being used by the third-parties on the sites on the communications network; In FIG. 16F at Step 254, receiving a digital media use approval request message response message on the copyright verification layer of the IVL application on the server network device via the communications network from the copyright verification and collaboration application on the network device approving use of one or more copies uploaded original copyrighted digital media located by the search engine interface service being used by the third-parties on the sites on the communications network; At Step 256, storing in the blockchain in a blockchain entry with the blockchain documentation service provided by the blockchain layer and the secure data records layer of the IVL application on the server network device, all approved uses of one or more copies uploaded original copyrighted digital media located by the search engine interface service being used by the third-parties on the sites on the communications network; At Step 258, periodically and continuously with a search engine interface service and a derivative content workflow service provided by the copyright verification layer of the IVL application on the server network device searching for other digital media that has been altered as the derivative work that matches a part of uploaded original copyrighted digital media creating a derivative work; At Step 260, creating a derivative works approval request message from the copyright verification layer of the IVL application on the server network device including one or more electronic links to other digital media that has been altered to create the derivative work that matches a part of uploaded original copyrighted digital media; at Step 262, sending the derivative works approval request message from the copyright verification layer of the IVL application on the server network device via the communications network to the copyright verification and collaboration application on the network device requesting approval of use of the uploaded original copyrighted digital media located by the search engine interface service that has been altered as the derivative work and that is being used by the third-parties as the derivative work on the sites on the communications network; At Step 264, receiving a derivative works approval request response message on the copyright verification layer of the IVL application on the server network device via the communications network from the copyright verification and collaboration application on the network device approving use of one or more copies uploaded original copyrighted digital media located by the search engine interface service that has been altered as the derivative work and that is being used by third-parties on the sites on the communications network; At Step 266, storing in the blockchain in the blockchain entry with the blockchain documentation service provided by the blockchain layer and the secure data records layer of the IVL application on the server network device, all approved uses of one or more copies uploaded original copyrighted digital media located by the search engine interface service that has been altered as the derivative work and that is being used by third-parties on the sites on the communications network; and At Step 268, displaying a graphical user interface (GUI) with a display interface service layer of the IVL application on the server network device via the communications network the uploaded original copyrighted digital media, copies of the uploaded original copyrighted digital media located on sites on the communications network and copies of the uploaded original copyrighted digital media located by the search engine interface service that has been altered as the derivative work and that is being used by the third-parties as the derivative work on the sites on the communications network, the GUI also displaying a privacy mode toggle interface via a privacy mode toggle interface service on the IVL application on the server network device for enabling and disabling manual execution and automatic execution of engagement actions including enabling and disabling viewing of the uploaded original copyrighted digital media, co-authorship and collaboration during browsing by the authenticated user and other users on the communications network and including manual and automatic confirmation prior to completing any such engagement actions.

The present invention is illustrated with an exemplary embodiment. However, the present invention is not limited to such an embodiment and other embodiments can be used to practice the invention.

In such an exemplary embodiment in FIG. 16A, at Step 228, providing a multi-layer identification verification and location (IVL) application 30 with a plurality of layers 122-153 on a server network device 20, 22, 24, 26 with one or more processors, executing a plurality of different methods providing real-time multi-layer copyright verification and collaboration services 203, wherein the plurality of different layers 122-153 include: (a) a first security layer 124 including authorization for providing summary only identification verification and location information for a desired person 14; (b) a plurality of second advanced security layers including 12: (c) a multi-layer identity verification layer 126 comprising: a (1) biometrics layer 130 including: a facial recognition sublayer 130a, eye scan sublayer 130b, and biometric markers 130c identification sublayer, (2) Artificial Intelligence (AI) identity verification decision and scoring layer 131, (3) location tracking layer 132, (4) proximity detection layer 134 (5) geofencing layer 136, (6) pattern recognition layer 138, (7) event recording layer 140, (8) secure data records layer 142, (9) data analytics layer 144, (10) electronic chain of custody layer 146, (11) jurisdictional biometrics and privacy law compliance layer 147, (12) law enforcement records layer 148, (14) copyright verification layer 149, (15) blockchain layer 151; and (16) all requested identification verification and location information layer 153.

At Step 230, receiving an initialization request message 13creq on a copyright document verification service 206 provided by a copyright verification layer 149 of the IVL application 30a on the server network device 20, 22, 24, 26 via the communications network 18, 18′ from a copyright verification and collaboration application 30 on a network device 12, 14, 16, 31, 33, 35, 37, 106-112 with one or more processors requesting copyright verification and collaboration for original copyrighted digital media 101 created by a user 39 of the network device 12, 14, 16, 31, 33, 35, 37, 106-112.

In FIG. 16B at Step 232, sending an initialization response message 13cres, on the copyright document verification service 206 provided by the copyright verification layer 149 of the IVL application 30a on the server network device 20, 22, 24, 26 via the communications network 18, 18′ to the copyright verification and collaboration application 30 on the network device 12, 14, 16, 31, 33, 35, 37, 106-112 requesting one or more types of biometric information 103 from the user 39 of the network device 12, 14, 16, 31, 33, 35, 37, 106-112.

At Step 234, receiving a biometric information message 13b on the IVL application 30a on the server network device 20, 22, 24, 26 via the communications network 18, 18′ from the copyright verification and collaboration application 30 on the network device 12, 14, 16, 31, 33, 35, 37, 106-112 including the requested one or more types of biometric information 103 from the user 39 of the network device 12, 14, 16, 31, 33, 35, 37, 106-112.

At Step 236, verifying with a biometric identity enforcement service provided by a biometrics layer 130 and an Artificial Intelligence (AI) identity verification decision and scoring layer 131 of the IVL application 30a on the server network device 20, 22, 24, 26 with one or more biometric identification methods and one or more AI identify verification methods and creating verified user identity information 126, 153 including the requested one or more types of biometric information 103 from the user 39 of the network device 12, 14, 16, 31, 33, 35, 37, 106-112.

In FIG. 16C, at Step 238, storing in a blockchain 174 with a blockchain documentation service provided by a blockchain layer 151, a secure data records layer 142 and a jurisdictional biometrics and privacy law compliance layer 147 of the IVL application 30a on the server network device 20, 22, 24, 26 the created verified user identity information 126, 153 including the requested one or more types of biometric information 103 from the user 39 of the network device 12, 14, 16, 31, 33, 35, 37, 106-112.

At Step 240, sending an identification verification message 13a from the IVL application 30a on the server network device 20, 22, 24, 26 via the communications network 18, 18′ back to the copyright verification and collaboration application 30 on the network device 12, 14, 16, 31, 33, 35, 37, 106-112 indicating the identity of the user 39 of the network device 12, 14, 16, 31, 33, 35, 37, 106-112 has verified.

At Step 242, receiving an upload of the original copyrighted digital media 101 from a copyright verification and collaboration application 30 on a network device 12, 14, 16, 31, 33, 35, 37, 106-112 with one or more processors via the communications network 18, 18′ via a content upload interface service provided by a secure data records layer 142 of the IVL application 30a on the server network device 20, 22, 24, 26 configured for receiving submissions of uploaded original copyrighted digital media 101.

In one embodiment, the uploaded original copyrighted digital media 101 includes, but is not limited to, digital image files, video files, voice files or electronic text files and/or other types of original copyright digital media 101.

In FIG. 16D at Step 244, receiving a request message 13a on the copyright document verification services 203 provided by a copyright verification layer 149 of the IVL application 30a on the server network device 20, 22, 24, 26 from the copyright verification and collaboration application 30 on the network device 12, 14, 16, 31, 33, 35, 37, 106-112 via the communications network 18, 18′ requesting the uploaded original copyrighted digital media 101 be protected on sites 20′, 24, 26′, 28′ on the communications network 18, 18′.

At Step 246, adding from the legal execution interface service 212 provided by the copyright verification layer 149 of the IVL application 30a on the server network device 20, 22, 24, 26 non-removable digital text 101t to the uploaded original copyrighted digital media 101, 101t indicating that the uploaded original copyrighted digital media 101, 101t will be protected on the sites 20′, 24, 26′, 28′ (e.g., web-sites including HTML, XML, etc. pages, social media web-sites, etc.) on the communications network 18, 18′.

In one embodiment, the non-removeable text 101t includes, electronic text, digital signature, hash code, message digest code, encrypted electronic text and/or other types of non-removeable text 101t. However, the present invention is not limited to such an embodiment and other embodiments may be used to practice the invention.

At Step 248, periodically and continuously with a search engine interface service 202, behavioral analytics service 218 and a derivative content workflow service 216 provided by the copyright verification layer 149 of the IVL application 30a on the server network device 20, 22, 24, 26 searching for other digital media that has been altered as a derivative work 101d that matches a part of uploaded original copyrighted digital media 101, 101t.

In one embodiment, the derivative work 101d includes an altered version of the uploaded original copyrighted digital media 101 including altered versions of, digital image files, video files, voice files or electronic text files including the uploaded original copyrighted digital media 101. However, the present invention is not limited to such an embodiment and other embodiments may be used to practice the invention.

In FIG. 16E, at Step 250, creating derivative works approval request message 13a from the copyright verification layer 149 of the IVL application 30a on the server network device 20, 22, 24, 26 including one or more electronic links to other digital media that has been altered as the derivative work 101d that matches a part of uploaded original copyrighted digital media 101, 101t.

At Step 252, sending the derivative works approval request message 13a from the copyright verification layer 149 of the IVL application 30a on the server network device 20, 22, 24, 26 via the communications network 18, 18′ to the copyright verification and collaboration application 30 on the network device 12, 14, 16, 31, 33, 35, 37, 106-112 requesting approval of use of the uploaded original copyrighted digital media 101, 101t located by the search engine interface service that has been altered as the derivative work 101d and that is being used by the third-parties on the sites 20′, 24, 26′, 28′ on the communications network 18, 18′.

In FIG. 16F, at Step 254, receiving a derivative works approval request response message 13b on the copyright verification layer 149 of the IVL application 30a on the server network device 20, 22, 26 via the communications network 18, 18′ from the copyright verification and collaboration application 30 on the network device 12, 14, 16, 31, 33, 35, 37, 106-112 approving use of one or more copies uploaded original copyrighted digital media 101, 101t located by the search engine interface service that has been altered as the derivative work 101d and that is being used by third-parties on the sites 20′, 24, 26′, 28′ on the communications network 18, 18′.

At Step 256, storing in the blockchain 174 in a blockchain entry 176-180 with the blockchain documentation service 214 provided by the blockchain layer 151 and the secure data records layer 142 of the IVL application 30a on the server network device 20, 22, 24, 26, all approved uses of one or more copies uploaded original copyrighted digital media 101 located by the search engine interface service 220 being used by the third-parties 39′, 41′ on the sites 20′, 24, 26′, 28′ on the communications network 18, 18′.

At Step 258, periodically and continuously with a search engine interface service 220 and a derivative content workflow service 216 provided by the copyright verification layer 149 of the IVL application 30a on the server network device 20, 22, 24, 26 searching for other digital media that has been altered as the derivative work 101d that matches a part of uploaded original copyrighted digital media 101 creating a derivative work 101d.

At Step 260, creating a derivative works approval request message 13a from the copyright verification layer 149 of the IVL application 30a on the server network device 20, 22, 24, 26 including one or more electronic links to other digital media that has been altered to create the derivative work 101d that matches a part of uploaded original copyrighted digital media 101.

At Step 262, sending the derivative works approval request message 13a from the copyright verification layer 149 of the IVL application 30a on the server network device 20, 22, 24, 26 via the communications network 18, 18′ to the copyright verification and collaboration application 30 on the network device 12, 14, 16, 31, 33, 35, 37, 106-112 requesting approval of use of the uploaded original copyrighted digital media 101 located by the search engine interface service 220 that has been altered as the derivative work 101d and that is being used by the third-parties 39′, 41′ as the derivative work 101d on the sites 20′, 24, 26′, 28′ on the communications network 18, 18′.

At Step 264, receiving a derivative works approval request response message 13b on the copyright verification layer 149 of the IVL application 30a on the server network device 20, 22, 24, 26 via the communications network 18, 18′ from the copyright verification and collaboration application 30 on the network device 12, 14, 16, 31, 33, 35, 37, 106-112 approving use of one or more copies uploaded original copyrighted digital media 101 located by the search engine interface service 220 that has been altered as the derivative work 101d and that is being used by third-parties 39, 41′ on the sites 20′, 22′, 24′, 26′ (e.g. web-sites, social media, etc.) on the communications network 18, 18′.

In FIG. 16H at Step 266, storing in the blockchain 174 in the blockchain entry 176-180 with the blockchain documentation service provided by the blockchain layer 151 and the secure data records layer 142 of the IVL application 30a on the server network device 20, 24, 26, 28, all approved uses of one or more copies uploaded original copyrighted digital media 101 located by the search engine interface service 220 that has been altered as a derivative work 101d and that is being used by third-parties 39′,41′ on the sites 20′, 22′, 24′, 26′ (e.g. web-sites, social media, etc.) on the communications network 18, 18′.

At Step 268, displaying a graphical user interface (GUI) 34 with a display interface service layer 222 of the IVL application 30a on the server network device 20, 22, 24, 26 via the communications network 18, 18′ the uploaded original copyrighted digital media 101, copies of the uploaded original copyrighted digital media 101 located on sites on the communications network 18, 18′ and copies of the uploaded original copyrighted digital media 101 located by the search engine interface service 220 that has been altered as the derivative work 101d and that is being used by the third-parties 39′, 41′ as the derivative work 101d on the sites 20′, 22′, 24′, 26′ on the communications network 18, 18′, the GUI 34 also displaying a privacy mode toggle interface 229 (FIG. 2) via a privacy mode toggle interface service 224 on the IVL application 30a on the server network device 20, 22, 24, 26 for enabling and disabling manual execution and automatic execution of engagement actions including enabling and disabling viewing of the uploaded original copyrighted digital media 101, co-authorship and collaboration during browsing by the authenticated user and other users on the communications network and including manual and automatic confirmation prior to completing any such engagement actions.

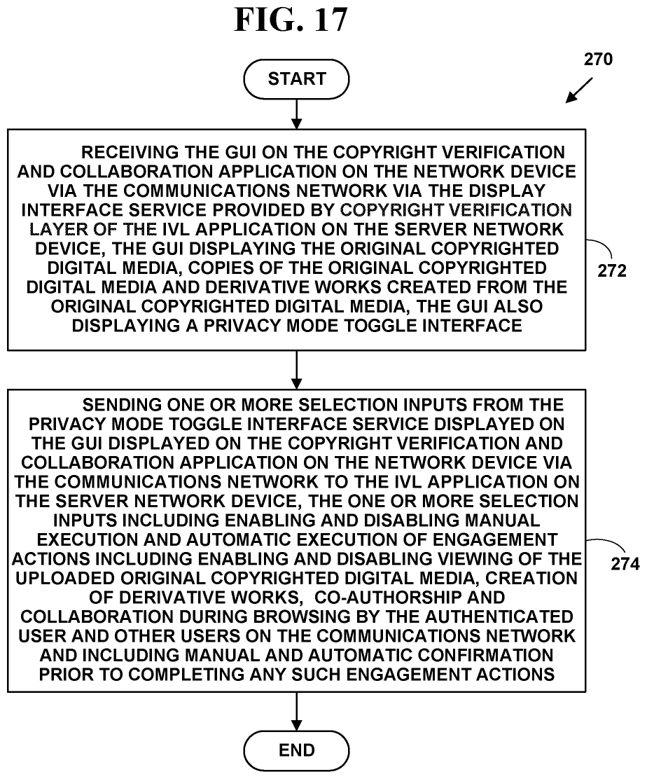

FIG. 17 is a flow diagram including a Method 270 for providing copyright verification and collaboration.

In FIG. 17 at Step 272, receiving the GUI on the copyright verification and collaboration application on the network device via the communications network via the display interface service provided by copyright verification layer of the IVL application on the server network device, the GUI displaying the original copyrighted digital media, copies of the original copyrighted digital media and derivative works created from the original copyrighted digital media, the GUI also displaying a privacy mode toggle interface; and At Step 274, sending one or more selection inputs from the privacy mode toggle interface service displayed on the GUI displayed on the copyright verification and collaboration application on the network device via the communications network to the IVL application on the server network device, the one or more selection inputs including enabling and disabling manual execution and automatic execution of engagement actions including enabling and disabling viewing of the uploaded original copyrighted digital media, creation of derivative works, co-authorship and collaboration during browsing by the authenticated user and other users on the communications network and including manual and automatic confirmation prior to completing any such engagement actions.

The present invention is illustrated with an exemplary embodiment. However, the present invention is not limited to such an embodiment and other embodiments can be used to practice the invention.

In such an exemplary embodiment in FIG. 17, at Step 272, receiving the GUI 34 on the copyright verification and collaboration application 30 on the network device 12, 14, 16, 31, 33, 35, 37, 106-112 via the communications network 18, 18′ via the display interface service layer 222 provided by copyright verification layer 149 of the IVL application 30a on the server network device 20, 22, 24, 26, the GUI 34 displaying the original copyrighted digital media 101, copies of the original copyrighted digital media 101 and derivative works 101d created from the original copyrighted digital media 101, the GUI 34 also displaying a privacy mode toggle interface 229.

At Step 274, sending one or more selection inputs from the privacy mode toggle interface 229 displayed on the GUI 34 displayed on the copyright verification and collaboration application 30 on the network device 12, 14, 16, 31, 33, 35, 37, 106-112 via the communications network 18, 18′ to the IVL application 30a on the server network device 20 22, 24, 26, the one or more selection inputs including enabling and disabling manual execution and automatic execution of engagement actions including enabling and disabling viewing of the uploaded original copyrighted digital media 101, creation of derivative works 101d, co-authorship and collaboration during browsing by the authenticated user 39, 41 and other users 39′, 41′ on the communications network 18, 18′ and including manual and automatic confirmation prior to completing any such engagement actions.

A multi-layer modular digital content platform that integrates copyrighted content upload, identity verification, content documentation, and behavioral analytics into a unified architecture. The platform enables users to upload and document original copyrighted content, record and receive authorship records on a blockchain, monitor in real-time content use, reuse and creation of derivative works and enforce real-time identity verification of authors and users of the original copyrighted content using biometric inputs.

It should be understood that the architecture, programs, processes, methods and systems described herein are not related or limited to any particular type of computer or network system (hardware and/or software and/or firmware, etc.), unless indicated otherwise. Various types of computer systems may be used with or perform operations in accordance with the teachings described herein.

In view of the wide variety of embodiments to which the principles of the present invention can be applied, it should be understood that the illustrated embodiments are exemplary only, and should not be taken as limiting the scope of the present invention. For example, the steps of the flow diagrams may be taken in sequences other than those described, and more or fewer elements may be used in the block diagrams.

While various elements of the preferred embodiments have been described as being implemented in software, in other embodiments hardware and/or firmware implementations may alternatively be used, and vice-versa.

The claims should not be read as limited to the described order or elements unless stated to that effect. In addition, use of the term “means” in any claim is intended to invoke 35 U.S.C. § 112, paragraph 6, and any claim without the word “means” is not so intended.

Therefore, all embodiments that come within the scope and spirit of the following claims and equivalents thereto are claimed as the invention.

I claim:

1. A real-time multi-layer copyright verification and collaboration system, comprising in combination:
a multi-layer identification verification and location (IVL) application with a plurality of layers on a server network device with one or more processors, executing a plurality of different methods, wherein the plurality of different layers include:
(a) a first security layer including authorization for providing summary only identification verification and location information for a desired person; (b) a plurality of second advanced security layers including: (c) multi-layer identity verification layer comprising a: (1) biometrics layer including: a facial recognition sublayer, eye scan sublayer, and biometric markers identification sublayer, (2) Artificial Intelligence (AI) identity verification decision and scoring layer, (3) location tracking layer, (4) proximity detection layer (5) geofencing layer, (6) pattern recognition layer, (7) event recording layer, (8) secure data records layer, (9) data analytics layer, (10) electronic chain of custody layer, (11) jurisdictional biometrics and privacy law compliance layer, (12) law enforcement records layer, (14) copyright verification layer, (15) blockchain layer; and (16) all requested identification verification and location information layer;
a communications network;
a real-time multi-layer copyright verification and collaboration operational platform on the multi-layer IVL application on the server network device and connected to the communications network providing real-time multi-layer copyright verification and collaboration services;
a plurality of network devices, each with one or more processors, connected to the communications network for accessing the IVL application on the server network device providing the real-time multi-layer copyright verification and collaboration services;
the real-time multi-layer copyright verification and collaboration operational platform providing the real-time multi-layer copyright verification and collaboration services comprising:
a copyright document verification service provided by the copyright verification layer of the IVL application on the server network device configured for providing:
a biometric identity enforcement service provided by the biometrics layer, the location tracking layer, and the Artificial Intelligence (AI) identity verification decision and scoring layer of the IVL application on the server network device configured for authenticating a single user as a creator of original copyrighted digital media or two or more users as co-creators of original copyrighted digital media through facial recognition or other biometric identification and restricting access to a set of core features until the authentication is completed, the set of core features including digital media uploading, collaboration, or messaging;
a content upload interface service provided by the secure data records layer of the IVL application on the server network device configured for receiving submissions of original copyrighted digital media from the authenticated user, content versioning for updating the original copyrighted digital media as new versions in a digital version chain including original authors and co-authors, receiving copies of the of original copyrighted digital media from other users, receiving other submissions altered versions of the received original copyrighted digital media from the other users as derivative works via the communications network and storing on the IVL application on the server network device the received submissions of the original copyrighted digital media from the authenticated user and the received other submissions of altered versions of the received original copyrighted digital media from the other users;
a legal execution interface service provided by the AI identity verification decision and scoring layer, biometrics layer, blockchain layer, evidence chain of custody layer and secure data records layer on the IVL application on the server network device configured for receiving non-removable text from the authenticated user on a digital document created from the received submissions of original copyrighted digital media, validating non-removable text on the created digital document using real-time facial recognition with the biometrics layers, storing the created digital document in a secure digital vault, and generating a blockchain-based audit trail for the signed created digital document via the blockchain layer;
a blockchain documentation service provided by the blockchain layer of the IVL application on the server network device configured for generating a plaintext hash or a cryptographic hash of the received original copyrighted digital media uploaded via the content upload interface, associating the plaintext hash or the cryptographic hash with an unique identifier for the authenticated user and a timestamp, a network address and transmitting a transaction record comprising the plaintext hash or the cryptographic hash, the unique identifier, the network address and the timestamp to a blockchain ledger prior to posting the uploaded original copyrighted digital media;
a derivative content workflow service provided by the copyright verification layer of the IVL application on the server network device configured for analyzing the received submissions of original copyrighted digital media from the authenticated user, for analyzing the received other submissions of altered versions of the original copyrighted digital media from other users, detecting portions of the received other submissions of altered versions of the original copyrighted digital media from other users in the received submissions of the original copyrighted digital media from the authenticated user that matches or derives from the received submissions of original copyrighted digital media, and notifying the authenticated user with selectable options to either approve reuse of the matching content, reject reuse of the matching content or flag the matching content for moderation;
a behavioral analytics service provided by the pattern recognition layer, the event recording layer and the data analytics layer of the IVL application on the server network device configured for monitoring engagement interactions by third-party users with web-site content and social media content associated with users of web-sites and social media platforms, recording data regarding an order and frequency of web-site content and social media content selection, and generating demographic-based trend information based on the recorded data;
a search engine interface service provided by copyright verification layer of the IVL application on the server network device configured for receiving queries from the authenticated user, the queries comprising one or more of: a facial image, a keyword, a name, a location, a check-in reference, or a time range, and to provide content results based on a match to a user identity and contextual relevance, sending queries to other sites on the communications network to search for copies of the uploaded the original copyrighted digital media
a display interface service provided by copyright verification layer of the IVL application on the server network device configured for providing a graphical user interface (GUI) to display the original copyrighted digital media, copies of the original copyrighted digital media and derivative works created from the original copyrighted digital media; and
a privacy mode toggle interface service provided by the copyright verification layer of the IVL application on the server network device including an interface configured for enabling and disabling: automatic storage of the original copyrighted digital media, automatic execution of engagement actions during browsing of the original copyrighted digital media by the authenticated user and other users on the communications network and requiring manual confirmation or automatic confirmation prior to completing any such engagement actions.

2. A method for real-time multi-layer copyright verification and collaboration, comprising:
providing a multi-layer identification verification and location (IVL) application with a plurality of layers on a server network device with one or more processors, executing a plurality of different methods providing real-time multi-layer copyright verification and collaboration services, wherein the plurality of different layers include:
(a) a first security layer including authorization for providing summary only identification verification and location information for a desired person; (b) a plurality of second advanced security layers including: (c) multi-layer identity verification layer comprising: a (1) biometrics layer including: a facial recognition sublayer, eye scan sublayer, and biometric markers identification sublayer, (2) Artificial Intelligence (AI) identity verification decision and scoring layer, (3) location tracking layer, (4) proximity detection layer (5) geofencing layer, (6) pattern recognition layer, (7) event recording layer, (8) secure data records layer, (9) data analytics layer, (10) electronic chain of custody layer, (11) jurisdictional biometrics and privacy law compliance layer, (12) law enforcement records layer, (14) copyright verification layer, (15) blockchain layer; and (16) all requested identification verification and location information layer;
receiving an initialization request message on a copyright document verification service provided by a copyright verification layer of the IVL application on the server network device via the communications network from a copyright verification and collaboration application on a network device with one or more processors requesting copyright verification and collaboration for original copyrighted digital media created by a user of the network device;
sending an initialization response message copyright document verification service provided by a copyright verification layer of the IVL application on the server network device via the communications network to the copyright verification and collaboration application on the network device requesting one or more types of biometric information from the user of the network device;
receiving a biometric verification message on the IVL application on the server network device via the communications network from the copyright verification and collaboration application on the network device including the requested one or more types of biometric information from the user of the network device;
verifying with a biometric identity enforcement service provided by a biometrics layer, an Artificial Intelligence (AI) identity verification decision and scoring layer and location tracking layer of the IVL application on the server network device with one or more biometric identification methods and one or more AI identify verification methods and creating verified user identity information including the requested one or more types of biometric information from the user of the network device;
storing in a blockchain with a blockchain documentation service provided by a blockchain layer, a secure data records layer and a jurisdictional biometrics and privacy law compliance layer of the IVL application on the server network device the created verified user identity information including the requested one or more types of biometric information from the user of the network device;
sending an identification verification response message from the IVL application on the server network device via the communications network back to the copyright verification and collaboration application on the network device indicating the identity of the user of the network device has verified;
receiving an upload of original copyrighted digital media from a copyright verification and collaboration application on a network device with one or more processors via the communications network via a content upload interface service provided by a secure data records layer of the IVL application on the server network device configured for receiving submissions of original copyrighted digital media;
receiving a request message on the copyright document verification service provided by a copyright verification layer of the IVL application on the server network device from the copyright verification and collaboration application on the network device via the communications network requesting the uploaded original copyrighted digital media be protected on sites on the communications network;
adding from copyright document verification service provided by the copyright verification layer of the IVL application on the server network device non-removable digital text to the uploaded original copyrighted digital media indicating that the uploaded original copyrighted digital media will be protected on the sites on the communications network;
periodically and continuously with a search engine interface service, a behavioral analytics service and a derivative content workflow service provided by the copyrights layer of the IVL application on the server network device searching for other digital media that matches the uploaded original copyrighted digital media on the sites on the communications network;
creating a digital media use approval request message from the copyright verification layer of the IVL application on the server network device including one or more electronic links to other digital media located by the search engine interface service that matches the uploaded original copyrighted digital media on the sites on the communications network;
sending the digital media use approval request message from the copyright verification layer of the IVL application on the server network device via the communications network to the copyright verification and collaboration application on the network device requesting approval of use of the uploaded original copyrighted digital media located by the search engine interface service being used by third-parties on the sites on the communications network;
receiving a digital media use approval request message response message on the copyright verification layer of the IVL application on the server network device via the communications network from the copyright verification and collaboration application on the network device approving use of one or more copies uploaded original copyrighted digital media located by the search engine interface service being used by the third-parties on the sites on the communications network;
storing in the blockchain in a blockchain entry with the blockchain documentation service provided by the blockchain layer and the secure data records layer of the IVL application on the server network device, all approved uses of one or more copies uploaded original copyrighted digital media located by the search engine interface service being used by the third-parties on the sites on the communications network;
periodically and continuously with a search engine interface service and a derivative content workflow service provided by the copyright verification layer of the IVL application on the server network device searching for other digital media that has been altered as the derivative work that matches a part of uploaded original copyrighted digital media creating the derivative work;
creating a derivative works approval request message from the copyright verification layer of the IVL application on the server network device including one or more electronic links to other digital media that has been altered to create the derivative work that matches a part of uploaded original copyrighted digital media;
sending the derivative works approval request message from the copyright verification layer of the IVL application on the server network device via the communications network to the copyright verification and collaboration application on the network device requesting approval of use of the uploaded original copyrighted digital media located by the search engine interface service that has been altered as the derivative work and that is being used by the third-parties as the derivative work on the sites on the communications network;
receiving a derivative works approval request response message on the copyright verification layer of the IVL application on the server network device via the communications network from the copyright verification and collaboration application on the network device approving use of one or more copies uploaded original copyrighted digital media located by the search engine interface service that has been altered as the derivative work and that is being used by third-parties on the sites on the communications network;
storing in the blockchain in the blockchain entry with the blockchain documentation service provided by the blockchain layer and the secure data records layer of the IVL application on the server network device, all approved uses of one or more copies uploaded original copyrighted digital media located by the search engine interface service that has been altered as the derivative work and that is being used by third-parties on the sites on the communications network; and
displaying a graphical user interface (GUI) with a display interface service layer of the IVL application on the server network device via the communications network the uploaded original copyrighted digital media, copies of the uploaded original copyrighted digital media located on sites on the communications network and copies of the uploaded original copyrighted digital media located by the search engine interface service that has been altered as the derivative work and that is being used by the third-parties as the derivative work on the sites on the communications network,
the GUI also displaying a privacy mode toggle interface via a privacy mode toggle interface service on the IVL application on the server network device for enabling and disabling manual execution and automatic execution of engagement actions including enabling and disabling viewing of the uploaded original copyrighted digital media, co-authorship and collaboration during browsing by the authenticated user and other users on the communications network and including manual and automatic confirmation prior to completing any such engagement actions.

3. The method of claim 2, wherein the security layer authorization information in the facial recognition verification request message includes: (1) the first security layer authorization which triggers a first security layer on the IVL application on the server network device including authorization for returning only summary facial recognition verification information including whether the request to verify the identity of the selected person was successful or not was not successful based on a first security layer authorization included in the facial recognition verification request message, and (2) the second security layer authorization which triggers second security multi-layers on the IVL application on the server network device for returning all available verification identification and location information available for the desired person when the request to verify the identity of the desired person with facial recognition was successful.

4. The Method of claim 2 wherein, the all available verification, identification and location information available for the desired person includes one or more of: a name, address, current geographic physical location, current Global Positioning System (GPS) location information, phone number, driver license number, vehicle information and license plate information, email identifiers, social media identifiers, tattoos, finger prints, DeoxyriboNucleic Acid (DNA) information, eye color, hear color, gait, voice, height, weight, digital photographs or law enforcement information, for the desired person.

5. The method of claim 2 wherein, the network device and the server network device include one or more wireless communications interfaces comprising one or more of: a cellular telephone, 802.11a, 802.11b, 802.11g, 802.11n, 802.11ac, 802.11ax, 802.11be, 802.15.4 (ZigBee), Wireless Fidelity (Wi-Fi), Wi-Fi Aware, Worldwide Interoperability for Microwave Access (WiMAX), ETSI High Performance Radio Metropolitan Area Network (HIPERMAN), Near Field Communications (NFC), Machine-to-Machine (M2M), 802.15.1 (BLUETOOTH®), RFID, or infra data association (IrDA), wireless communication interfaces.

6. The method of claim 2 wherein, the network device includes: server network devices, desktop and laptop computers, tablet computers, mobile phones, non-mobile phones with displays, smart phones, Internet phones, Internet appliances, personal digital/data assistants (PDA), portable, handheld and desktop video game devices, cable television (CATV), satellite television (SATV) and Internet television set-top boxes, digital televisions including high definition television (HDTV), three-dimensional (3DTV) televisions, smart speakers, Internet of Things (IoT) devices, Radio Frequency Identifier (RFID) devices, wearable network devices, Point of Sale (POS) network devices, or air, water or land vehicles, each with one or more processors, with wireless or wired network interfaces, connectable to the communications network.

7. The method of claim 2 wherein, the all message communications between the IVL application on the server network device and the copyright verification and collaboration application on network device via the communications network includes one or more of: an email message, voice message, video message, RCS message, Short Message Service (SMS) message, Direct Message (DM), Instant Message (IM), Multimedia Messaging Service (MMS) message, GOOGLE Business Message, APPLE iMessage, instant message, direct message, Short Message Peer-to-Peer (SMPP) message, social media message, REpresentational State Transfer (REST) message, data link protocol message, network protocol message, Simple Object Access Protocol (SOAP) message, or Lightweight Directory Access Protocol (LDAP) message.

8. The method of claim 2 wherein, all message communications between the IVL application on the server network device and the copyright verification and collaboration application on the network device via the communications network are securely sent and securely received with one or more of: a Wireless Encryption Protocol (WEP), Advanced Encryption Standard (AES), Data Encryption Standard (DES), RSA encryption, Secure Hash Algorithm (SHA), Message Digest-5 (MD-5), Keyed Hashing for Message Authentication Codes (HMAC), Perceptual Hashing, Electronic Code Book (ECB) or Diffie and Hellman (DH) or Secure Sockets Layer (SSL), encryption or security methods.

9. The method of claim 2 wherein, all message communications between the IVL application on the server network device and the copyright verification and collaboration application on the network device via the communications network include secure end-to-end encryption.

10. The method of claim 1 wherein, Artificial Intelligence (AI) identity verification decision layer includes: software, user interfaces, and accessibility features that enable users to interact with the underlying AI models, methods, Large Language Models (LLMs) and the Big datasets that power the AI identify verification decision layer with generative AI, predictive AI or Retrieval Augmented Generation (RAG) AI.

11. The method of claim 10, wherein the Artificial Intelligence (AI) identity verification decision layer creates a continuous feedback cycle using Artificial Intelligence (AI) methods, AI models, methods, Large Language Models (LLMs), Big datasets, neural networks and machine learning to adapt its behavior based on current identity verification decision requests.

12. The method of claim 2 wherein, the server network device includes a plurality of cloud applications and one or more cloud databases communicating with a cloud communications network, the plurality of cloud applications providing a plurality of cloud identification verification and location services including: a cloud computing Infrastructure as a Service (IaaS), a cloud computing Platform as a Service (PaaS) and one or more real-time, multi-layer identification verification services including copyright verification and collaboration services, as a Software as a Service (Saas).

13. The method of claim 12, wherein, the one or more cloud databases include one or more cloud storage objects comprising one or more of: a REpresentational State Transfer (REST) or Simple Object Access Protocol (SOAP), Lightweight Directory Access Protocol (LDAP) cloud storage objects, portions thereof, or combinations thereof, stored in the one or more cloud databases.

14. The Method of claim 2, wherein the non-removable digital text includes, electronic text, digital signature, hash code, message digest code or encrypted electronic text.

15. The method of claim 14, wherein the non-removable digital text includes, secure non-removable text created with one or more of: Advanced Encryption Standard (AES) encryption, Data Encryption Standard (DES), RSA encryption, Secure Hash Algorithm (SHA), Message Digest-5 (MD-5), Keyed Hashing for Message Authentication Codes (HMAC), Perceptual Hashing, Electronic Code Book (ECB) or Diffie and Hellman (DH) or Secure Sockets Layer (SSL), encryption or security methods.

16. The method of claim 2, wherein the uploaded original copyrighted digital media includes, digital image files, video files, voice files or electronic text files.

17. The method of claim 2, wherein the derivative work includes an altered version of the uploaded original copyrighted digital media including altered versions of, digital image files, video files, voice files or electronic text files including the uploaded original copyrighted digital media.

18. The method of claim 2, wherein the sites on the communications network include one or more of: Internet web-sites, social media web-sites, FACEBOOK, YOUTUBE, TWITTER-X, INSTAGRAM, TICTOK, social networking web-sites including social couponing sites, dating web-sites, blogs, RSS feeds, podcasts and other types of information web-sites in which posts or messages can be left or posted for a variety of social activities.

19. The Method of claim 2, further comprising:
receiving the GUI on the copyright verification and collaboration application on the network device via the communications network via the display interface service provided by copyright verification layer of the IVL application on the server network device,
the GUI displaying the original copyrighted digital media, copies of the original copyrighted digital media and derivative works created from the original copyrighted digital media,
the GUI also displaying a privacy mode toggle interface; and
sending one or more selection inputs from the privacy mode toggle interface displayed on the GUI displayed on the copyright verification and collaboration application on the network device via the communications network to the IVL application on the server network device,
the one or more selection inputs including enabling and disabling manual execution and automatic execution of engagement actions including enabling and disabling viewing of the uploaded original copyrighted digital media, creation of derivative works, co-authorship and collaboration during browsing by the authenticated user and other users on the communications network and including manual and automatic confirmation prior to completing any such engagement actions.

20. One or more non-transitory computer readable mediums each having stored therein a plurality of instructions configured for causing one or more processors on one more network devices to execute the steps of:
providing a multi-layer identification verification and location (IVL) application with a plurality of layers on a server network device with one or more processors, executing a plurality of different methods providing real-time multi-layer copyright verification and collaboration services, wherein the plurality of different layers include:
(a) a first security layer including authorization for providing summary only identification verification and location information for a desired person; (b) a plurality of second advanced security layers including: (c) multi-layer identity verification layer comprising: a (1) biometrics layer including: a facial recognition sublayer, eye scan sublayer, and biometric markers identification sublayer, (2) Artificial Intelligence (AI) identity verification decision and scoring layer, (3) location tracking layer, (4) proximity detection layer (5) geofencing layer, (6) pattern recognition layer, (7) event recording layer, (8) secure data records layer, (9) data analytics layer, (10) electronic chain of custody layer, (11) jurisdictional biometrics and privacy law compliance layer, (12) law enforcement records layer, (14) copyright verification layer, (15) blockchain layer; and (16) all requested identification verification and location information layer;
receiving an initialization request message on a copyright document verification service provided by a copyright verification layer of the IVL application on the server network device via the communications network from a copyright verification and collaboration application on a network device with one or more processors requesting copyright verification and collaboration for original copyrighted digital media created by a user of the network device;
sending an initialization response message copyright document verification service provided by a copyright verification layer of the IVL application on the server network device via the communications network to the copyright verification and collaboration application on the network device requesting one or more types of biometric information from the user of the network device;
receiving a biometric verification message on the IVL application on the server network device via the communications network from the copyright verification and collaboration application on the network device including the requested one or more types of biometric information from the user of the network device;
verifying with a biometric identity enforcement service provided by a biometrics layer, an Artificial Intelligence (AI) identity verification decision and scoring layer and location tracking layer of the IVL application on the server network device with one or more biometric identification methods and one or more AI identify verification methods and creating verified user identity information including the requested one or more types of biometric information from the user of the network device;
storing in a blockchain with a blockchain documentation service provided by a blockchain layer, a secure data records layer and a jurisdictional biometrics and privacy law compliance layer of the IVL application on the server network device the created verified user identity information including the requested one or more types of biometric information from the user of the network device;
sending an identification verification response message from the IVL application on the server network device via the communications network back to the copyright verification and collaboration application on the network device indicating the identity of the user of the network device has verified;
receiving an upload of original copyrighted digital media from a copyright verification and collaboration application on a network device with one or more processors via the communications network via a content upload interface service provided by a secure data records layer of the IVL application on the server network device configured for receiving submissions of original copyrighted digital media;
receiving a request message on the copyright document verification service provided by a copyright verification layer of the IVL application on the server network device from the copyright verification and collaboration application on the network device via the communications network requesting the uploaded original copyrighted digital media be protected on sites on the communications network;
adding from copyright document verification service provided by the copyright verification layer of the IVL application on the server network device non-removable digital text to the uploaded original copyrighted digital media indicating that the uploaded original copyrighted digital media will be protected on the sites on the communications network;
periodically and continuously with a search engine interface service, a behavioral analytics service and a derivative content workflow service provided by the copyrights layer of the IVL application on the server network device searching for other digital media that matches the uploaded original copyrighted digital media on the sites on the communications network;
creating a digital media use approval request message from the copyright verification layer of the IVL application on the server network device including one or more electronic links to other digital media located by the search engine interface service that matches the uploaded original copyrighted digital media on the sites on the communications network;
sending the digital media use approval request message from the copyright verification layer of the IVL application on the server network device via the communications network to the copyright verification and collaboration application on the network device requesting approval of use of the uploaded original copyrighted digital media located by the search engine interface service being used by third-parties on the sites on the communications network;
receiving a digital media use approval request message response message on the copyright verification layer of the IVL application on the server network device via the communications network from the copyright verification and collaboration application on the network device approving use of one or more copies uploaded original copyrighted digital media located by the search engine interface service being used by the third-parties on the sites on the communications network;
storing in the blockchain in a blockchain entry with the blockchain documentation service provided by the blockchain layer and the secure data records layer of the IVL application on the server network device, all approved uses of one or more copies uploaded original copyrighted digital media located by the search engine interface service being used by the third-parties on the sites on the communications network;
periodically and continuously with a search engine interface service and a derivative content workflow service provided by the copyright verification layer of the IVL application on the server network device searching for other digital media that has been altered as the derivative work that matches a part of uploaded original copyrighted digital media creating the derivative work;
creating a derivative works approval request message from the copyright verification layer of the IVL application on the server network device including one or more electronic links to other digital media that has been altered to create the derivative work that matches a part of uploaded original copyrighted digital media;
sending the derivative works approval request message from the copyright verification layer of the IVL application on the server network device via the communications network to the copyright verification and collaboration application on the network device requesting approval of use of the uploaded original copyrighted digital media located by the search engine interface service that has been altered as the derivative work and that is being used by the third-parties as the derivative work on the sites on the communications network;
receiving a derivative works approval request response message on the copyright verification layer of the IVL application on the server network device via the communications network from the copyright verification and collaboration application on the network device approving use of one or more copies uploaded original copyrighted digital media located by the search engine interface service that has been altered as the derivative work and that is being used by third-parties on the sites on the communications network;
storing in the blockchain in the blockchain entry with the blockchain documentation service provided by the blockchain layer and the secure data records layer of the IVL application on the server network device, all approved uses of one or more copies uploaded original copyrighted digital media located by the search engine interface service that has been altered as the derivative work and that is being used by third-parties on the sites on the communications network; and
displaying a graphical user interface (GUI) with a display interface service layer of the IVL application on the server network device via the communications network the uploaded original copyrighted digital media, copies of the uploaded original copyrighted digital media located on sites on the communications network and copies of the uploaded original copyrighted digital media located by the search engine interface service that has been altered as the derivative work and that is being used by the third-parties as the derivative work on the sites on the communications network,
the GUI also displaying a privacy mode toggle interface via a privacy mode toggle interface service on the IVL application on the server network device for enabling and disabling manual execution and automatic execution of engagement actions including enabling and disabling viewing of the uploaded original copyrighted digital media, co-authorship and collaboration during browsing by the authenticated user and other users on the communications network and including manual and automatic confirmation prior to completing any such engagement actions.
